(19) United States
(12) Patent Application Publication
(10) Pub. No.: US 2015/0140978 A1
(43) Pub. Date: May 21, 2015

(54) VOICE CONVERSATIONS IN A UNIFIED AND CONSISTENT MULTIMODAL COMMUNICATION FRAMEWORK

(71) Applicant: Zeta Project Swiss GmbH, Zug (CH)

(72) Inventors: Priidu Zilmer, Tallinn (EE); Angel Sergio Pascual Palomo, Helsinki (FI); Oliver Reitalu, Tallinn (EE); Martin Hoffmann, Berlin (DE)

(21) Appl. No.: 14/536,590

(22) Filed: Nov. 8, 2014

Related U.S. Application Data
(60) Provisional application No. 61/905,410, filed on Nov. 18, 2013.

(51) Int. Cl. H04M 1/725; H04W 88/06; H04M 3/56; H04W 4/16

(52) U.S. Cl. CPC H04M 1/72522; H04W 4/16; H04W 88/06; H04M 3/56
USPC 455/416

(57) ABSTRACT

A unified communication framework in which multiple users communicate using multiple modes including voice. Conversations are kept consistent across users' devices. A backend maintains the true and authoritative version of the conversation within the communication framework. Users may join and leave voice channels of conversations. Users may attempt to get the attention of other users.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### APPENDIX

This application is related to U.S. Provisional Patent Application No. 61/860,222, titled “Unified and Consistent Multimodal Communication Framework,” filed Jul. 30, 2013, the entire contents of which are fully incorporated herein by reference for all purposes. A copy of Application No. 61/860,222 is included herewith as Appendix A hereto and which is considered part of this application.

### FIELD OF THE INVENTION

This invention relates to a framework for communication, and, more particularly, to a unified framework for multi-modal consistent communication supporting voice conversations.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of a framework for a unified and consistent communications in accordance with embodiments hereof;

FIGS. 2A-2D depict aspects of devices in accordance with embodiments hereof;

FIG. 3 depicts aspects of a backend in accordance with embodiments hereof;

FIGS. 4 AND 5A-5B show aspects of exemplary data structures in accordance with embodiments hereof;

FIGS. 6A-6H depict aspects of conversations in accordance with embodiments hereof;

FIGS. 7A-7C depict aspects of an exemplary system architecture in accordance with embodiments hereof;

FIGS. 8A, 8B-1, 8B-2, 8B-3, 8C-8E depict aspects of exemplary user interfaces in accordance with embodiments hereof for initiating and controlling voice within a conversation;

FIGS. 9A-9F depict aspects of exemplary user interfaces for forming avatars for use by the UI in accordance with embodiments hereof;

FIGS. 10A-10D and 11A-11E depict aspects of exemplary user interfaces showing voice header information in conversations in accordance with embodiments hereof;

FIGS. 12A-12P depict exemplary aspects of knocks and knocking according to embodiments hereof;

FIGS. 13A-13V and 14A, 14A-1, 14B, 14B-2, 14C-14S depict aspects of exemplary user interfaces in accordance with embodiments hereof; and

FIGS. 15A-15E depict aspects of computing and computer devices in accordance with embodiments.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

API means application programming interface;

CA means Certificate Authority;

CRL means certificate revocation list;

GUI means graphical user interface (UI);

HTTP means Hyper Text Transfer Protocol;

HTTPS means HTTP Secure;

IP means Internet Protocol;

IPv4 means Internet Protocol Version 4;

IPv6 means Internet Protocol Version 6;

IP address means an address used in the Internet Protocol, including both IPv4 and IPv6, to identify electronic devices such as servers and the like;

JSON means JavaScript Object Notation;

MIME means Multipurpose Internet Mail Extensions;

OCSP refers to the Online Certificate Status Protocol;

PKI means Public-Key Infrastructure;

POTS means Plain old telephone service;

TCP means Transmission Control Protocol;

UI means user interface;

URI means Uniform Resource Identifier;

URL means Uniform Resource Locator;

VKB means virtual keyboard; and

VOIP means Voice of IP.

### BACKGROUND AND OVERVIEW

Computers and computing devices, including so-called smartphones, are ubiquitous, and much of today's communication takes place via such devices. In many parts of the world, computer-based inter-party communication has superseded POTS systems. Much of today's computer-based communication is built on old protocols that were designed to provide simple messages between devices on the homogeneous networks.

The inventors realized that existing communications systems do not support a consistent model of voice and notification within conversations over multiple heterogeneous devices.

It is desirable to provide a system that can maintain or provide consistent model of voice and notification with conversations over multiple heterogeneous devices.

Overview—Structure

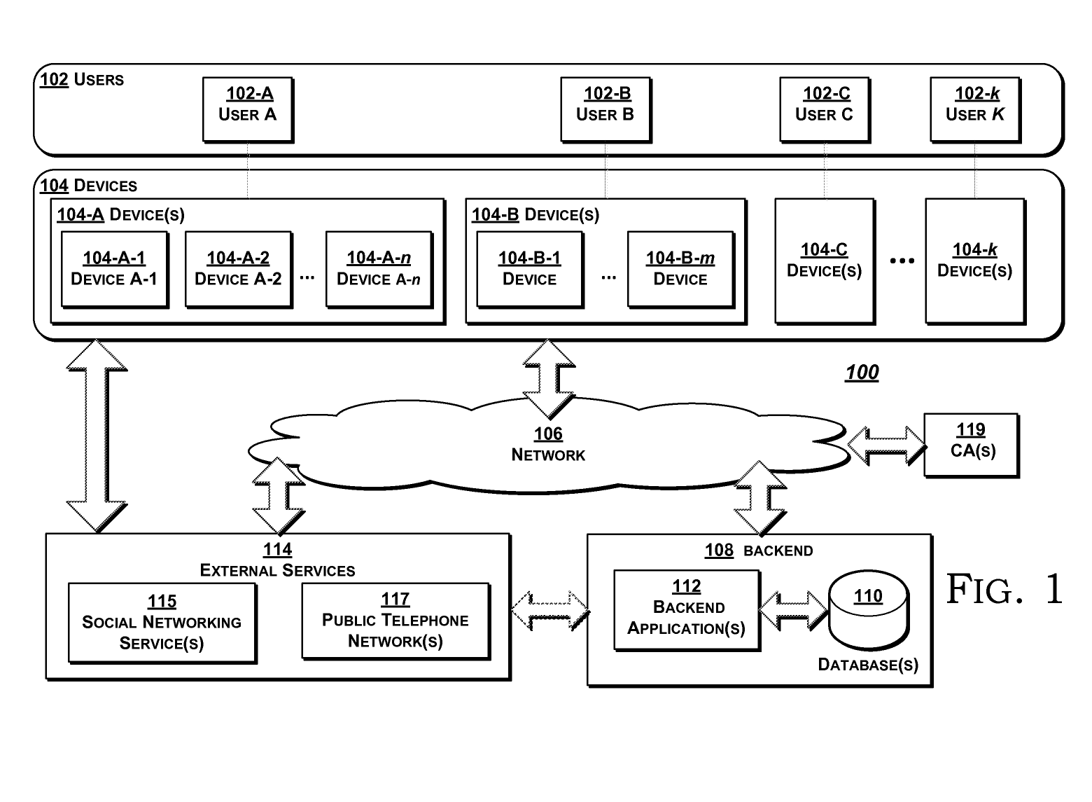

FIG. 1 shows an overview of an exemplary framework 100 for a unified and consistent communications system according to embodiments hereof Within the framework 100, a user 102 may have one or more devices 104 associated therewith. For example, as shown in FIG. 1, user 102-A has device(s) 104-A (comprising devices 104-A-1, 104-A-2 . . . 104-A-n) associated therewith. Similarly, user 102-B has device(s) 104-B (comprising devices 104-B-1 . . . 104-B-m) associated therewith. The association between a user and its devices is depicted in the drawing by the line connecting user 102 with devices 104 associated with that user. Although only four user/device associations are shown in the drawing, it should be appreciated that a particular system may have an arbitrary number of users, each with an arbitrary number of devices.

Those of ordinary skill in the art will realize and appreciate, upon reading this description, that a particular user/device association may change over time, and further, that a particular device may be associated with multiple users (for example, multiple users may share a computer).

It should be appreciated that a user 102 may not correspond to a person or human, and that a user 102 may be any entity (e.g., a person, a corporation, a school, etc.).

Users 102 may use their associated device(s) 104 to communicate with each other within the framework 100. As will be explained in greater detail below, a user's device(s) may communicate with one or more other users' device(s) via network 106 and a backend 108, using one or more backend applications 112. The backend 108 (using, e.g., backend application(s) 112) maintains a record/history of communications between users in one or more databases 110, and essentially acts as a persistent store through which users 102 share data.

The backend database(s) 108 may comprise multiple separate or integrated databases, at least some of which may be distributed. The database(s) 108 may be implemented in any manner, and, when made up of more than one database, the various databases need not all be implemented in the same manner. It should be appreciated that the system is not limited by the nature or location of database(s) 108 or by the manner in which they are implemented.

It should be appreciated that multiple devices 104 associated with the same user 102 may be communicating via the backend 108 at the same time (for example, as shown in the drawing, some or all of the devices 104-A-1, 104-A-2 . . . 104-A-n associated with user 102-A may be communicating via the backend 108 at the same time).

Devices

The devices 104 can be any kind of computing device, including mobile devices (e.g., phones, tablets, etc.), computers (e.g., desktops, laptops, etc.), and the like. Computing devices are described in greater detail below.

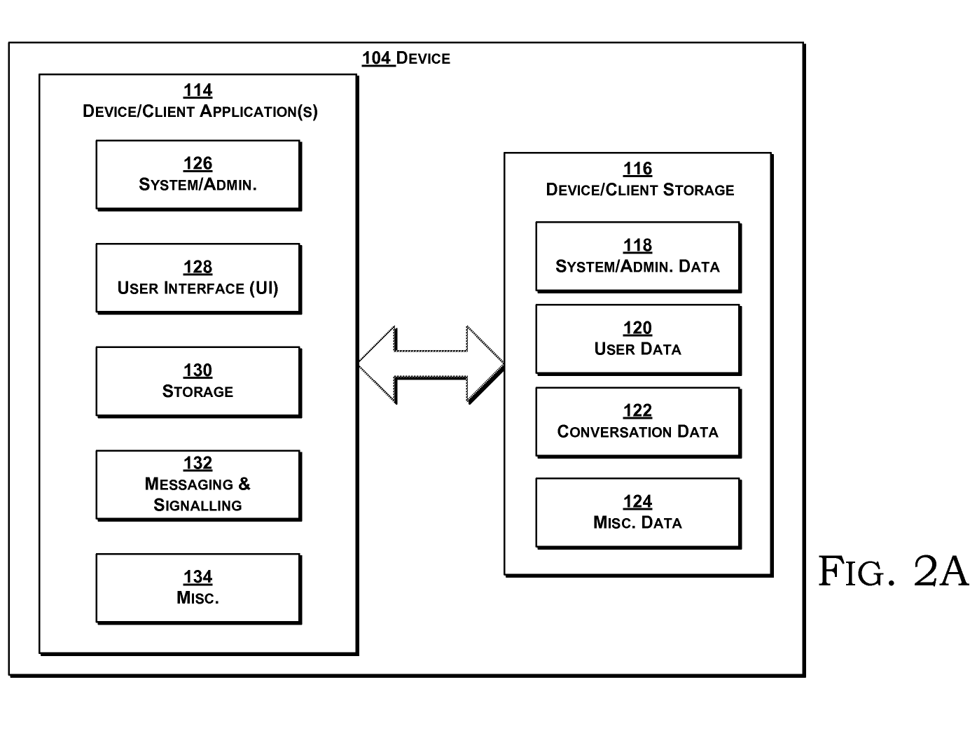

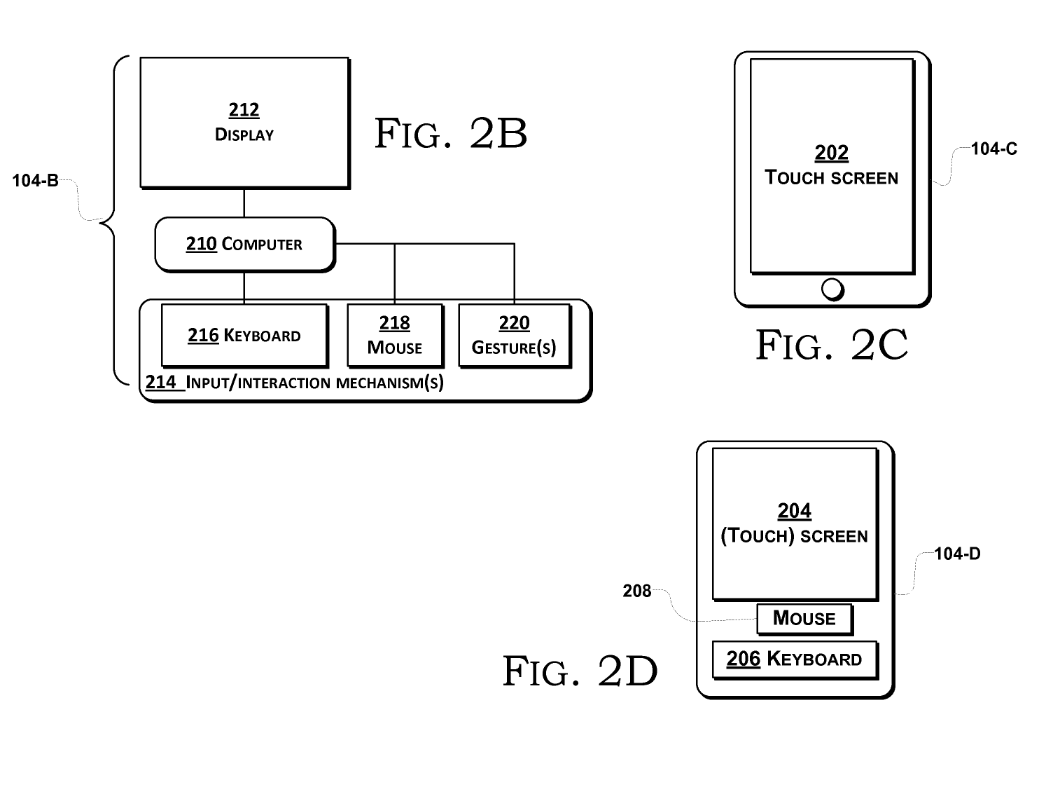

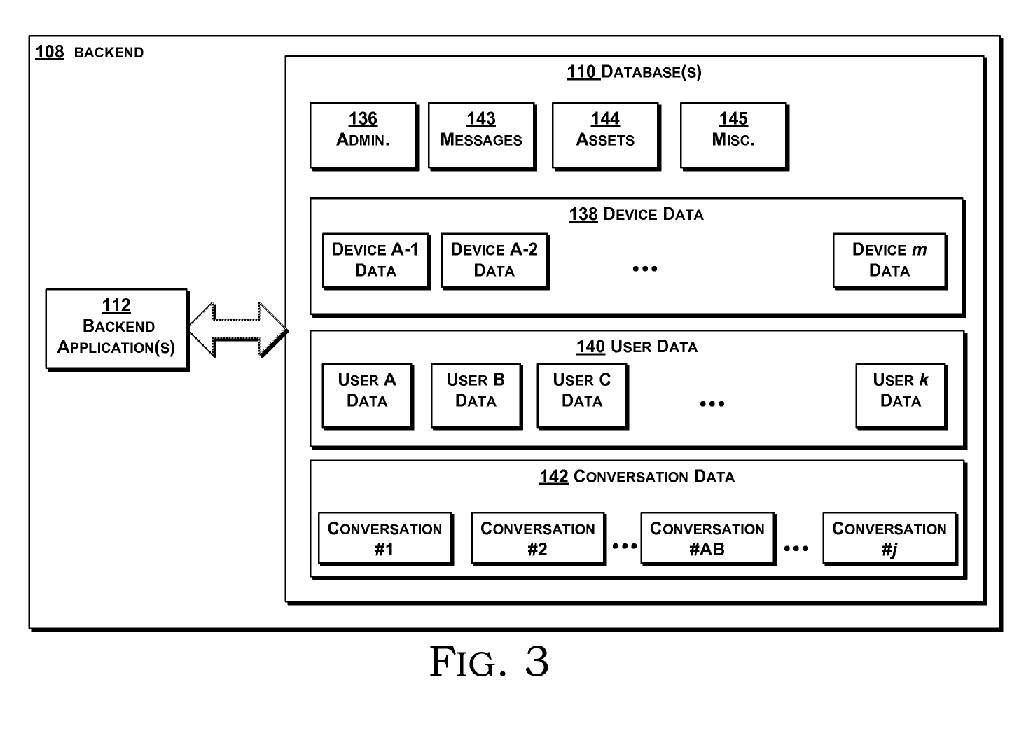

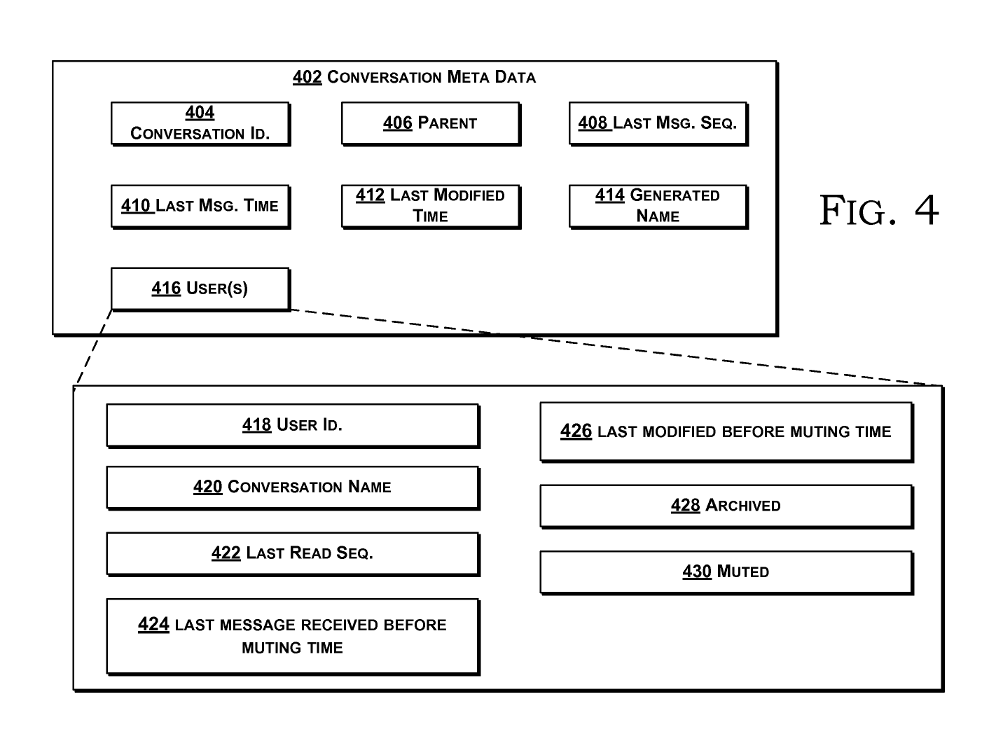

FIG. 2A shows aspects of a typical device 104, including device/client applications 114 interacting with client storage 116. As will be described in greater detail below, an interaction between a set of one or more users is referred to herein as a “conversation.” Device/client storage 116 may include system/administrative data 118, user data 120, conversation data 122, and miscellaneous data 124. The device/client application(s) 114 may include system/administrative applications 126, user interface (UI) applications 128, storage applications 130, messaging and signaling applications 132, and other miscellaneous applications 134. The categorization of data in storage 116 is made for the purposes of aiding this description, and those of ordinary skill in the art will realize and appreciate, upon reading this description, that different and/or other categorizations of the data may be used. It should also be appreciated any particular data may categorized in more than one way. Similarly, it should be appreciated that different and/or other categorizations of the device/client applications 114 may be used and furthermore, that any particular application may be categorized in more than one way.

FIGS. 2B-2D show exemplary devices 104-B, 104-C, and 104-D that may be used within the system 100. These may correspond, e.g., to some of the devices 104 in FIG. 1.

Each device preferably includes at least at one display and at least some input mechanism. The display and input mechanism may be separate (as in the case, e.g., of a desktop computer and detached keyboard and mouse), or integrated (as in the case, e.g., of a tablet device such as an iPad or the like). The term “mouse” is used here to refer to any component or mechanism the may be used to position a cursor on a display and, optionally, to interact with the computer. A mouse may include a touchpad that supports various gestures. A mouse may be integrated into or separate from the other parts of the device. A device may have multiple displays and multiple input devices.

As used herein, the term “mechanism” refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

Device 104-B (FIG. 2B) comprises multiple components, including a computer 210, a computer monitor 212, and input/interaction mechanism(s) 214, such as, e.g., a keyboard 216 and/or a mouse 218. The device 104-B may also include gesture recognition mechanism 220. Some or all of these components may be integrated into a single physical device or appliance (e.g., a laptop computer), or they may all be separate components (e.g., a desktop computer). Although the various components of device 104-B are shown connected by lines in the drawing, it should be appreciated the connection between some or all of the components may be wireless.

As another example, a device may be integrated into a television or a set-top box or the like. Thus, e.g., with reference again to FIG. 2B, the display 212 may be a television monitor and the computer 210 may be integrated fully or partially into the monitor. In this example, the input/interaction mechanisms 218 (e.g., keyboard 216 and mouse 218) may be separate components connecting to the computer 210 via wired and/or wireless communication (e.g., via Bluetooth or the like). In some cases, the input/interaction mechanisms 218 may be fully or partially integrated into a remote control device or the like. These input/interaction mechanisms 218 may use virtual keyboards generated by the computer 210 on the display 212.

Device 104-C (FIG. 2C) has an integrated display and input mechanism in the form of touch screen 202. The device 104-C is integrated into a single component, e.g., a smartphone, a tablet computer, or the like. Device 104-D (FIG. 2D) is also integrated into a single component, but, in addition to a screen 214, it includes a keyboard 206 and an integrated mouse 208. The keyboard may be a hardware keyboard (e.g., as in the case of a BlackBerry phone). The screen 204 may be a touch screen and the keyboard may be implemented as a software (or virtual) keyboard.

These exemplary devices are shown here to aid in this description, and are not intended to limit the scope of the system in any way. Other devices may be used and are contemplated herein.

Backend

FIG. 3 depicts aspects of an exemplary backend 108 (in FIG. 1) in which database(s) 110 includes administrative data 136, device data 138, user data 140, conversation data 142, messages 143, asset data 144, and other miscellaneous data 145. The device data 138 in the backend database(s) 110 may, and preferably does, include data about all devices in the system 100. Thus, e.g., and with reference again to the exemplary system 100 shown in FIG. 1, the device data 138 may, and preferably does, include data about all devices in the system, including data (Device A-1 Data) about device 104-A-1, data (Device A-2 Data) about device 104-A-2 . . . and data (Device A-m Data) about device 104-A-m. The user data 140 may, and preferably does, include data about all users of the system 100. Thus, e.g., the user data 140 may include data about User A, User B, User C, . . . , and User k. The conversation data 142 preferably includes data about all conversations that have occurred (and are occurring) within the system 100. As shown in the drawing in FIG. 3, conversations are denoted “Conversation #1”, “Conversation #2,” etc. Recall that the backend essentially acts as a persistent store through which users 102 may share and access data, including conversation data.

A conversation stored and maintained in the backend is considered to be the “true” or authoritative version of that conversation within the system. As such, to the extent that any other version of that conversation exists within the system, e.g., on any device, the version stored and maintained in the backend is considered to be the correct and authoritative version of that conversation. If there are any discrepancies between a conversation version in the backend and any other version of that conversation that might exist in the system, the version of the conversation in the backend controls and is authoritative within the system (and is thus considered to be the “true” version of that conversation).

It should be appreciated that the categorization of data in the backend database(s) is made for the purposes of this description, and those of ordinary skill in the art will realize and appreciate, upon reading this description, that different and/or other categorizations and/or organizations of the data may be used. It should also be appreciated that the backend database(s) 110 preferably include appropriate index data to facilitate fast and efficient access to and update of the various data stored therein.

Each user 102 within the system 100 is preferably identified by an internal user identifier (user ID) that is unique within the system 100. This user ID may be assigned to the user in a registration process. While in a presently preferred implementation there is no explicit signup of users, in an exemplary registration process users may register via one or more external services (114, FIG. 1) with which the user is already registered, such as, social network services (115, FIG. 1), e.g., Facebook, Twitter, LinkedIn, Google, and the like) or public telephone network(s) 117 (FIG. 1), e.g., Vodafone, AT&T, Optus, Sprint, Verizon, and the like).

With reference again to FIG. 1, when a user registers or joins the system 100 using an external service 114 (e.g., social network service or public telephone network) the combination of the service and the user's ID in that service is referred to as a foreign identifier (foreign ID). As a user 102 may be registered with more than one external service, the user may have more than one foreign ID.

It should be appreciated that system is not limited by the manner in which a user ID is assigned to a user. It should also be appreciated that the system is not limited by whether or how registration takes place. Those of ordinary skill in the art will realize and appreciate, upon reading this description, that although registration is described herein via external services, different and/or other registration techniques may be used.

User information such as the user ID and a user's foreign ID(s) may be stored in the user data 140 the backend database(s) 110.

Device Identifiers (IDs)

Each client/device 104 using or associated with the system 100 needs a device identifier (device ID). Each device is associated with at least one user, and the device identifier is unique within the system 100 for a single user. Thus, within the system 100, there may be identical device identifiers, but each <user ID, device ID> pair will be unique.

Authentication

A client/device 104 using the system 100 preferably needs to authenticate itself with the system. In presently preferred implementations, there are two options for authentication: client certificates and access tokens. Client certificates are the preferred approach, and the access token approach is preferably only used to facilitate clients that cannot use client certificates (e.g., web applications). An exemplary client/device 104 may have one or more client certificates and/or access tokens associated therewith. Typically a client/device 104 will have either certificate(s) or tokens, depending on the type of connection that client/device will make with the backend 108.

The system 100 may use or provide one or more certificate authorities (CAs) 119 (FIG. 1) for authentication and verification purposes, both during a user or device's initial use of the system, and in an ongoing manner for communication between devices 104 and/via the backend 108.

Connecting a Device to a User

As noted, a device 104 needs to be associated with a user 102 in order to operate within the system 100. When connecting a device 104 to a user 102, the client application 114 has to obtain and authenticate a foreign ID from the user 102. Next the client application 114 has to use the foreign ID and authentication data it obtained from the corresponding foreign service and request either a certificate or an access token from the backend 108.

Acquiring the Foreign ID

As some of these foreign services may be embedded into mobile devices, in presently preferred implementations it is the device's responsibility to perform authentication with the foreign service and to acquire the necessary data to allow the system to confirm successful authentication with the service.

Within an OAuth-based authorization service, authentication typically provides an access token. When proceeding with connecting the device, the application has to provide information about the foreign services authentication data as parameters of the request.

Acquiring a Client Certificate

In order to acquire a client certificate, a client/device 104 requests a certificate from the backend 108. The request is preferably in the form of a certificate signing request that is made of the backend 108. Preferably information about the foreign authentication is included in the request. In some cases the certificate request includes information about the device.

Managing the Requesting Device and Its User

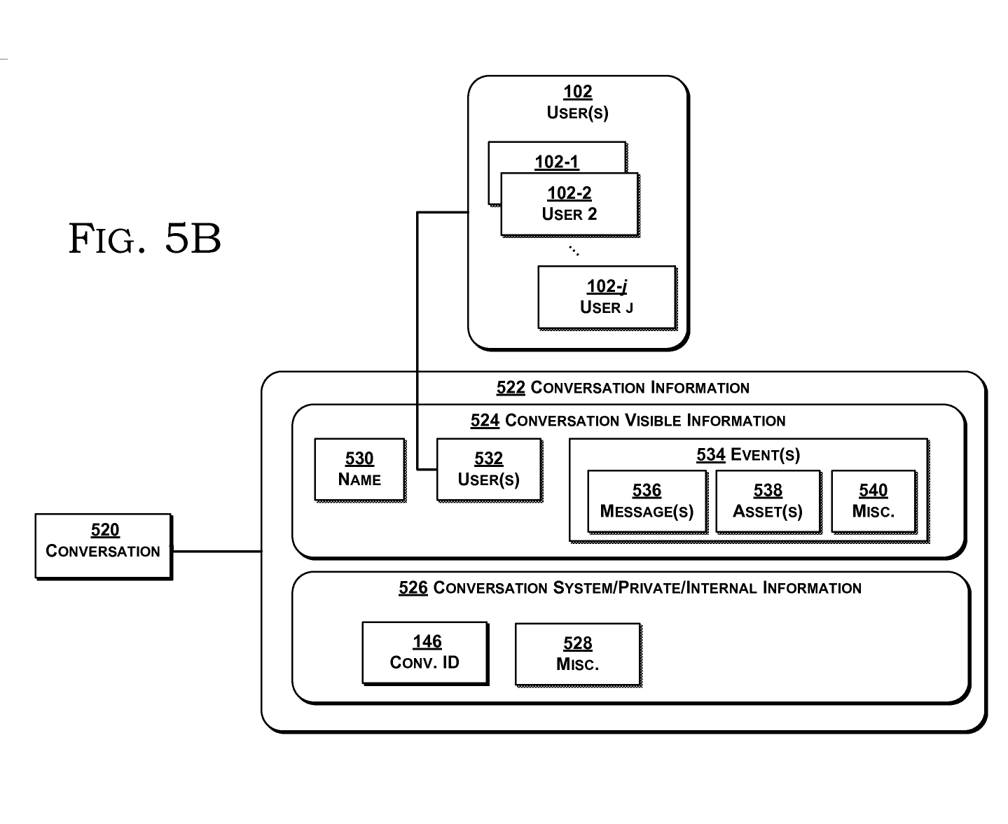

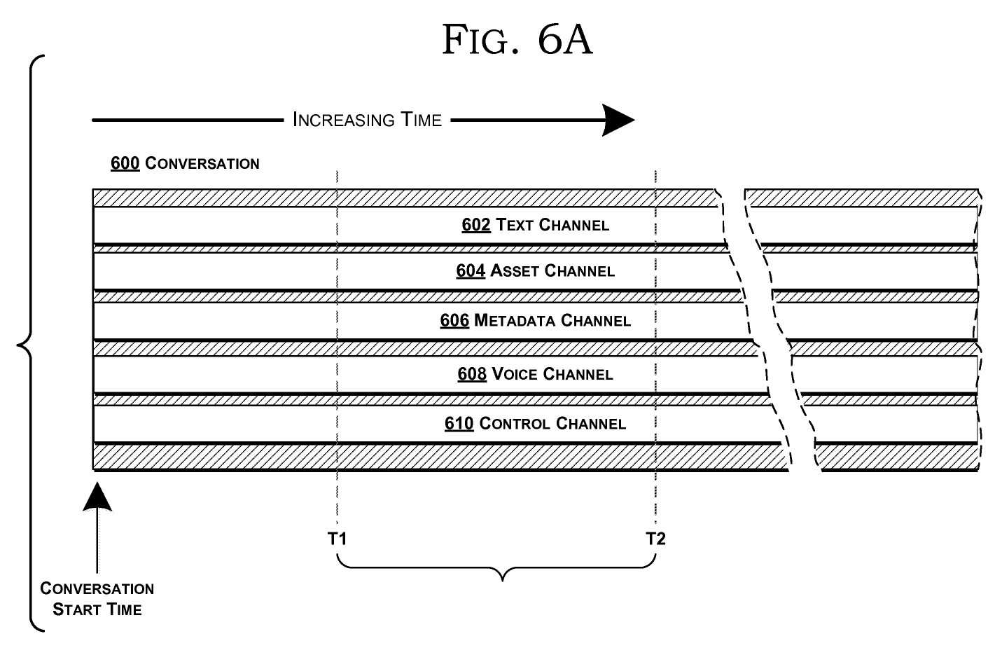

With reference again to FIG. 3, information about authenticated devices may be stored in/as the device data 138 in the backend database(s) 110. Device information may be stored in the backend database(s) 110 in/as device data 138. The device information may include some or all of the following:

| Attribute | Description |
|---|---|
| User id. | The unique identifier of the user the device is connected |
| | to (146, FIG. 5A). |
| Device id. | An identifier for the connected device making the |
| | request. This device identifier is only guaranteed to be |
| | unique within a single user. |
| Connection type | The type of credential that was handed out for the device. |
| | This is either “certificate” or “token”. |
| Certificate issuer | The contents of the issuer field of the certificate that |
| | should currently be used by the client. This attribute is |
| | only included if “connection type” is “certificate”. |
| Certificate serial | The serial number of the certificate that should currently |
| number | be used by the device. This attribute is only included if |
| | “connection type” is “certificate”. |
| Device Info. | A human-readable description of the device |
| Agent Information | An optional object containing information about the |
| | hardware and software the device runs on. |

The optional Agent Information may include the following:

| Attribute | Description |
|---|---|
| System | An identification of the system (e.g., “ios”, “android”, |
| | “osx”). |
| Software | The software version of the device application. |
| Hardware | An optional string that can be used to describe the |
| | underlying hardware. |

An authenticated device 104 may ascertain information about itself, its user, and operations directly related to the two from the backend 108. In a presently preferred implementation a device 104 may obtain some or all of the following information: user ID and device ID.

In addition the device may also obtain attributes of the user's profile. In a presently preferred implementation, the device requests the information using an HTTPS GET request and the information is returned to the device in an object (e.g., a JSON response).

Conversations

Recall from above that a “conversation” is the term used herein to refer to an ongoing interaction between a set of one or more users. In some aspects, a conversation may be considered to be a time-ordered sequence of events and associated event information or messages. The first event occurs when the conversation is started, and subsequent events are added to the conversation. The time of an event in a conversation is the time at which the event occurred on the backend.

The Event Information Associated with an Event—Contents of Conversations

Events in a conversation may be represented as or considered to be objects, and thus a conversation may be considered to be a time-ordered sequence of objects. An object (and therefore a conversation) may include or represent text, images, video, audio, files, and other assets. As used herein, an asset refers to anything in a conversation, e.g., images, videos, audio, links (e.g., URIs) and other objects of interest related to a conversation.

As will be understood and appreciated by those of ordinary skill in the art, upon reading this description, in some aspects, a conversation may be considered to be a timeline with associated objects. Each object in the conversation may represent or correspond to an event. Thus, in some aspects, an event may be considered to be a <time, object> pair, and a conversation is collection of such events for a particular user set.

It should be appreciated that the time interval between any two objects may differ. The time intervals between events (including adjacent events) in a conversation may, e.g., fractions of a second, hours, days, weeks, months, years, etc.

An object may contain the actual data of the conversation (e.g., a text message) associated with the corresponding event, or it may contain a link or reference to the actual data or a way in which the actual data may be obtained. For the sake of this discussion, a conversation object that contains the actual conversation data is referred to as a direct object, and a conversation object that contains a link or reference to the data (or some other way to get the data) for the conversation is referred to as an indirect or reference object. A direct object contains, within the object, the information needed to render that portion of the conversation, whereas an indirect object requires additional access to obtain the information needed to render the corresponding portion of the conversation. Thus, using this terminology, an object may be a direct object or an indirect object.

As used herein, the term “render” (or “rendering”) with respect to data refers to presenting those data in some manner, preferably appropriate for the data. For example, a device may render text data (data representing text) as text on a screen of the device, whereas the device may render image data (data representing an image) as an image on a screen of the display, and the device may render audio data (data representing an audio signal) as sound played through a speaker of the device (or through a speaker or driver somehow connected to the device), and a device may render video data (data representing video content) as video images on a screen of the device (or somehow connected to the device). The list of examples is not intended to limit the types of data that devices in the system can render, and the system is not limited by the manner in which content is rendered.

It should be appreciated that a particular implementation may use only direct objects, only indirect objects, or a combination thereof. It should also be appreciated that any particular conversation may comprise direct objects, indirect objects, or any combination thereof. The determination of which conversation data are treated as direct objects and which as indirect objects may be made, e.g., based on the size or kind of the data and on other factors affecting efficiency of transmission, storage, and/or access. For example, certain types of data may be treated as indirect objects because they are typically large (e.g., video or images) and/or because they require special rendering or delivery techniques (e.g., streaming).

As used herein, the term “message” refers to an object or its (direct or indirect) contents. Thus, for a direct object that includes text, the message is the text in that direct object, whereas for an indirect object that refers to an asset, the message is the asset referred to by the indirect object.

A presently preferred implementation uses a combination of direct and indirect objects, where the direct objects are used for text messages and the indirect objects are used for all other assets. In some cases, text messages may be indirect objects, depending on their size (that is, an asset may also include or comprise a text message). It should be appreciated that even though an asset may be referenced via an indirect object, that asset is considered to be contained in a conversation and may be rendered (e.g., displayed) as part of (or apart from) a conversation.

Each conversation has a unique conversation identifier (ID) that is preferably assigned by the backend 108 when a conversation between a set of users begins.

A message can only belong to one conversation and should not move to another conversation. Note, however, that in some cases a conversation may become part of another (e.g., new) conversation (e.g., as its parent), in which case the messages in the conversation may be considered to be part of the new conversation.

A direct object preferably includes the actual contents of the conversation (e.g., the message). A direct object may also include some or all of the following attributes:

| Attribute | Description |
|---|---|
| Object/ | A unique identifier for this object (message). This unique |
| message ID | identifier may be a Unicode string of unspecified length with |
| | no further semantics attached. The value is preferably chosen |
| | by the service upon creation of the message by a user and |
| | will never change. This object/message ID allows messages |
| | in a conversation to be individually addressable. In some |
| | implementations individual messages are not addressable, in |
| | which cases this attribute may not be provided. |
| Sequence | A sequence number of this message. This sequence number |
| Number | should be unique within a conversation and may be used, e.g., |
| | for ordering, tracking the last read message, etc. |
| Creator Tag | A value that may be sent by the device. The value can be |
| | used, e.g., to check if the message was actually sent in |
| | cases where the response was lost. In some implementations |
| | this value may not be used and/or may only be visible |
| | to the sending device. |
| Sender | The user ID of the sender of this message. |
| Origin | The device ID of the device from which this message |
| | originated. |
| Conversation | The conversation ID of the conversation to which this |
| ID | message belongs. |
| Received At | The time at which the backend server received this message |
| Time | (preferably in Standard Time Format). |
| Type | The type of this message (e.g., as a string). |

An indirect object may have some of the same attributes as a direct object, except that instead of the actual contents of the conversation, an indirect object includes asset metadata.

Assets typically originate outside of the system 100. Preferably each asset is obtained and stored by the system 100 before (or while) being provided to users in a conversation. In this manner a conversation will be reproducible at future times, without reliance on the persistence of external content. Assets are maintained and stored by the backend 108 in assets 144 in the database(s) 110.

The asset metadata may include some or all of the following:

| Attribute | Description |
|---|---|
| Published at | The time at which this message was published. A message is |
| time | typically considered to be published once the upload starts. |
| | If an asset has not yet been uploaded, the “published at” |
| | attribute will be unset. |
| Location | The canonical location of the asset data (e.g., in the form of a |
| | URI). |
| Content | The media type (e.g., MIME type) of this asset. |
| type | |
| Content | The length of this asset. This attribute, if present, may not |
| Length | be set until the upload is complete. |
| Visibility | The visibility of this asset. In current implementations the |
| | attribute can be either “public”, meaning it will be world |
| | visible, or “conversation”, meaning it will only be available |
| | to members of the conversation to which it belongs. |

It will be appreciated, as discussed below, that each device should be able to render each asset in some manner. The device may use the content type to determine how the asset should be rendered. In some cases, a device may be able to determine from the location information how to render the asset (e.g., the location information may have type information or other information encoded therein), or the device may determine the type of the asset after obtaining some of or the entire asset.

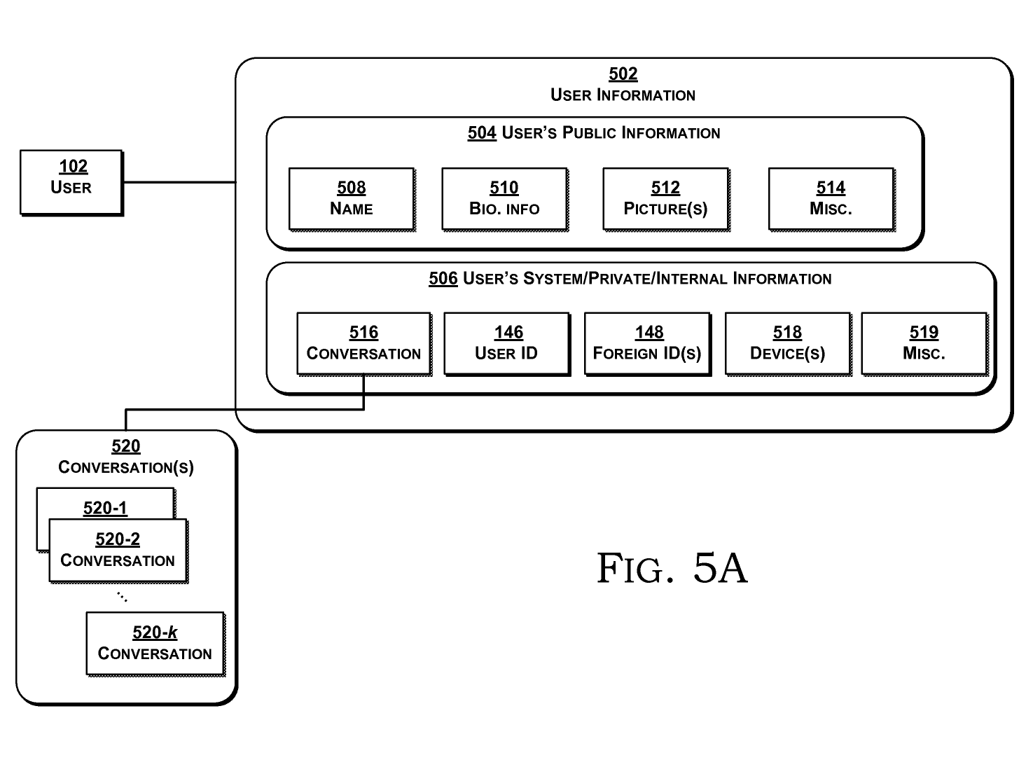

The conversation data 142 in the database(s) 110 on the backend 108 contains conversation metadata 402 and participant(s) list(s) and may include some or all of the following attributes (with reference to FIG. 4):

| Attribute | Description |
|---|---|
| Conversation Id. | The unique identifier for this conversation. |
| 404 | |
| Parent | The ID of the conversation from which this conversation |
| conversation ID | originated, e.g. when adding a member to a multi-user |
| 406 | conversation. This value will be present if this conversation |
| | originates from another one, and it can be used, e.g., to |
| | refer to the previous conversation at the start of the |
| | timeline of the first one. |
| Last Message | The sequence number of the last message in this |
| Seq. 408 | conversation. This will start off at zero and is incremented |
| | on every message posted to the conversation. |
| Last message | The time a message/event was last received in this |
| time 410 | conversation (preferably represented in the Standard Time |
| | Format). If there are no messages in the conversation yet, |
| | the value may be empty or missing. |
| Last modified | The last time the conversation was modified (which may |
| time 412 | correspond to the last time that the conversation metadata |
| | changed, preferably represented in the Standard Time |
| | Format). |
| Generated name | A generated name for this conversation. This may be a list |
| 414 | of the names of the participants (e.g., separated by “,” or |
| | “&” as appropriate). Creation and formatting of this name |
| | is discussed in greater detail below. The name may differ |
| | for different users in the conversation. |
| Users 416 | A list of participants in this conversation, including the |
| | authenticated user, and conversation specific information |
| | about them. |

Each item on the users attribute 416 is an object preferably containing some or all of the following attributes:

| Attribute | Description |
|---|---|
| User Id. 418 | The user ID of the participant. |
| Name 420 | The name of the conversation, if set. It is preferably not |
| | possible to set this for self or 1:1 conversations. Note that |
| | each participant user may have a different name for the |
| | same conversation. |
| Last read seq. | The sequence number of the last message read by this user |
| 422 | in this conversation. |
| Last message | A timestamp representing the last time that the user |
| received before | received a message before he muted the conversation. |
| muting time 424 | (This value may be used, e.g., for the client side to do |
| | proper sorting of the conversations.) |
| Last modified | Similar to “last message received before muting time”, a |
| before muting | timestamp representing the last time that the conversation |
| time 426 | state was updated while the user was not muted |
| archived 428 | A value indicating whether or not the user has archived this |
| | conversation. The server will set this to “false” if a |
| | message is received in an archived conversation. |
| muted 430 | A value indicating whether or not the user has muted this |
| | conversation. |

It should be appreciated that various techniques may be used to point to the location of an asset. For example, the location data may be a URL or a URI. Those of ordinary skill in the art will appreciate and understand, upon reading this description, that different and/or other ways of pointing to or referring to assets may be used, and that the system is not limited by the manner or location(s) in which asset locations are specified. It should further be appreciated that a particular system may use more than one technique to refer to assets. The different techniques may depend, e.g., on the type or size of an asset.

It should be appreciated that the assets in a conversation (i.e., the assets referenced by indirect objects in the conversation) may be of different types (e.g., audio, pictures, video, files, etc.), and that the assets may not all be of the same size, or stored in the same place or in the same way. Thus, for example, in an exemplary conversation one asset may be a photograph, another asset may be a video, and yet another asset may be a PDF file, and so on.

Those of ordinary skill in the art will appreciate and understand, upon reading this description, that the phrase “an asset may be a video” means that “the asset may refer to content that represents a video.” In general, referring to an asset as being of some type (e.g., audio, picture, video, file, text, etc.), means that the asset comprises data representing something of that type. So that, e.g., if an asset is an audio asset, this means that the asset comprises data representing audio content, if an asset is an image, this means that the asset comprises data representing video content, and so on. It should be appreciated that all assets are essentially data, possibly with associated metadata, and that the type of an asset will affect what the data in an asset represent and, possibly, how those data are to be rendered. For example, when an asset is a video, the asset comprises data (and possibly metadata) representing video content in some form. When appropriately rendered, the video asset data will comprise a video (video images, possibly including audio).

The system may store multiple copies of the same asset.

As used herein, a user participating in a conversation is said to be conversing or engaging in that conversation. The term “converse” or “conversing” includes, without any limitation, adding any kind of content or object to the conversation. It should be appreciated that the terms “converse” and “conversing” include active and passive participation (e.g., viewing or reading or listening to a conversation). It should further be appreciated that the system is not limited by the type of objects in a conversation or by the manner in which such objects are included in or rendered within a conversation.

It should be appreciated that a conversation may also include conversation metadata (e.g., data about when events occur within the conversation). Conversation metadata may be treated as conversation objects, with their rendering (if at all) being dependent, e.g., on system policies. For example, when a user Jane leaves a conversation, that event may be a conversation object with the text “Jane has left the conversation.” In this example, a device may render the object as text on a display. Some other metadata (e.g., system status information) may be stored as part of the conversation but not rendered by any device.

Identifying Conversations

Within the system 100, a conversation may have one or more participants and is uniquely identified (e.g., using a conversation ID 404 in FIG. 4) by or, at least, as a function of its participants. In some presently preferred implementations a conversation may be uniquely identified by a function of a set of one or more user IDs, and consists of the interaction/communication between/among the users in the set. A special case of a conversation is defined by a set containing a single user ID—a so-called “self-conversation.” A conversation preferably consists of the entire interaction/communication between/among the user(s) in the set that define the conversation, beginning at time of the first interaction/communication between the user(s) in the set. Thus, e.g., an interaction/communication between two users A and B defines a first conversation, whereas another interaction/communication between users A, B, and C defines a second and distinct conversation. In other words, the conversation “AB” between users A and B is not the same as the conversation “ABC” between users A, B, and C. A conversation may be between an arbitrary number of users. For the sake of this discussion, the user set that define a particular conversation may be referred to as the member(s) of that conversation, so that a conversation in the system is said to be uniquely defined, at least in part, by its member(s).

Note that the set of users in a conversation is preferably unordered, so that a conversation between users A and B may be considered to be the same as the conversation between users B and A.

Users can be added to and/or removed from a conversation, and the manner of doing so is described in greater detail below.

As noted above, when a conversation between a set of users begins, that conversation is given a unique conversation identifier (conversation ID, e.g., 404 in FIG. 4). The conversation ID may be generated, e.g., based on the user ID(s) of the user(s) in the set. For example, the conversation ID may be a message digest or hash (e.g., MD5 or SHA) of the concatenated sorted user ID(s) in the set of participants. It should be appreciated the different and/or other functions may be used to generate conversation IDs. The function should be defined to ensure uniqueness of conversation identifiers within the system, so that every two distinct sets of users will have a distinct conversation ID. Since user IDs are unique, a conversation ID formed by concatenating an ordered list of the user IDs in a set will always produce a unique value. However, given that an arbitrary number of users may be in any conversation, this concatenation approach may not be optimal, and another, more compact conversation ID may need to be determined. It should be understood that the conversation ID is used internally by the system 100 to uniquely identify each conversation. Each conversation may also have one or more names (e.g., conversation name 420, FIG. 4) that can be presented to users (via the user interfaces) to help them identify and distinguish conversations. Such naming schemes are described in greater detail below.

Users may be added to (or removed from) a conversation. A change in the membership of a conversation may cause a new conversation ID to be generated, based on the new membership. In order to facilitate access to the entire interaction/communication history, for each conversation the system may also maintain information about conversation(s) from which a current conversation originated (e.g., a parent conversation). For example, a first conversation starts at time T₀ between user A and user B may be given conversation ID “#AB”. At a later time T₁>T₀ user C is added to the conversation between user A and user B. The new conversation may be given conversation ID “#ABC”, and its parent ID is set to refer to conversation “A#B”. In this example the conversation metadata 402 for the conversation with users A and B would have conversation ID 404 set to “#AB” and parent 406 unset (or null). The user(s) 416 would be set to “{A, B}”. For user A, the conversation name 420 may be set to “B”, whereas for user B, the conversation name 420 may be set to “A”. When user C is added to the conversation (at time T₁), the conversation ID for the new conversation may be set to “#ABC”, the parent 406 for the new conversation may be set to “#AB” (previously it was null or unset), and the users 416 may be set to “{A, B, C}”. The conversation name 420 for conversation “ABC” for user A may be set to “B and C”, conversation name 420 for user B to “A and C”, and conversation name 420 for user C to “A and B”.

It should be appreciated that these settings are provided only by way of example, and are not intended to limit the scope of the system in any way.

In some embodiments there may only be (or the system may only allow) one conversation for any set of users. That is, in some embodiments, a set of users defines (and may only define) one and only one conversation. For example, in such embodiments, there can only be one conversation between users A and B. Some other embodiments may allow for multiple conversations with the same set of participants. In such embodiments a set of users may define more than one conversation, so, e.g., in such embodiments there may be multiple conversations between users A and B. Those of ordinary skill in the art will realize and appreciate, upon reading this description, that when the system allows multiple conversations between identical participants, the internal naming of conversations (the conversation ID) will be a function of more than just the user IDs of its participants. An exemplary function to generate a unique conversation ID may use time of day as an input along with the user IDs.

Techniques and policies for merging and splitting conversations between and among users and for adding and removing users from conversations are described in greater detail below.

As described above, the backend 108 (backend application(s) 112) maintains conversations (as identified by the user IDs of the users having the conversation—i.e., the participants) in a conversation database 142 in database(s) 110 (FIG. 3). Thus, with reference again to FIG. 3, the conversation data 142 in database(s) 110 in the backend 108 may be maintained and indexed, e.g., using conversation IDs.

As shown in FIG. 5A, each user 102 has user information 502 associated therewith. For the purposes of this discussion, the user information 502 may be considered to include the user's public (or visible) information 504 and the user's non-public information 506 (which may include internal system information and the user's private information). The user's public (or visible) information 504 may include the user's name 508, the user's biographical information 510, one or more user pictures 512, and other information 514.

The user's non-public or internal system information 506 may include conversation information 516, the user ID 146 and foreign IDs 148, information about the user's device(s) 518 (e.g., a list of all devices associated with the user, perhaps by device ID), and other information 519.

It should be appreciated that the categorization of user information described here is given by way of example, and that different and/or other categorizations of the user information may be made. It should also be appreciated that the system need not impose a strict boundary between public/visible and non-visible information for users. It should further be appreciated that the term “private” does not imply any legal notion of privacy and is used here to describe which information may or may not be visible to other users in the system.

The system 100 may allow the user to set and possibly change some or all of the user's public information.

With reference again to FIG. 5A, each user 102 may be associated with (i.e., at some time involved in) one or more conversations 520 (including, at least, the user's self-conversation). Information about the conversation(s) with which a user 102 is associated may be maintained as conversation information 516 for that user. As shown in FIG. 5A, user 102 is associated with k conversations (k≧1), denoted 520-1, 520-2, . . . 520-k. These conversations 520 preferably include the user's self-conversation and all non-deleted conversations that the user has ever joined and is still a part of (i.e., has not left), regardless of how much time has expired since any activity took place in the conversation and regardless of the user's actual active participation in the conversation. Thus, as used herein, the term “involved in a conversation” means “is, or at some time was, involved in a conversation,” whether actively or passively.

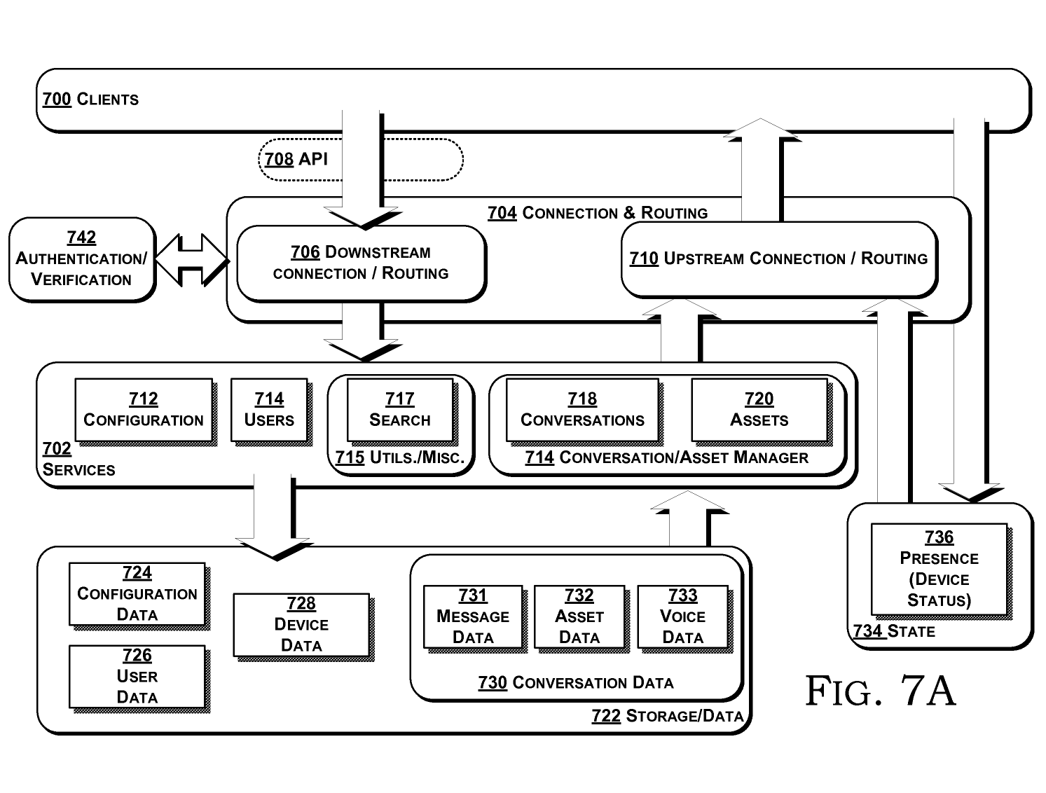

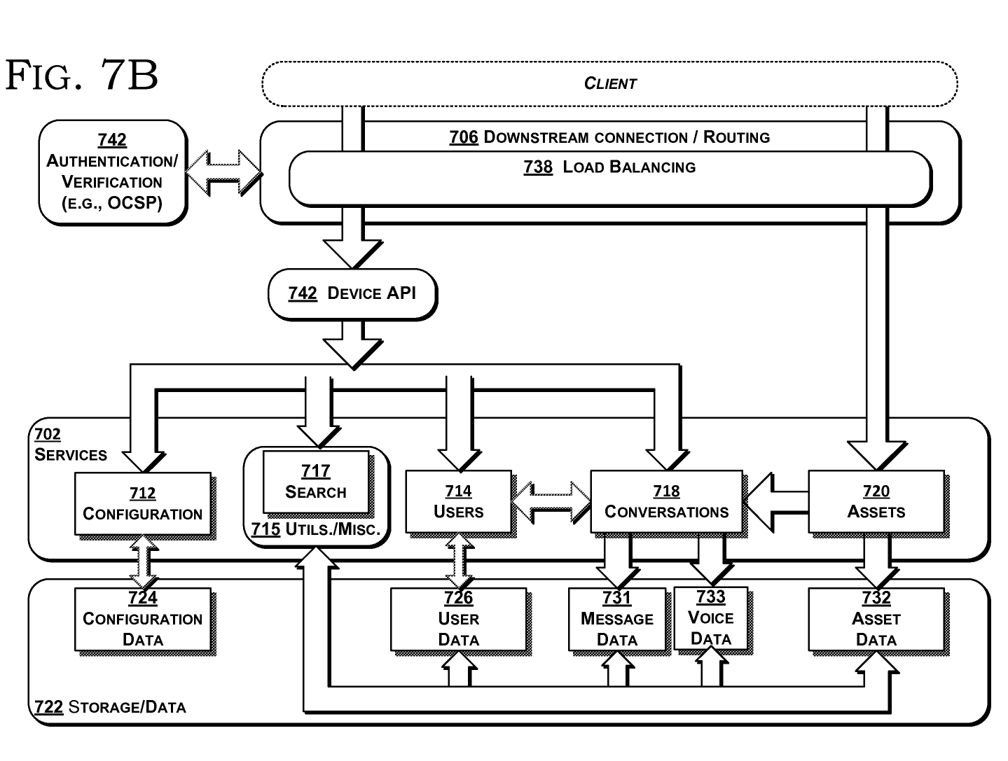

The information described above with reference to FIG. 5A may be stored in or derivable from one or more databases 110 associated with the backend 108 (FIG. 1). For example, at least some of the user information 502 may be stored as or derivable from user data (140, FIG. 3, 726 FIG. 7A).

With reference to FIG. 5B, each conversation 520 has one or more users 102 (denoted 102-1, 102-2 . . . 102-j in the drawing) and conversation information 522 associated therewith. The conversation information 522 may be considered to include the conversation's visible information 524 and the conversation's non-visible information 526 (which may include internal system information such as the conversation ID 146 and other non-visible information 528). The conversation's visible information 524 may include the conversation's name 530, information about the user(s) in the conversation 532, and the events comprising the conversation 534, along with associated time information. The events 534 may comprise message(s) 536 and asset(s) 538 associated with the conversation. The events 534 may also include miscellaneous events 540. The message(s) 536 may include messages between and among the conversation's participants (users(s) 532) as well as system generated messages. The conversation name 530 is a name that may be presented to users. As noted earlier, the user-visible name of a conversation may differ from the system's internal conversation ID 146 for that conversation. It should be appreciated that, in the context of conversations, the notion of “visible” is preferably limited to the participant user(s) 532.

The information described above with reference to FIG. 5B may be stored in or derivable from one or more databases 110 associated with the backend 108 (FIG. 1). For example, at least some of the conversation information 520 may be stored as or derivable from conversation data (142, FIG. 3, 728, FIG. 7A).

Each user 102 in a conversation may interact with that conversation using any device 104 associated with that user (as identified by the user ID), and changes to a conversation are preferably reflected in each present device 104 associated with all users present in the conversation, with the version of the conversation in the conversation database 152 being considered to be the true version of the conversation.

As used herein, a device is “present” if it is online and accessing (or has access to and/or is accessible from) the backend 108. Whether a particular device is present or not present in the system is sometimes referred to as the device's “presence” in the system. A device's presence may be determined in a number of ways. For example, in some case the system may maintain persistent connections with some devices, and, in those cases, the existence of a persistent connection with a device may be used to determine that the device is present. Those of ordinary skill in the art will appreciate and understand that different and/or other techniques may be used to determine whether a device's presence, and that the system is not limited by the manner in which presence is determined.

By way of example, user A may have n devices (device A-1, device A-2, . . . device A-n) associated therewith; user B may have in devices (device B-1, device B-2, . . . device B-n) associated therewith; and user C may have devices 104-C associated therewith. At any time, some or all of user A's devices may be online (or offline). Similarly for user B's devices and user C's devices. User A's devices that are offline (whether turned on or off) are considered to be not present, whereas user A's devices that are online may be considered to be present.

When users A and user B converse, e.g., in a conversation #AB, the messages of that conversation and any other changes to that conversation are preferably reflected in each present device associated with users A and B. The backend 108 maintains conversation #AB in the database(s) 110, and each present device of each participant in that conversation (users A and B) preferably has a view of the conversation #AB consistent with the version in the backend database(s) 110.

If another user C joins the conversation (e.g., as conversation #ABC), the messages of that conversation and any other changes to that conversation are preferably reflected in each present device associated with users A, B, and C. The backend 108 maintains conversation #ABC in the database(s) 110, and each present device of each participant in that conversation (users A, B, and C) preferably has a view of the conversation ABC consistent with the version in the backend database(s) 110.

Users may interact with and view conversations on their devices 104 via user interfaces (UIs) 128 on the respective devices. A user interface 128 provides a view or rendering of an aspect or portion of a conversation (possibly the entire conversation). A view of a conversation within a time period is a view of the objects in that conversation in that time period.

While each present device of each user in a conversation should have the same conversation data, it should be appreciated that the UI of each device 104 of each user associated with a particular conversation may be viewing a different portion of the conversation.

Note that the views of a conversation may cover non-overlapping time periods (as in the example just described), and that the time periods need not be of the same duration or contain the same number of events. That is, each device that has a view of a conversation may have a different view, starting at a different and arbitrary time within the conversation and having an arbitrary duration. However, when two or more devices do have overlapping views of a conversation, the overlapping portions of those views are preferably the same (or contain the same information, however rendered). That is, when two or more devices have views of the same time period of a particular conversation, those views are preferably of the same events/messages, however rendered.

As noted above, while it should be appreciated that while the two devices should have a consistent view of any overlapping data, those of ordinary skill in the art will realize and appreciate, upon reading this description, that actual rendering of that view on different devices may differ. In other words, while the data (objects) corresponding to a view may be identical for two devices, each of those devices may render or present those data differently to the user. For example, the format of the data (e.g., video data or audio data or text data or image data) presented may differ for different devices, even though they are rendering the same data.

Those of ordinary skill in the art will realize and appreciate, upon reading this description, that fully overlapping views of the same conversation data will be the same (although they may be presented differently, e.g., due to device differences, rendering differences, etc.). Furthermore, it should be appreciated that overlapping views of different participant users in the same conversation will preferably also be the same.

As conversations are consistent on all devices, the overlapping views show the same information (regardless of how formatted or rendered). Those of ordinary skill in the art will realize and appreciate, upon reading this description, that the same information may be presented in different manners on different devices, especially on devices of different types. For example, a region or time period which is common to all three views may be presented or rendered differently on a device that is a mobile phone from a device that is running a web-based application using a laptop computer.

### Voice in Conversations

As described above, a conversation may be considered to be or include a sequence of events. Some events may involve sending data from one participant to another (or others) via the backend, and some of the events may involve receiving data from another participant (again, via the backend). A conversation may comprise different types of data, e.g., text/message data, metadata, voice data, control data, etc. Those of ordinary skill in the art will realize and appreciate, upon reading this description, that different and/or other categorizations of conversation data may be used. For example, a particular implementation of the system may split metadata into two distinct metadata channels, one for system data and the other for participant data (e.g., “knock, knock” type of data).

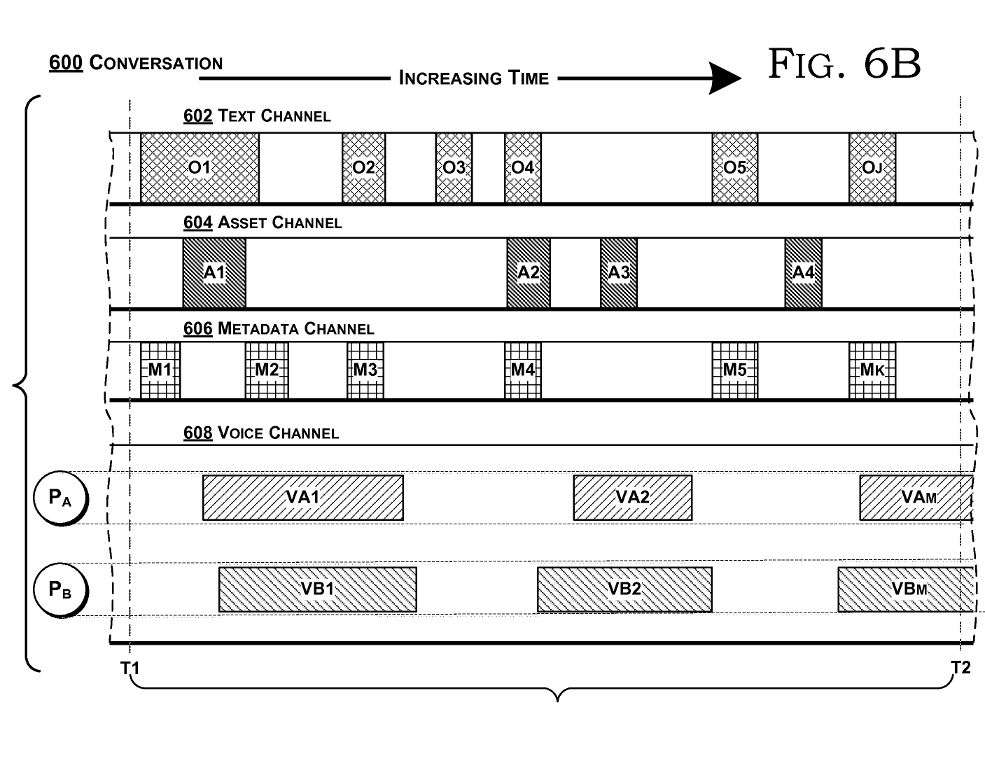

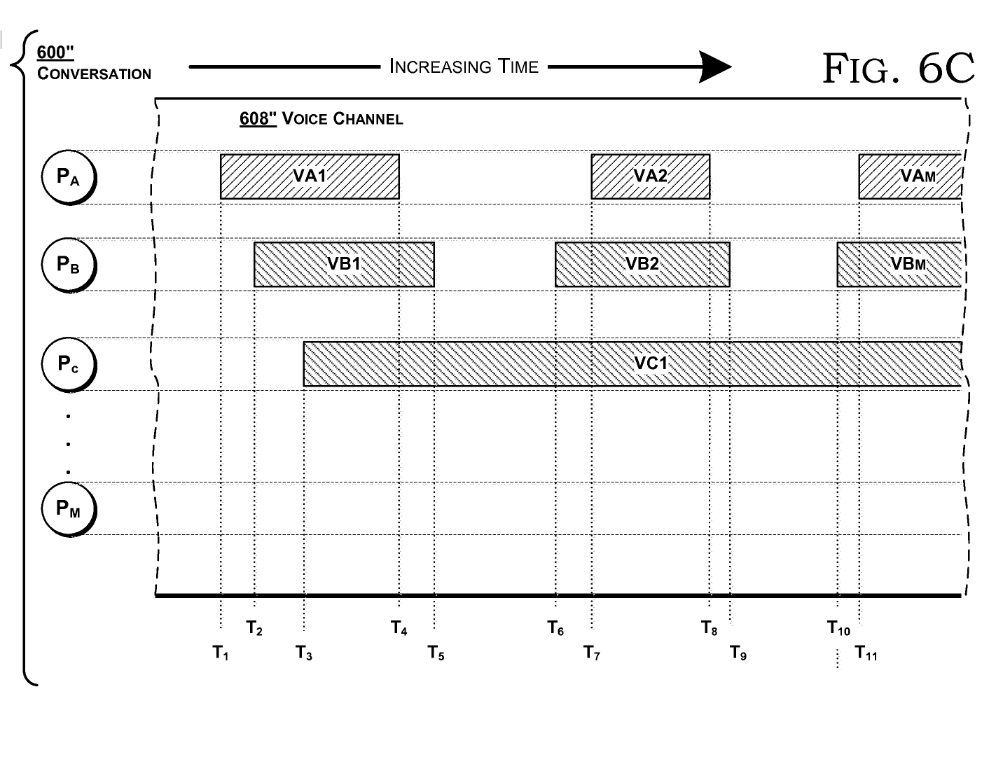

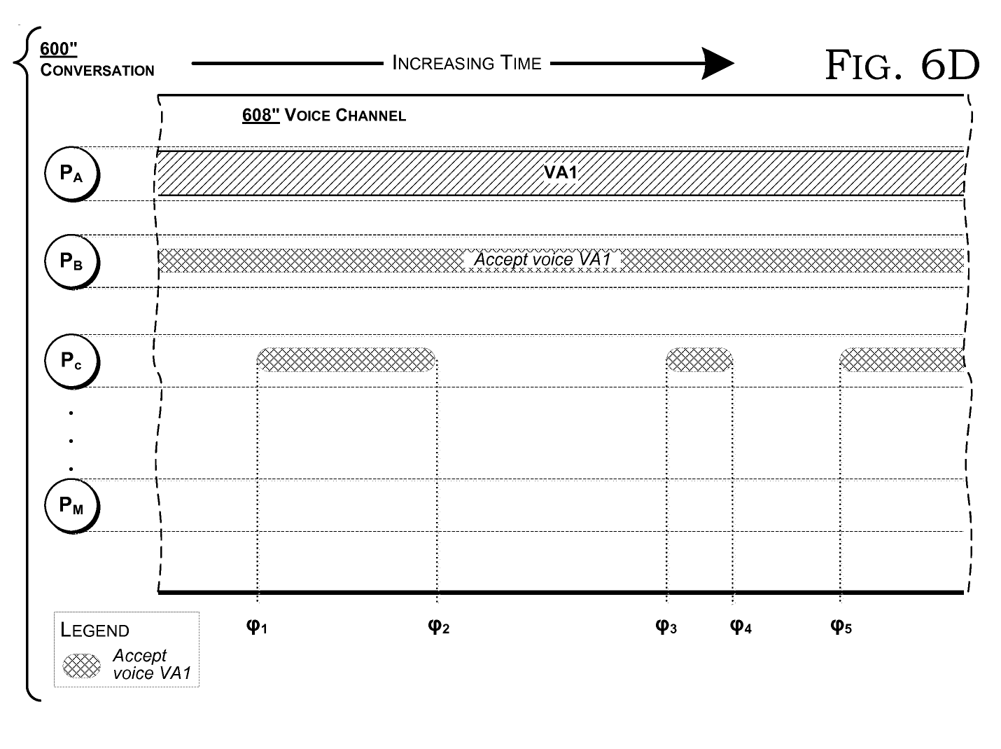

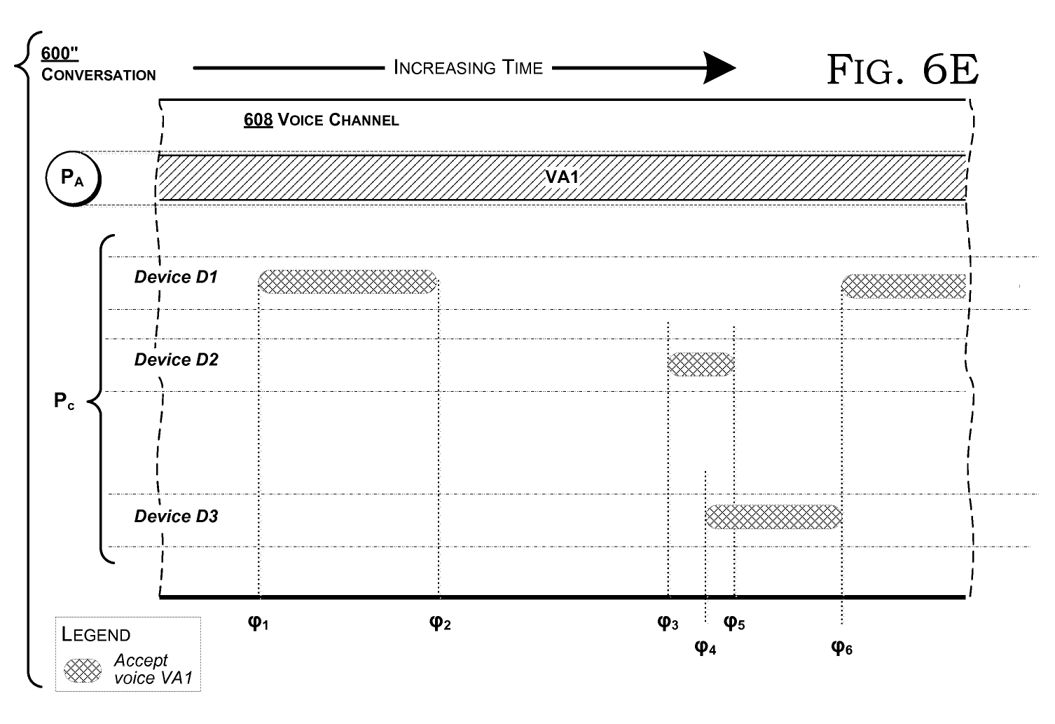

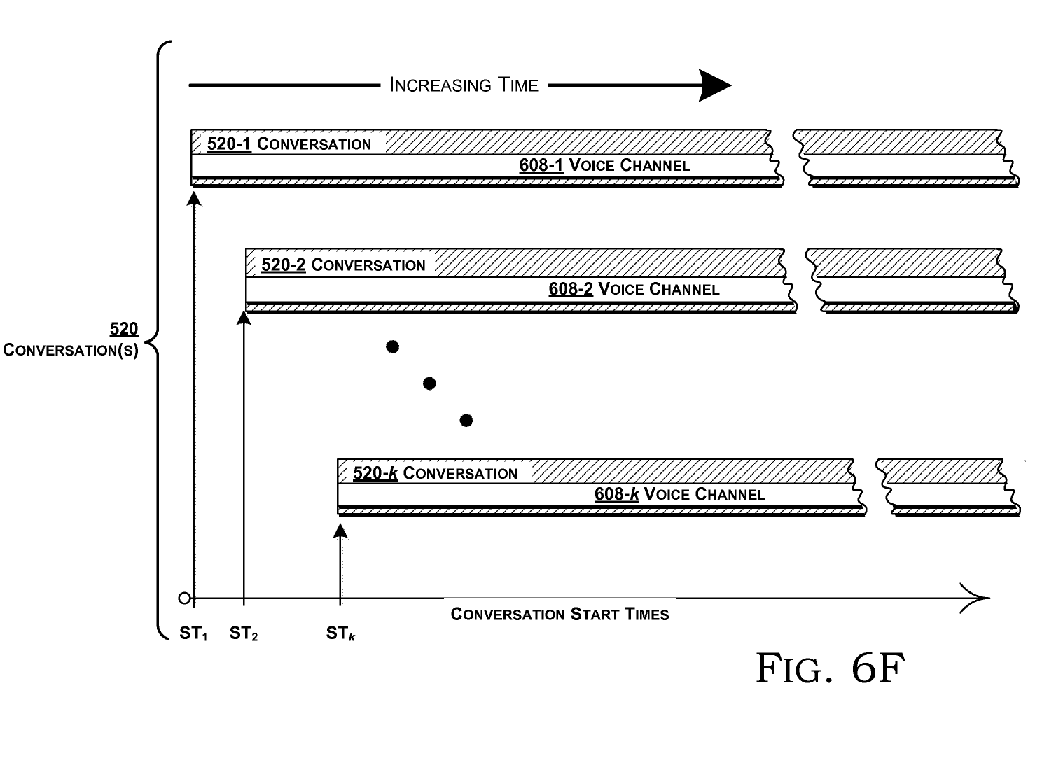

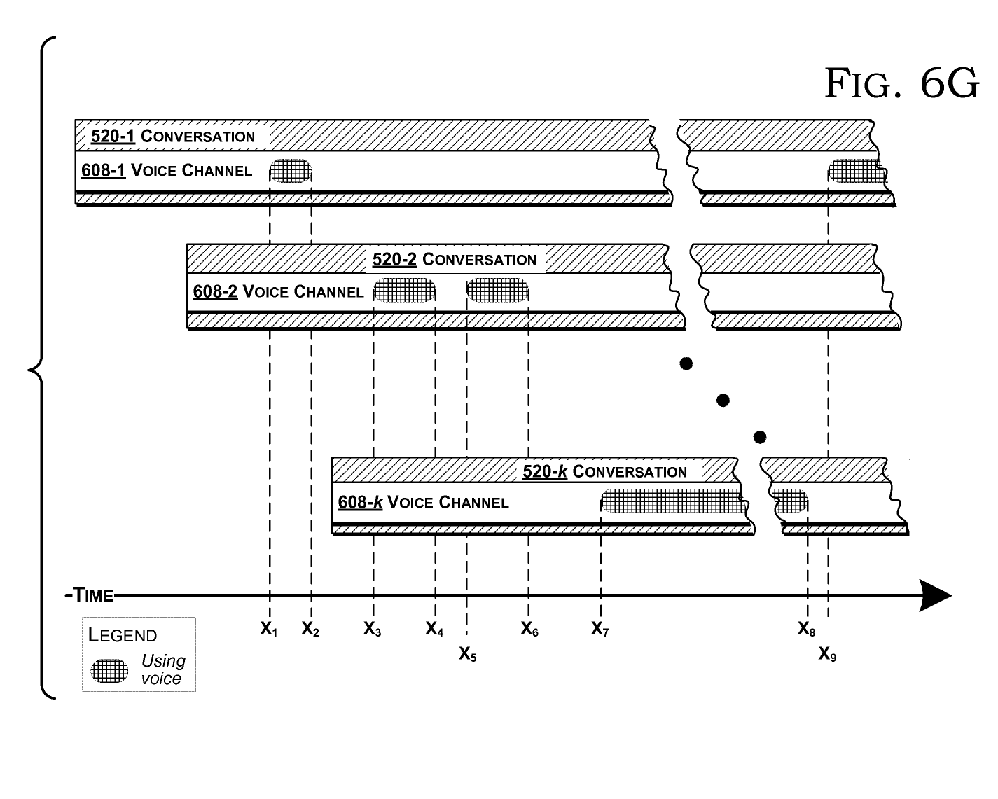

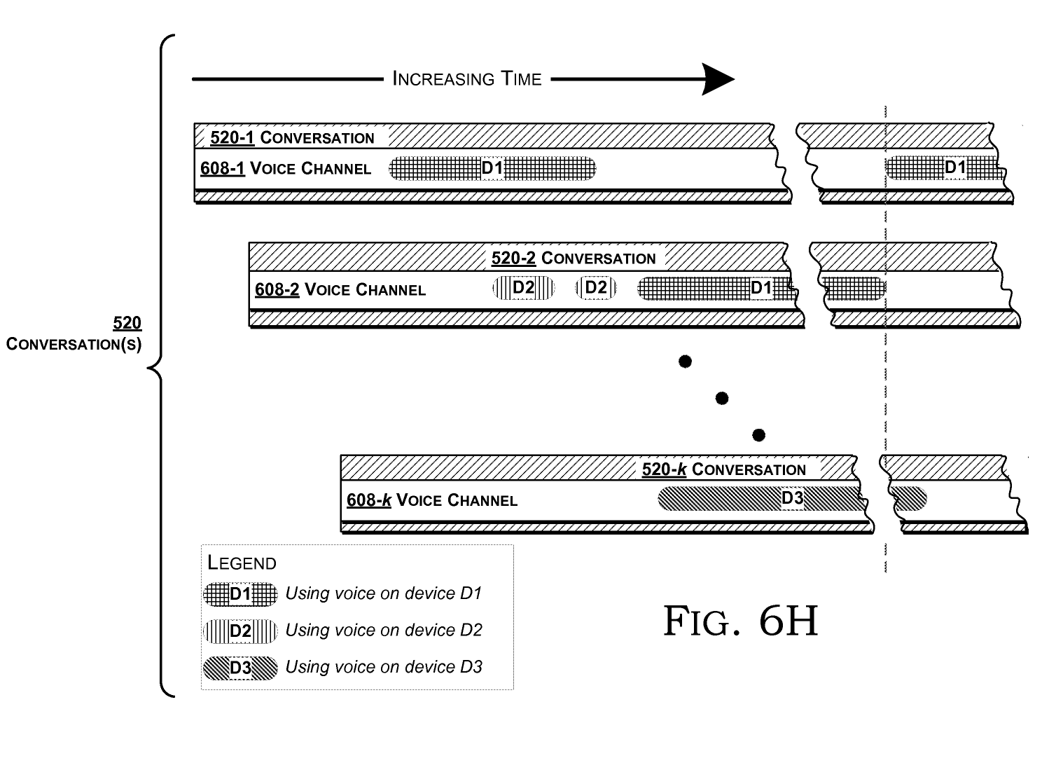

A conversation may thus be considered to comprise or be a collection of multiple logical channels, over which data may be sent and received by the conversation's participant(s), with different types of content (data) requiring or using different logical channels. FIGS. 6A-6C depict aspects of conversations in accordance with embodiments hereof. As shown in FIG. 6A, an exemplary conversation 600 comprises a text channel 602, an asset channel 604, a metadata channel 606, a voice channel 608, and control channel 610. The conversation may include other channels (not shown). The logical channels that comprise a conversation exist simultaneously (in parallel).

As shown in FIG. 6A, the logical channels are preferably present/available in every conversation, from the start of the conversation and ready to be used as needed.

Each type of data may use its corresponding channel. For example, text data within a conversation may use the text channel 602, asset data within that same conversation may use the asset channel 605, metadata within that same conversation may use the metadata channel 606, voice data within that conversation may use the voice channel 608, and control data within that conversation may use the control channel 610.

Each logical channel in a conversation may have its own semantics, policies, and rules, associated therewith, as implemented within the framework 100. In that manner, each type of content may be processed/treated in an appropriate manner for that type of content. For example, in presently preferred implementations, text data (e.g., text messages) are received by intended recipients without any affirmative acts by the intended recipients. On the other hand, as will be explained in greater detail below, voice data (also referred to herein as “voice”) can be treated differently from other types of content (e.g., in some preferred implementations a recipient may have to affirmatively accept voice data). It should be appreciated that requiring an affirmative acceptance of voice data is a policy/implementation feature for the voice channel, and is not a limitation of the system.

The term “voice data,” as used herein, refers generally and without limitation to any kind of data that may be rendered as audio or sound data. Thus, voice data or “voice” may include speech (including synthesized speech) and music.

The various channels may use different types of processing, e.g., in the backend, depending on the way in which the corresponding types of data are expected to be processed. Thus, although voice may be treated/considered as just another kind of data being sent/received (via the backend), voice differs from other data types/content in that (a) voice occurs in “real time” (discussed below); and (b) the recipient preferably has to affirmatively accept the voice data (although, as noted, that is just an implementation/policy decision).

For other purposes, “voice” may be treated as data (content) that is sent/received in a conversation, albeit in its own logical channel.

FIG. 6B shows a part (i.e., a time slice from time T₁ to time T₂) of an example conversation 600 using various logical channels shown in FIG. 6A, including a text channel 602, an asset channel 604, a metadata channel 606, and a voice channel 608. As shown in the drawing, from time T₁ to time T₂ the text channel 602 includes text objects O₁, O₂, O₃, O₄, O₅, . . . , Oⱼ; the asset channel 604 includes assets A₁, A₂, A₃, and A₄; and the metadata channel 606 includes metadata M₁, M₂, M₃, M₄, M₅, . . . , Mₖ. In the description of the text and asset channels it may be assumed that each text object or asset was sent from one conversation participant to all other conversation participants. The drawing, however, does not distinguish between the sender and recipient(s) for these channels. However, for the voice channel 608, to aid in this description, the voice data (content) in the channel is shown in the drawing associated with a particular participant. For the sake of this example (in FIG. 6B), assume that there are two participants (denoted P_{A} and P_{B}) in the conversation 600. Thus, as shown in FIG. 6B, from time T₁ to time T₂ the voice channel 608 includes voice data (voice) VA₁, VA₂, . . . . , VA_{R}, from participant P_{A}, and voice data VB₁, VB₂, . . . , VBₘ from participant P_{B}. It should be appreciated that in this example the participants are users. Thus, as used in this example, voice data is said to be from a participant P when that voice data is from a device associated with participant P (regardless of how many devices that participant has).

Thus, in the drawing in FIG. 6B, a block (e.g., representing a message or an asset or metadata or voice data) denotes an exchange within the conversation either between participants, or between the system and one or more participants (e.g., in the case of metadata). So in the text channel the block labeled O₁ refers to an exchange of text in the conversation 600. Similarly for the blocks labeled O₂, O₃, etc. In the asset channel the block labeled A₁ refers to an exchange of an asset between participants in the conversation 600. Similarly for the blocks labeled A₂, A₃, etc. In the metadata channel the block labeled M₁ refers to metadata or system data in the conversation 600. Similarly for the blocks labeled M₂, M₃, etc. In the voice channel the blocks labeled VA_{#} refer to a voice exchange between participants. As noted above, however, in preferred implementations a participant in a conversation needs to affirmatively accept voice data. Therefore, even though participant P_{A} sends voice data VA₁, VA₂, VAₘ during the time period shown in FIG. 6B, it need not be the case that any other participant (e.g., participant P_{B}) accepted any of the voice data. It is also possible that a participant (e.g., participant P_{B}) accepted and received some of the voice data from participant P_{A} (e.g., voice data VA₁) but did not accept or receive the other voice data (e.g., voice data VA₂, VAₘ) from participant P_{A}. Note that the term “voice” may be used in place of “voice data,” so that, e.g., voice data VA₁ may also be referred to as voice VA₁.

In the drawings (FIGS. 6A-6C), time flows from left to right, so that, e.g., voice VA₂ occurs after text T₄ and asset A₂ and metadata M₄ have been sent. Note, however, that voice VA₂ overlaps in time with asset A₃ and with voice VB₂.

As noted earlier, the drawings are not to scale (unless specifically stated otherwise), and so it should be appreciated that the time period (T₁ to T₂) being depicted in the example conversation 600 in FIG. 6B may be minutes, hours, days, or longer. Similarly, the time period between events (e.g., text O₃ and text O₄) may be seconds, minutes, hours, days, weeks, etc.

FIG. 6C shows another example of a portion of an exemplary conversation 600″, this time focusing primarily on the voice channel 608. It should be appreciated that the other channels (e.g., text, asset, metadata, control) are used or available in this conversation, but are being omitted from the drawing to aid in this discussion. In this example, during the time period depicted in the drawing, the conversation has participants P_{A}, P_{B}, P_{C}, . . . . , P_{M}. During the time period shown in the drawing, participant P_{A} sends voice data VA₁ (from time T₁ to time T₄), voice data VA₂ (from time T₇ to time T₈), and voice data VA₃ (from time T₁₁ to some time out of the range of the drawing); participant P_{B} sends voice data VB₁ (from time T₂ to time T₅), voice data VB₂ (from time T₆ to time T₉), and voice data VB₃ (from time T₁₀ to some time out of the range of the drawing); and participant P_{C} sends voice data VC₁ (from time T₃ to some time out of the range of the drawing). None of the other participants (including P_{M}) sends any voice data during the time period shown in the drawing. Note that each of the participants may be receiving the voice data sent by the other participants on any of their present device(s), however, since, in presently preferred implementations, a participant may reject (or not accept) voice data, it may be the case that a participant (e.g., participant P_{M}) is present by chooses not to receive any of the voice data sent by some or all of the other participants.

As noted above, in preferred embodiments each participant may choose whether or not to accept voice data from other participants. A participant may preferably chose whether or not to receive voice data at any time during a conversation, and may switch between receiving voice data and not receiving voice data at any time during a conversation. In addition, in some embodiments a particular participant may chose to receive voice data from some other participants and not others during the same time period. In preferred embodiments, a participant may choose to receive voice data on all present devices, on some devices and not others, or on no devices. In some embodiments a user may choose to receive data from some participants on some devices and from other participants on other devices. The selection (acceptance or rejection) of voice data is preferably controlled by a user interface on the user's devices, although in some implementations users may be able to set default control values for voice data. An exemplary UI is described below. Such default control values may be based, e.g., on time of day, which devices are present, the identity of the voice originator, etc. Thus, e.g., a user (participant) may set a default to no voice (without specific acceptance) from 10 PM to 7 AM on all devices; or to no voice (without specific acceptance) unless the voice is from participant Pₓ. As another example, a user (participant) may set a default to no voice without specific acceptance at all times on all devices except device D which, if present, may accept all voice from all participants. This default effectively sets device D to a voice-accepting device whenever device D is present. The default is preferably no voice without specific acceptance at all times and for all participants and on all devices. It should be appreciated that these examples are not limiting of the kinds of control that the system may provide for voice data.

A user may be able to accept voice data at any time after that voice data has begun and arbitrarily to switch back and forth between accepting the voice data and not accepting the voice data. For example, FIG. 6D shows a voice channel 608″ of a portion of a conversation k≧1. The conversation has participants P_{A}, P_{B}, P_{C}, . . . P_{M}. During the time period depicted in the drawing participant P_{A} is producing voice data VA₁ on the voice channel 608″. It should be appreciated that during the time period shown other data may be on the other channels (not shown), and that other voice data (also not shown) may also be on the voice channel 608″.

In the example in FIG. 6D, the cross-hatched regions are used to show the time(s) during which participants accept voice VA₁ from participant P_{A}. As shown in the drawing, participant P_{B} receives (accepts) voice VA₁ from participant P_{A} for the entire time period shown in the drawing. Participant P_{C} accepts (receives) voice VA₁ from time φ1 to φ2 and from time φ3 to φ4, and then again from time φ5 to some time not shown in the drawing. Participant P_{M} does not accept voice VA₁ at any time during the period shown in the drawing. Note that the system is not limited by the manner in which a participant switches between accepting and not accepting voice VA₁. For example, the user (P_{C}) may use a UI on a present device to switch between accepting and not accepting voice VA₁; or the acceptance of voice VA₁ may be controlled by default values (e.g., associated with user P_{C} and/or user P_{A}).

It should be appreciated that in some embodiments a particular user (participant) may be accepting voice from some participants and not others during the same time period. Thus, e.g., with reference again to the example conversation 600″ in FIG. 6D, participant P_{M} may be accepting voice data from some of the other participants (other than P_{A}) during the time period shown, even though P_{M} is not accepting any voice data from participant P_{A} during this period.

A user may accept voice data on one or more present devices simultaneously. FIG. 6E shows a portion of exemplary conversation 600″ in which participant P_{A} produces voice data VA₁ for the entire period of time shown in the drawing. Participant P_{C} has three devices (D₁, D₂, and D₃), and accepts voice VA₁ on device D₁ from time φ1 to φ2 and then again from time φ6 to some time not shown in the drawing. Participant P_{C} also accepts voice VA₁ on device D₂ from time φ3 to φ5, and on device D₃ from time φ4 to φ6. As can be seen in the drawing, participant P_{C} is accepting data on two devices (D₂ and D₃) at the same time between times φ4 to φ5. It should be appreciated that during the time period shown participant P_{C} may be accepting voice data from other participants (not shown) on the same or other devices. It should further be appreciated and understood that participant P_{C} may accept voice data from one participant on one device and from another participant on another device at the same time. Thus, e.g., during the period φ1 to φ3 (or φ4), participant P_{C} may be accepting voice data from participant P_{B} (not shown) on device D₃.

Some implementations may limit the number of devices on which a participant may receive simultaneous voice data from the same conversation.

As noted, various channels may use different types of processing, e.g., in the backend, depending on the way in which the corresponding types of data are expected to be processed. A channel may thus provide a way to define and control the manner in which the system handles and processes different kinds of data within a conversation. Each channel may thus have semantics associated therewith, where the semantics of a channel define how the system operates on data in that channel.

By way of example, in some implementations, the semantics of the text channel are that text messages are immediately sent to all present devices of all participants. The semantics of the asset channel are that when an asset is sent, a placeholder is immediately put in the conversation and sent to all present devices of all participants. But the actual asset is then uploaded in a separate process (which may be right away, or delayed). The semantics of the metadata channel may depend on the kind of metadata. For example, metadata about a user leaving or joining the conversation may be displayed on participants' devices, whereas some system metadata may not be rendered at all. And the semantics of the voice channel may include that intended recipients have to actively accept participation. Those of ordinary skill in the art will realize and appreciate, upon reading this description, that these are only examples of semantics of various channels. Within a particular implementation, a channel's semantics may include different and/or other processing rules and/or procedures. The system may have the same semantics for different channels.

Channels and channel semantics may also provide discriminatory handling and processing of data by the backend. For example, the backend may search and/or index all data in the text channel, but not necessarily do the same for all asset data or voice data.

As discussed above, with reference again to FIG. 5A, each user 102 may be associated with one or more conversations 520, e.g., denoted 520-1, 520-2, . . . 520-k (k≧1). Each of those k conversations preferably has the various logical channels described above with reference to FIGS. 6A-6E. Thus, as shown in FIG. 6F, each user 102 has k conversations (k≧1). Those of ordinary skill in the art will realize and appreciate, upon reading this description, that conversation 600 in FIGS. 6A-6B, and 600″ in FIGS. 6C-6E are instances of conversations 520-i, for some i in FIG. 6F. As shown in the drawing, each conversation 520-i has its own corresponding logical voice channel 608-i (the other channels, e.g. text, asset, metadata, and control, are not shown in this drawing). Thus, e.g., conversation 600″ in FIG. 6E corresponds to a conversation 520-p, for some 1≦p≦k (in FIG. 6F), and voice channel 608″ for conversation 600′ in FIG. 6E corresponds to voice channel 608-p for conversation 520-p. As can be seen in the drawing, each conversation 520-p, for 1≦p≦k has a corresponding start time STₚ.

A user may use (e.g., initiate or accept) voice on each voice channel in each conversation associated with that user. Thus, as shown in FIG. 6G (which shows the conversations 520 of FIG. 6F associated with a particular user), the user may be using voice on voice channel 608-1 from time x₁ to x₂, on voice channel 608-2 associated with conversation 520-2 from time x₃ to x₄ and again from time x₅ to x₆; on voice channel 608-k associated with conversation 520-k from time x₇ to x₈, and on voice channel 608-1 again from time x₉ to some time not shown in the drawing. It should be appreciated that the times shown in this drawing are by way of example only, and that the user may be using voice on these voice channels (and in other voice channels in other conversations not shown) at different and other times.

Note that the drawing does not distinguish between the user's devices, and those of ordinary skill in the art will realize and appreciate, upon reading this description, that when using voice, the user may be using voice on one or more of the user's devices.

While there is preferably no overlap between voice use on different voice channels (i.e., in different conversations), in some embodiments a user may be actively involved in different conversations on different devices, in which cases the user may be using voice simultaneously in more than one conversation. For example, as shown in FIG. 6G, the user is using voice on device D1 on voice channel 608-1 (associated with conversation 520-1) and, for at least some of that time, using voice on a different device D2 on voice channel 608-2 (associated with conversation 520-2) and also using voice on yet another device D3 on voice channel 608-k (associated with conversation 520-k). The user may also use device D1 on the voice channel 608-2. Note, however, that the user's use of device D1 for voice on voice channel 608-1 does not overlap with the use of that same device for voice on voice channel 608-2. While only three devices are shown in this example, it should be appreciated that the user may have and be using other devices at the same time in the same and/or different conversations.

Some implementations may limit the number of voice channels (or conversations) a user may be simultaneously involved in, even on different devices.

Getting Users' Attention—Knocks and Knocking

The etiquette associated with VOIP calls has changed from that of POTS calls. VOIP cold calls are rare, and there is typically a back and forth between the participants using text messaging or email or the like to establish times for such calls. (e.g., “Are you there?” “Can I call now?” “How about in 5 minutes?”).

The system as described herein provides suitable support for such approaches. As described, embodiments of the system provide a substantially permanent voice channel per conversation that any participant in the conversation can join and leave at any time.

It is therefore desirable and useful for users to be able to get each other's attention in some way, whether or not they are involved in a conversation.

In the communication framework described herein a conversation, once begun, generally does not end even when there is no activity in that conversation. This is particularly the case for conversations actively using voice, since the preferred default behavior of the system is to require users to affirmatively accept voice data.

As noted before, the backend provides a persistent store through which users share data. Users may therefore connect or reconnect to a conversation at any time and obtain essentially the entire conversation, including parts of the conversation for which they were absent (i.e., for which they did not have any device present or for which they had devices present but did not accept some aspects of the conversation, such as voice).

It should be appreciated that in some embodiments the backend may store voice data associated with each conversation, although this option is less preferred. When voice data are stored, they are preferably stored in a compressed form. Even though the backend may, in some embodiments, maintain and store voice data, voice conversations are preferably real-time. Thus, regardless of whether or not the backend maintains voice data, the nature of voice conversations makes it generally preferable to have other conversation participants listening.

It is therefore generally desirable for each user to be able to get the attention of other users, regardless of whether or not they are already in a conversation with each other.

The approach described herein whereby a user tries to get the attention of one or more other users is referred to herein as “knocking.” The term “knocking” refers generally to an approach, within the system, whereby one user tries to get the attention of one or more other users. In some aspects, as used herein, the term “knocking” refers to the act(s) or process(es) of getting one or more user's attention. As used herein, the user doing the knocking is sometimes referred to as the “knocker,” and a user whose attention a knocker is trying to get is sometimes referred to as a “recipient.”

While knocking is particularly useful for voice conversations (i.e., conversations which are actively using voice) it should be appreciated and understood that knocking is applicable to other aspects of conversations. Thus, for example, knocking may be used before, during, or after joining a voice channel of a conversation. Even in the embodiments in which uses do not have to affirmatively accept voice data (i.e., when the default is to accept all voice data) knocking may be used by a user to get or try to get the attention of other users.

As will be described below, the system's user interface preferably provides ways for users to get each other's attention, e.g., by so-called knocking. When a particular user knocks, in order to get the attention of one or more other users, each of the other users is preferably given some indication that the particular user is trying to get their attention. As the user interface supports multiple views (e.g., a list view in which other uses are listed, a conversation view in which conversations are listed, a conversation list view, etc.), the user interface may provide different forms of knock indication depending on the view.

The user interface preferably also provides ways for users to respond to a knock (i.e., to an attempt to get their attention). In this context, a “knock” may refer to an indication on a user's device that another user is trying to get their attention. The response may be to reject or ignore the knock or to interact with the knocking user (e.g. to join or rejoin a conversation with that user or to open and accept a voice channel in a conversation with that user, etc.). In some cases, a user may provide a default response message, either by text or voice, to knocks from other users.

The types and options of responses that a user may provide to a knock may depend on the user's current state within the system. For example, if the user is already in another conversation using voice, the user may have different response options provided than if the user is inactive.

Knocking indications preferably include both visual and sound indicators. For example, knocking may cause a recipient's devices that are present in the system to play distinctive sounds and have visual indicators (e.g., animation, flashing, etc.).

Since knocking generally indicates some sense of time sensitivity, in preferred embodiments knocks expire after some period of time, and the visual and/or sound indicators associated with a knock may increase in intensity over time.

In some embodiments the system, via the UI, may provide the ability for users to escalate their notifications (i.e., knocks) to other users thereby to express a greater sense of urgency and possibly increase the chances of the recipient noticing the knocks. These escalated knocks are sometimes referred to herein as “hot knocks.”

Aspects of knocking, including the UI associated with knocking, are described in greater detail below.

### Exemplary Implementation

An architecture of an exemplary implementation of system 100 is described here. FIG. 7A, which depicts a logical view of an exemplary architecture of system 100. The architecture is described here in terms of various logical components or divisions, and in terms of data flow. As will be appreciated by those of ordinary skill in the art, upon reading this description, different and/or other organizations and structures are possible and are contemplated herein. It should be appreciated that the logical structure shown in the drawings is used as an aid in this description, and that the system 100 is not limited by the logical structure used here to describe it.

Clients 700 in FIG. 7A may correspond to user devices 104 (FIGS. 1 and 2A-2D) that have been registered with the system 100 (that is, user devices to which the system 100 has assigned a device ID). A client need not be present. A client may be any kind of device including a device such as a smartphone (e.g., an IOS or android device, etc.), a handheld tablet device (e.g., an Apple iPad or the like), a special-purpose device program specifically to operate within the system 100, and application running on a general purpose or special purpose computer device, or a web-based application.

As used herein, for this description, “downstream” refers to the direction from devices to the backend, whereas “upstream” refers to the direction from the backend to one or more devices.

Clients 700 communicate with the backend 108 and with each other via the backend. In order to communicate with the backend or with other clients, a client may communicate with one or more backend services 702 via connection and routing mechanism(s) 704. Connection and routing between clients and backend services in the downstream direction may use downstream connection and routing mechanism(s) 706. Clients 700 may use API 708 in order to communicate downstream. It should be appreciated that not all backend system services 702 need be directly visible to or accessible directly by clients 700, even using the API 708. Connection and routing between the backend services and clients in the upstream direction may use upstream connection and routing mechanism(s) 710.

The backend system services 702 may include configuration services 712, user services 714, utilities and miscellaneous services 715, and conversation/asset manager services 716. The conversation/asset manager services 716 may include conversation services 718 and asset services 720. The utilities and miscellaneous services 715 may include search services 717. The backend system services 702 may correspond to, or be implemented by, backend applications 112 in FIGS. 1 and 3.

The backend system services 702 may maintain and access storage/data 722. The storage/data 722 may be stored/maintained in the backend databases 110 of FIG. 1. Storage/data 722 may include configuration data 724, user data 726, device data 728, and conversation data 730. Conversation data 730 may include message data 731 and asset data 732.

The backend system preferably maintains and can access state information via state mechanism(s) 734. State mechanism(s) 734 may include presence (device or client status) mechanisms 736. The state mechanism(s) 734 preferably provide state information (for example, presence information about devices) to the upstream connection/routing mechanism(s) 710. The state mechanism(s) 734 may obtain or determine state information directly from clients 700 and/or via connection and routing mechanism(s) 704 (for this reason, in the drawing in FIG. 7A the downstream arrow connecting clients 702 state 734 is shown partially overlapping connection and routing mechanism(s) 704).

The connection and routing mechanism(s) 704 may use authentication/verification mechanism(s) 742, e.g., to authenticate client downstream requests to the backend and/or backend upstream communications to clients. It is preferable and desirable that clients authenticate themselves when communicating downstream with the backend. Likewise, it is preferable and desirable that backend upstream communication with clients be authenticated and/or verified. Various authentication techniques may be used, including certificate-based and token-based authentication, and it should be appreciated that the system is not limited by the authentication/verification scheme(s) used. The authentication/verification mechanism(s) 742 may include, for example, CA(s) 119 (FIG. 1). In order to support operation of the system without continuous access to CA(s) 119, the authentication/verification mechanism(s) 742 may include some way of determining the revocation status of digital certificates while offline, for example, using an OCSP service (OCSP is an Internet protocol for obtaining the revocation status of X.509 digital certificates).

To aid in this description, FIG. 7B shows aspects of the system in FIG. 7A dealing primarily with downstream processing (from clients to the backend), and FIG. 7C shows aspects of the system FIG. 7A dealing primarily with upstream processing (from the backend to clients). As shown in FIG. 7B, the downstream connection and routing mechanism(s) 706 may include load-balancing mechanism(s) 738. As shown in FIG. 7C, the upstream connection and routing mechanism(s) 710 may include event routing mechanism(s) 744.

A User Interface (UI)

Clients (users' devices) interact with each other and the system 100 via the backend 108. These interactions preferably take place using a user interface (UI) application 128 running on each client (e.g., device 104, FIG. 2A).

Devices

A UI is implemented, at least in part, on a device 104, and preferably uses the device's display(s) and input/interaction mechanism(s). Use of a UI may require selection of items, navigation between views, and input of information. It should be appreciated that different devices support different techniques for presentation of and user interaction with the UI. For example, a device with an integrated touch screen (e.g., device 104-C as shown in FIG. 2C) may display UI information on the touch screen 202, and accept user input (for navigation, selection, input, etc.) using the touch screen (perhaps with a software/virtual keyboard for some types of input). A device with an integrated screen, keyboard, and mouse (e.g., device 104-D as shown in FIG. 2D) may display UI information on the screen 204, and accept user input using the hardware keyboard 206 and hardware mouse 208. If the screen/display 204 is also a touch screen display, then user interactions with the UI may use the screen instead of or in addition to the keyboard 206 and mouse 208. A device with separate components (e.g., device 104-A of FIG. 2A) may display UI information on the display 212 and accept user input to the UI using the keyboard 214, mouse 216 (and possibly via gesture mechanism 218).

UI Interactions

A UI presents information to a user, preferably in the form of text and/or graphics (including drawings, pictures, icons, photographs, etc.) on the display(s) of the user's device(s). The user may interact with the UI by variously selecting regions of the UI (e.g., corresponding to certain desired choices or functionality), by inputting information via the UI (e.g., entering text, pictures, etc.), and performing acts (e.g., with the mouse or keyboard) to affect movement within the UI (e.g., navigation within and among different views offered by the UI).

The UI application(s) 128 (FIG. 2A) preferably determines (or knows) the type and capability of the device on which it is running, and the UI may vary its presentation of views depending on the device. For example, the UI presented on a touch screen display on a smartphone may have the same functionality as the UI presented on the display of general purpose desktop or laptop computer, but the navigation choices and other information may be presented differently.

It should be appreciated that, depending on the device, the UI may not actually display information corresponding to navigation, and may rely on parts of the screen and/or gestures to provide navigation support. For example, different areas of a screen may be allocated for various functions (e.g., bottom for input, top for search, etc.), and the UI may not actually display information about these regions or their potential functionality.

As has been explained, and as will be apparent to those of ordinary skill in the art, upon reading this description, the manner in which UI interactions take place will depend on the type of device and interface mechanisms it provides.

As used herein, in the context of a UI, the term “select” (or “selecting”) refers to the act of a user selecting an item or region of a UI view displayed on a display/screen of the user's device. The user may use whatever mechanism(s) the device provides to position the cursor appropriately and to make the desired selection. For example, a touch screen 204 on device 104-C may be used for both positioning and selection, whereas device 104-D may require the mouse 208 (and/or keyboard 206) to position a cursor on the display 204 and then to select an item or region on that display. In the case of a touch screen display, selection may be made by tapping the display in the appropriate region. In the case of a device such as 104-A, selection may be made using a mouse click or the like.

Touch Screen Interfaces and Gestures

Touch-screen devices (e.g., an iPad, iPhone, etc.) may recognize and support various kinds of touch interactions, including gestures, such as touching, pinching, tapping, and swiping. These gestures may be used to move within and among views of a UI.

Voice Menu

The UI preferably provides a user with a way to use and control voice aspects of a conversation. For example, the UI on a device preferably provides the user with a way to initiate a voice conversation, mute a voice conversation, join an existing voice conversation, leave a voice conversation, and switch devices within a voice conversation. It should be appreciated that, as discussed above, voice is a kind of content that may have its own channel(s) within a conversation. Thus, as used herein, the term “voice conversation” may refer to the voice channel of a conversation. Thus, e.g., the phrase “initiate a voice conversation” may mean to “initiate the voice channel of a conversation,” and so on.

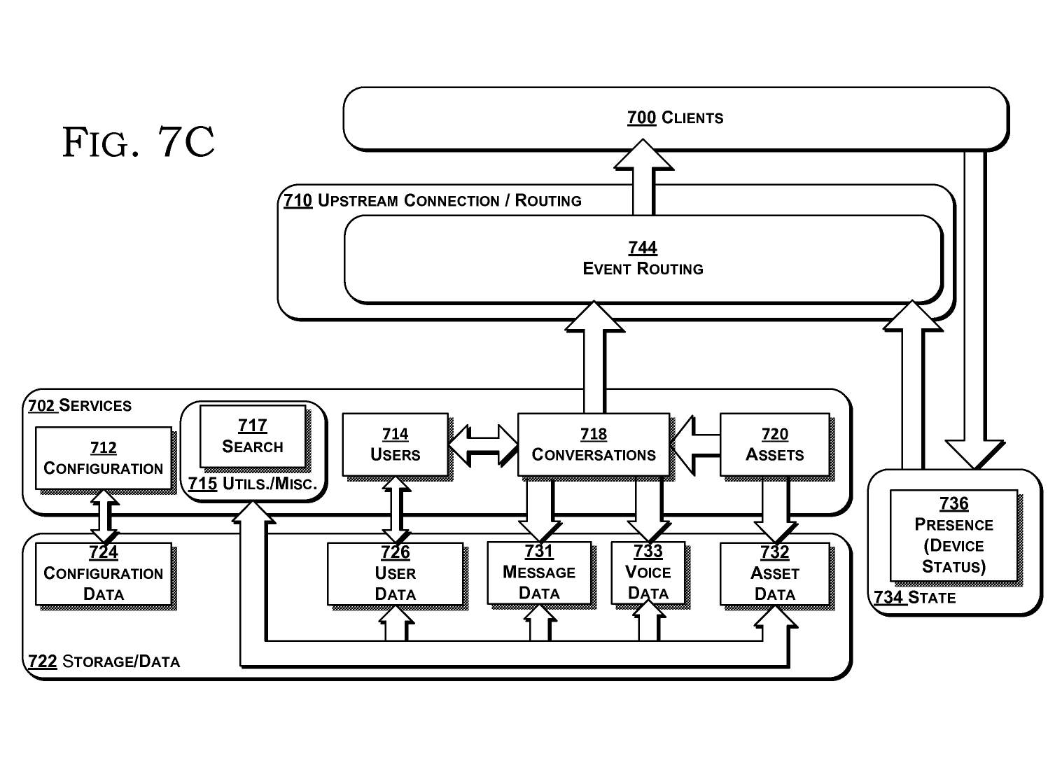

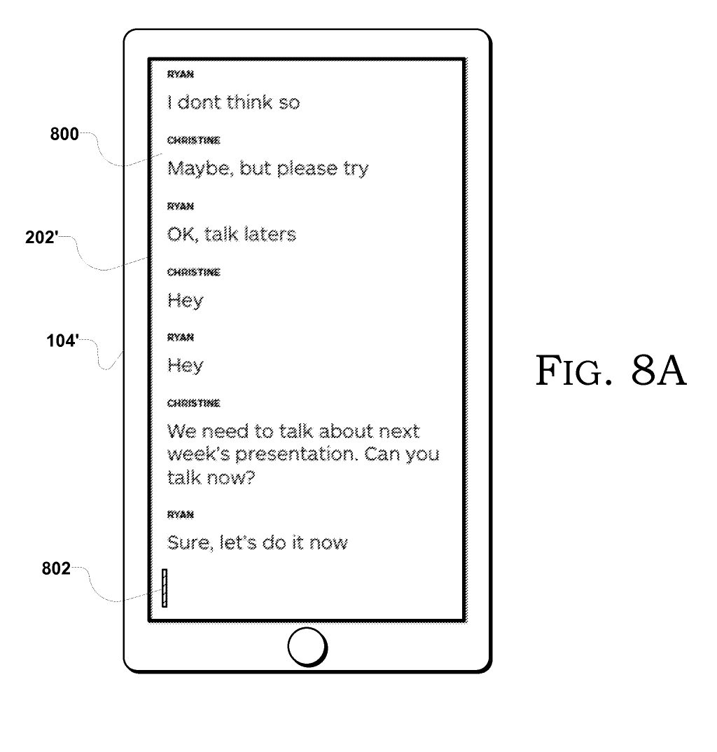

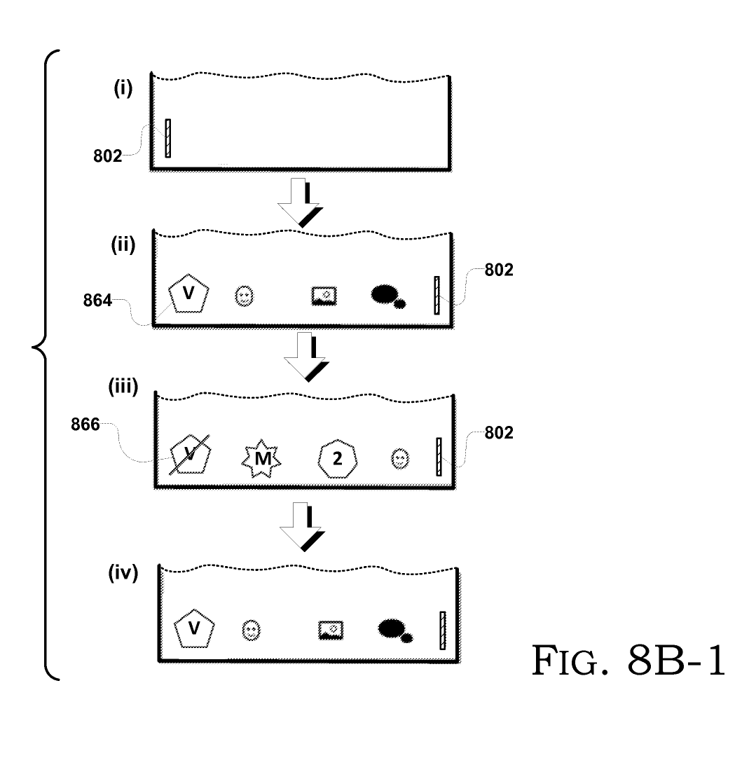

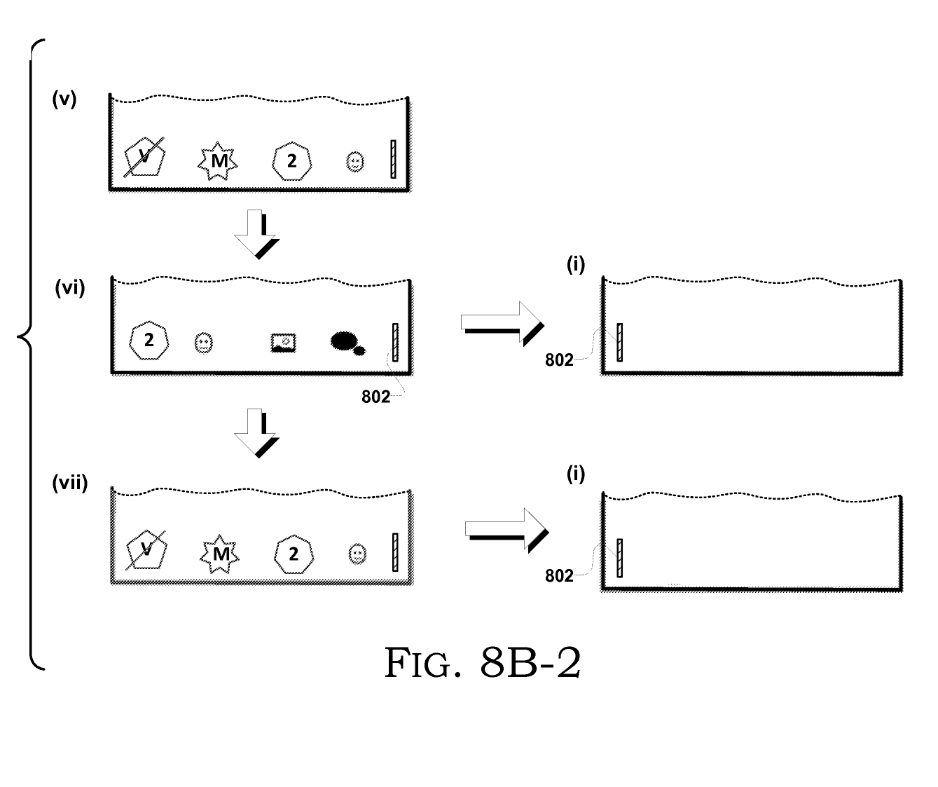

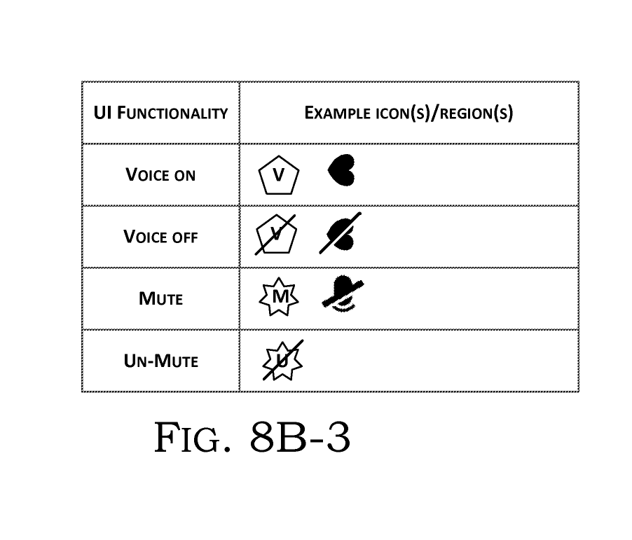

FIGS. 8A-8E depict aspects of exemplary user interfaces in accordance with embodiments hereof for initiating and controlling voice and for knocking within the system.

FIG. 8A depicts an exemplary UI 800 presented on the display screen 202′ of a device 104′ (such as, e.g., an iPhone or the like as described above with reference to FIG. 2C). The UI 800 on screen 202′ in this drawing displays a portion of a conversation between at least two participants (“Ryan” and “Christine”). The UI 800 includes a cursor 802 (e.g., displayed as a vertical bar) on the lower left side of the screen. Those of ordinary skill in the art will realize and appreciate, upon reading this description, that the UI 800 on device 104′ may be implemented, at least in part, by the user interface (UI) application(s) 128 (of the device/client application(s) 114) on device 104′ (described above with reference to FIG. 2A). For the remainder of this description the term “UI” with reference to a particular device refers to the user interface produced and run on that device using at least some of the UI application(s) 128 on that device.

The UI on a device may provide access to a menu of options relating to voice conversations. The menu may be provided, e.g., as a sliding menu below an input cursor on the display of the device, e.g., as described in U.S. Provisional Patent Application No. 61/838,942, titled “User Interface With Sliding Cursor For Multimodal Communication Framework,” filed Jun. 25, 2013, the entire contents of which are fully incorporated herein by reference for all purposes (and which is included herein as Appendix B).

Although the drawings in FIGS. 8A, 8B-1, and 8B-2 show a menu for a device such as a smartphone, those of ordinary skill in the art will realize and appreciate, upon reading this description, that a similar menu or a menu with similar functionality may be used on different devices, including a computer, a web interface, a set-top box, etc.

The user can select the cursor 802 or a region around it in order to enter text in the conversation. In addition, as described here, the user may slide or move the cursor (or a portion of the screen to the right of the cursor) to the right in order to expose an underlying menu (e.g., as shown in FIGS. 8B-1, 8B-2). In the example shown in FIG. 8B-1, in a mode such as text input mode, the cursor 802 is on the left side of the display region (as shown in view (i)). As noted U.S. Provisional Patent Application No. 61/838,942, for some embodiments, e.g., for right-to-left languages, the default cursor position may be on the right side of the display region. As shown in view (ii) in FIG. 8B-1, the exposed menu preferably includes a “talk” or “voice” icon or region 864, that, when selected causes the device to initiate a voice conversation (e.g., to open or join a voice channel of a conversation). Thus the “talk” or “voice” icon/region, when selected, may cause the UI to initiate voice within the current conversation (i.e., within the conversation being displayed on the screen).

In the example shown in view (ii) in FIG. 8B-1, the “talk” or “voice” icon/region is shown as a pentagon with the letter “V” inside it. It should be appreciated that this depiction is provided only for the sake of this description, and that different and/or other depictions of the “talk” or “voice” icon/region may be used.

As shown in the drawings, the menu exposed by sliding the cursor to the right (from view (i) to view (ii) in FIG. 8B-1) may expose other icons/regions. In the example shown, the “talk” or “voice” icon/region is shown along with three other icons/regions, each of which, when selected, performs some function or causes some function to be performed. It should also be appreciated that the menu may be positioned anywhere on the display and that the “talk” or “voice” icon may be positioned anywhere within the menu.

When the user selects the “talk” or “voice” icon (in view (ii) in FIG. 8B-1), in addition to this causing the UI to initiate voice within the current conversation, a new menu (i.e., a new set of menu options) is displayed (as shown in exemplary view (iii) in FIG. 8B-1). The new menu, which may be referred to as a “voice” menu, may include an “exit voice” icon/region 866 that, when selected, allows the user to exit the voice within that conversation. When the “exit voice” icon/region menu option 866 is selected, the UI causes the device to exit the voice within the current conversation and presents the user with a menu (exemplary view (iv), which is the same as view (ii), in FIG. 8B-1) that allows the user to select voice within the conversation. The user may thus toggle between using the voice channel of the current conversation by using the “voice” and “exit voice” menu options.

Other menu options may also be included, as shown in exemplary view (iii) in FIG. 8B-1. The other menu options preferably include an icon/region (denoted “M” in the drawing) to enable the user to mute (or un-mute) the current conversation. Thus, e.g., the icon/region depicted as a star and with an “M” inside corresponds to a UI region that, when selected, toggles the mute functionality of the underlying device.

The “voice” menu may include menu options (e.g., icons or regions) that are not initially exposed. In some embodiments, these may be displayed or exposed by moving other menu options (e.g., icons or regions) to the left or right. Thus, for example, as shown in FIG. 8B-2, the voice menu in view (v) may be moved to the right to expose additional menu options (shown in view (vi), and moved back to the left to show the voice menu (view (vii), which is the same as view (v)). In addition, the user may, from any view, move the cursor 802 back from right to left to expose the text input menu (views (i)). Note that exposing the text input menu while in voice mode preferably does not exit voice mode.

FIG. 8B-3 shows some example icons used in some of the following examples for the voice and mute icons/regions. As should be appreciated, these icons are only examples of icons and they are not intended to limit the scope of the system in any way.

FIG. 8C shows another UI screen 804 on display screen 202′ of device 104′. UI screen 804 provides a list of conversations (by name) with which the user of the device 104′ is associated. That is, the user is involved (as a conversation participant) in the listed conversations. It should be appreciated that the list may only be a partial list of the user's conversations, and may be ordered, e.g., based on recency of activity. The user's self-conversation is preferably listed first on the list (so that in this example, the user is “Joe Godard”).

FIG. 8D shows the UI 806 on the display 202″ of a desktop computer 104″ (such as device 104-B described above with reference to FIG. 2B). The UI 806 may be implemented in a window on the display 202″, and may simultaneously include both the conversation list portion (shown in FIG. 8C) and the conversation portion (shown in FIG. 8B-1).

FIG. 8E shows the UI of FIG. 8A after the cursor has been slid to the right, exposing the underlying voice menu. If the user selects the “voice” icon/region 864 then the UI will cause the device to join the voice channel of the currently viewed conversation.

In FIG. 8E and in the remainder of this description, to simplify the drawings, the UI screens are shown without the underlying devices on which they are implemented. Thus, it should be appreciated that the UI 806 in FIG. 8E would be implemented by and presented on a device (e.g., the device 104′ in FIG. 8A). In some cases only the mobile UI (or only the desktop UI) is shown, since they both generally provide the same information. Differences in the interfaces for the different devices will be described as needed. One area of difference in interface may be in menu display and interaction. On the mobile device the UI needs to conserve space and so menus may be hidden until needed. The UI on a desktop screen need not conserve as much space and may make use of dropdown menus and control key sequences to initiate menus and menu options.

Avatars

Recall from the discussion above, with reference again to FIG. 5A, that each user has associated user information 502, preferably include at least one picture 512. A user may use their camera on their device to take a picture to be associated with the user information 502 or they may upload a previously acquired image. The UI preferably provides the user with a way to select a picture from their picture(s) 512 to be used as a so-called avatar by the UI. The user's picture 512 that is used for the user's avatar may be the same picture that is used for the background of the conversation (if such a picture is used), as was described in U.S. Provisional Patent Application No. 61/860,222, referred to above, the entire contents of which are fully incorporated herein by reference for all purposes.

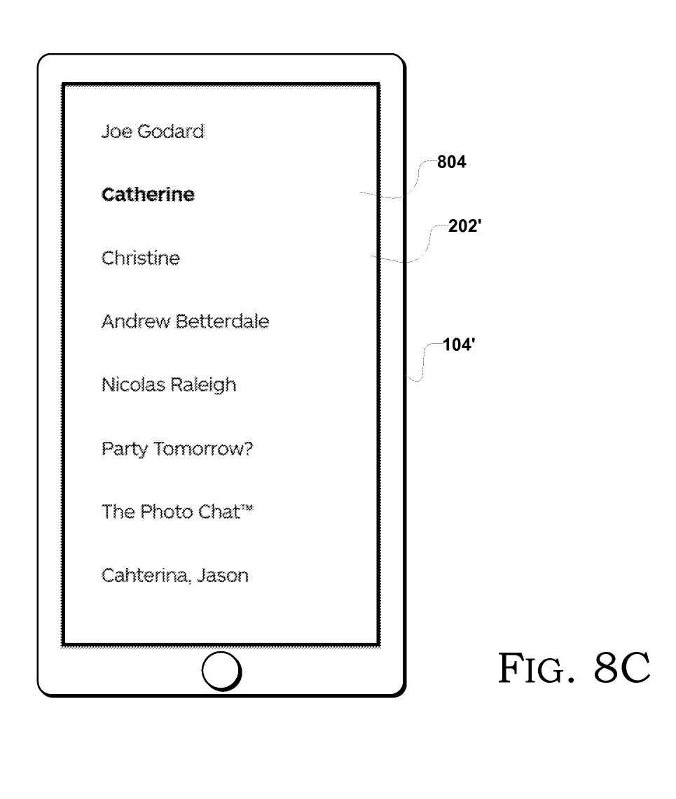

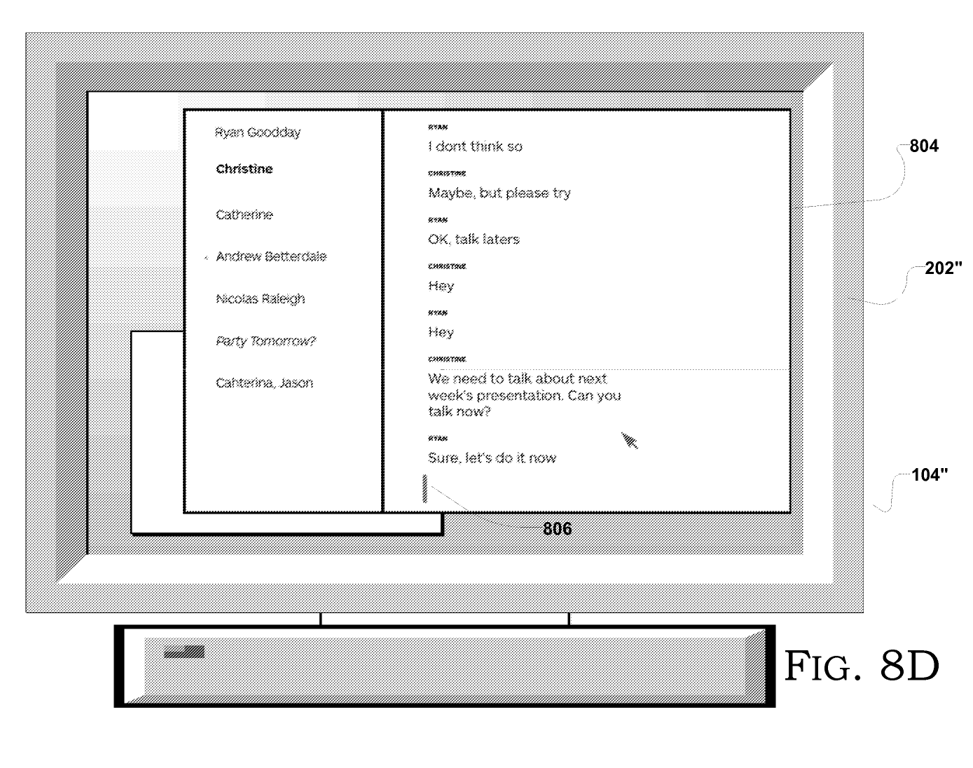

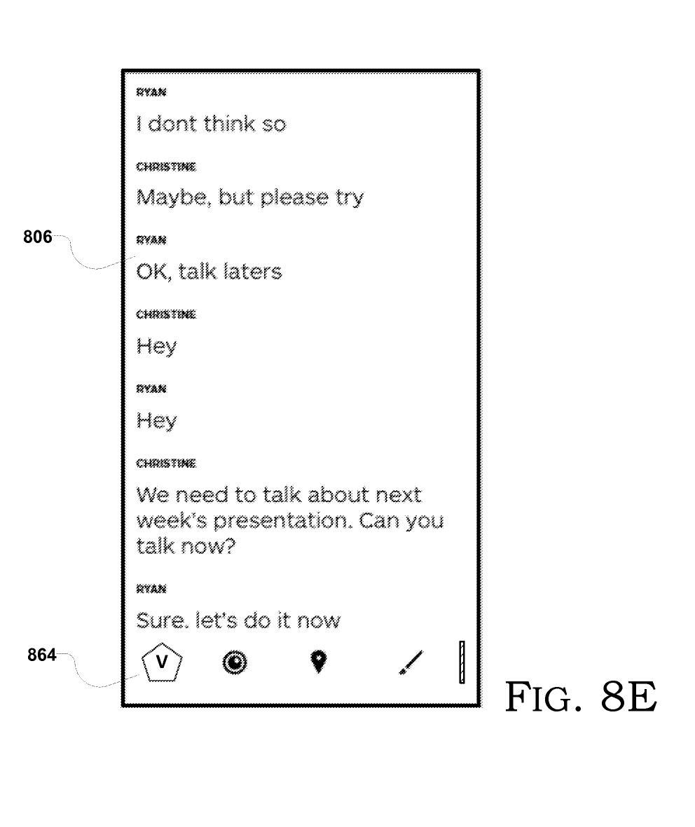

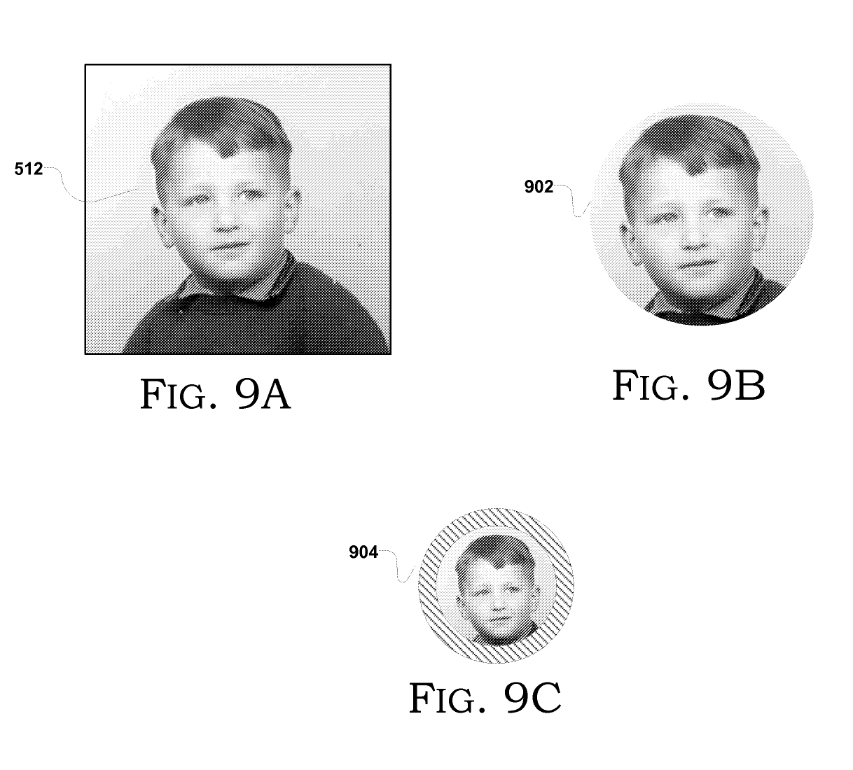

In presently preferred exemplary implementations the avatar is a round (circular) image derived or extracted from a user picture 512. FIG. 9A shows an example of a user's picture 512 taken from the user's information 502, and FIG. 9B shows the corresponding avatar picture 902.

A user's avatar (or an area around the avatar) may be animated and/or color coded by the UI to show activity or status of that user. Exemplary animation of an avatar may include changing its color and/or intensity, causing the avatar image to flash or appear to pulsate or throb, or the like. In addition, or instead, an area such as a ring around the avatar may be animated. As used herein, animation of an avatar includes animation or changing of the avatar image itself and/or animation and/or changing of an area around the avatar image. The area around the avatar image may be changed, e.g., to a different color and/or hue and/or intensity. An avatar is said to be animated if it differs from the avatar that was derived from the picture 512 in some way, and it should be appreciated that animation may include, but does not require, movement or repeated change. Thus, e.g., an avatar 902 with a colored ring around it is said to be animated. Similarly, an avatar 902 with a ring around it that rotates or appears to rotate or changes size or appears to change size is said to be animated. In some cases the hue or intensity of the image itself may be modified as part of an animation of an avatar. For example, a black and white image (e.g., as shown in FIG. 9B) may be changed to a different color, depending on the user's state. The color change may be constant or vary over time, and may be used alone or combined with other animations of the avatar.

In general, the term “animation” refers to any change in the avatar. Those of ordinary skill in the art will realize and appreciate, upon reading this description, that the system is not limited by the manner in which an avatar is selected or animated.

An avatar may be animated in different ways, e.g., to show that a user is: (i) talking; (ii) knocking; (iii) connecting; (iv) listening; or (v) muted. It should be appreciated that these are just some states in which a user may be, and a particular system is not required show all these user states, and a particular system may show different and/or other states.

FIG. 9C shows an animated avatar 904 derived from avatar 902 (FIG. 9B) by adding a color ring around the image 902. As noted, the color of the ring and its intensity may be used to indicate different user states. In addition, the rings may themselves be animated so as to appear to pulsate and/or rotate around the image 902 to indicate different states.

In some cases multiple rings may be used around the image 902 to indicate state. For example, FIG. 9D shows another animated avatar 906 similarly derived, but with a different color ring. FIG. 9E shows the animated avatar of FIG. 9D with a second ring 908 around the first ring. And FIG. 9F shows the animated avatar of FIG. 9E with a third ring 910 around the second ring 908. The UI may display the three avatars in sequence (as one animated avatar), with the rings appearing to form or grow out of the circumference of the image 902. E.g., first ring 906 forms, growing out of the circumference of the image 902 in a first color, and then the second ring 908 forms of a second color, growing out of the outermost circumference of the first ring 906. If three rings are used, then the third ring 910 forms after the second ring has reached its largest diameter, the third ring 910 having a third color and growing out of the outermost circumference of the second ring 908. The first, second, and third colors may be variations or shades of the same underlying color (e.g., they may all be blues), or they may be different colors. In some cases the different rings may rotate (in the same or different directions). In some cases the animation may include the three rings moving back in, in a reverse of their expansion, and then out again, repeatedly.

Although three rings were shown in the example above, those of ordinary skill in the art will realize and appreciate, upon reading this description, that a particular system may use fewer or more rings. It should also be appreciated that although the drawings show discrete boundaries between adjacent rings, in particular implementations the rings may be made to appear to blend into each other.

When movement is shown in an avatar's animation, the speed of that movement may be used to indicate an aspect of the user's state.

Voice Headers

A conversation includes one or more users (also referred to as participants), and it is useful to provide an indication to each participant of which users are the participants of a conversation. It should be appreciated that the term “participant” is used throughout this description to refer to the membership of a conversation, and does not imply any active participation in the conversation. For example, a particular participant may read messages from others and listen to voice from others without sending any messages or voice himself one user.

When at least one user of a conversation is using a voice channel in that conversation, then that conversation's voice channel is said to be active. It should be appreciated and understood that an active voice channel does not require any actual activity on the channel. When a conversation has an active voice channel (i.e., when at least one user is using or has opened the voice channel), the conversation preferably includes header information indicative of the active voice channel. As used herein, this header may be referred to as the conversation's voice header.

A conversation's participants may change, as may their degree of activity in the conversation. The voice header of a conversation may be updated to reflect changes in the conversation's participants. Thus, for example, a conversation voice header preferably reflects the current list of participants. In some embodiments, the voice header may change dynamically to reflect actual activity level (e.g., recency of activity) of the conversation's various participants.

In presently preferred embodiments user information 502 (FIG. 5A) of some or all of the participants of a conversation may be used to provide aspects of that conversation's header, including, aspects of the conversation's voice header.

With reference again to FIG. 5A, recall that each user within the system has public information 504 that preferably includes a name 508 and one or more pictures 512. As described above, a user's picture(s) 512 may be set and/or modified by the user in a known manner, e.g., by using a camera on a user's device or by uploading an existing picture.

In presently preferred embodiments a user's public information 504, including one or more of the user's name 508 and a picture 512 or avatar derived or based on a picture 512 (as described above), may be used to identify that user within a voice header.

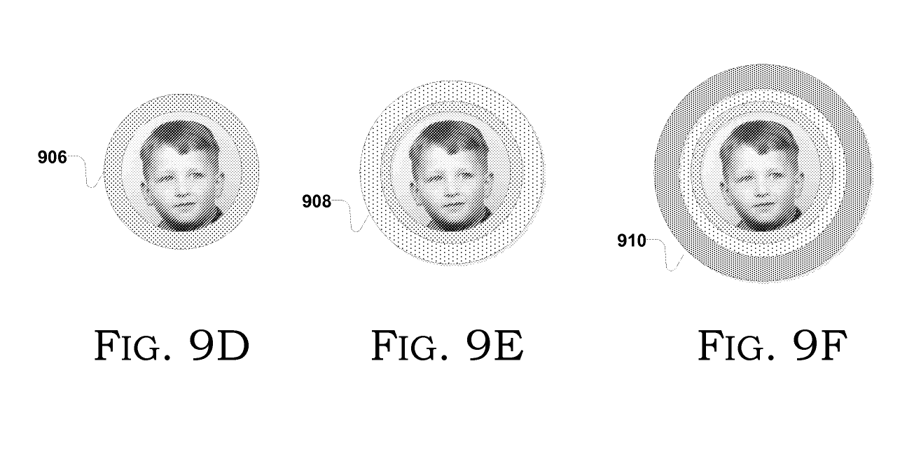

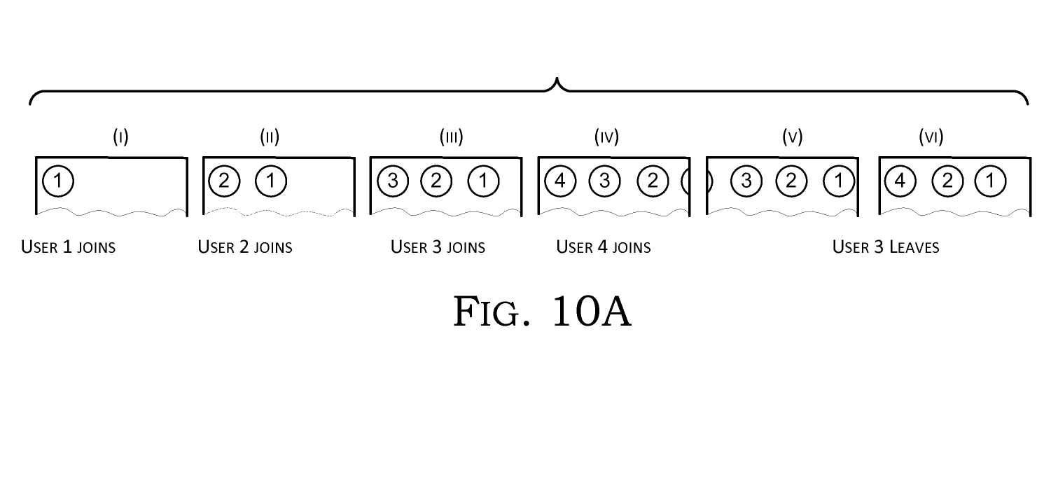

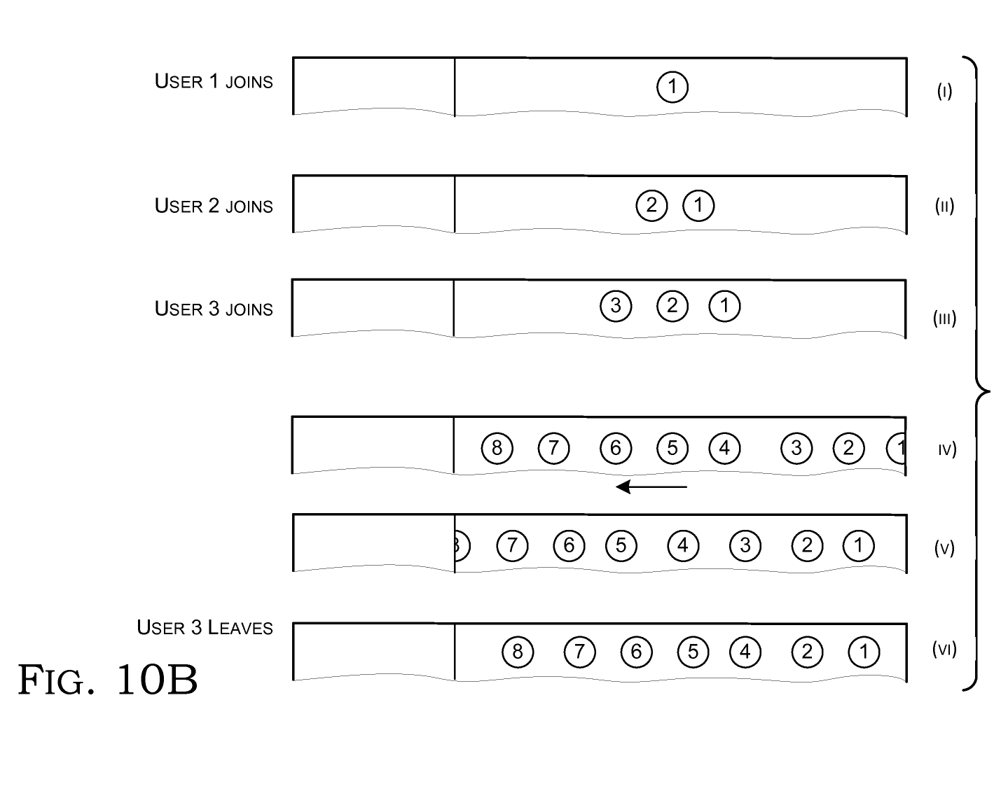

FIGS. 10A-10D depict aspects of exemplary user interfaces showing voice header information in conversations in accordance with embodiments hereof.

FIGS. 10A-10B show examples of voice headers within a voice conversation. FIG. 10A shows the exemplary voice headers on the display of a device such as a smartphone or tablet or the like (e.g., as shown in FIGS. 2C and 2D), whereas FIG. 10B shows the voice headers in the same conversation scenario on a screen of device such as a laptop or desktop computer or the like (e.g., as shown in FIGS. 2B).

In the examples in FIGS. 10A-10C, a circle with a number or letter inside it is used to represent the information corresponding to that user. In an actual implementation, the information preferably includes an avatar for that user (e.g., as described above). In some implementations the information may include the user's name (e.g., taken or derived from name 508), a picture (e.g., taken or derived from picture(s) 512), and/or other information. The voice header is preferably presented at the top of the UI screen, however it may be presented anywhere on the screen.

With reference again to FIGS. 10A-10B, in the first screen portion (i), user #1 joins the conversation and the voice header is updated (created) to include an identification of user #1 (depicted by a circle with the number “1” in it). Screen portion (ii) reflects the voice header after user #2 joins the voice conversation, and screen portion (iii) reflects the voice header after user #3 has joined the voice conversation, and so on.

The voice header is used to reflect which members have joined the voice channel of the conversation, so that a user may already be a participant in the conversation when they join the voice channel of the conversation. Thus, e.g., when user #4 joins the speech conversation (i.e., joins the speech channel of the conversation) in screen portion (iv) of FIG. 10A, that user may have already been a participant in the conversation.

The order of the list of users in a voice header is preferably defined by the time at which the participants join the voice channel. As users join, their identifying information (e.g., an avatar) is preferably added to the beginning (i.e., to the left side) of the list of users in the voice header. The identifying information (e.g., avatar(s)) of previous users is then pushed or moved to the right. If the number of users exceeds the available width of the display area (as seen, e.g., in FIG. 10A, screen portions (iv) and (v)), then the voice header may be scrolled to see the remainder of the list. A voice header preferably includes some indication (e.g., on the far left or far right) to indicate that it includes information that is not being displayed. When a participant leaves the voice channel, his identifying information (e.g., avatar) is removed from the list and the participants to his right on the list are moved left. Thus, e.g., when user #3 leaves the conversation, his avatar is removed (in FIG. 10A, no (vi)).

In some embodiments a user's voice activity (e.g., the user actively talking) does not affect the sorting of the user list in the voice header or the scroll position.

The voice headers shown in FIGS. 10A-10B are preferably used for active conversations. However, a user may switch from a voice conversation to another conversation (e.g., a text only conversation). In such cases it is useful to provide an indication to the user that there is an ongoing active voice conversation. For this purpose the UI may provide another voice header (e.g., a minimized voice header) such as shown in FIGS. 10C-10D. The minimized voice header may include the name of the conversation and, optionally, an indication of the active state of the minimized voice conversation (e.g., wave 1002, preferably moving wave). The wave may be in the form of a continuous wave (as shown in FIG. 10D) or in the some other form that indicates activity. The wave in a minimized voice header may be synchronized to the actual activity in the corresponding voice conversation.

In presently preferred implementations the identifying information of a user is derived directly or otherwise from the user's picture(s) 412 and is preferably that user's “avatar.”

As noted above, a user's identifying information (e.g., their avatar) may be used to show state information about that user. For example, a user's identifying information may show one or more of whether that user is: listening, talking, connecting, knocking, or mute. Some of the state information about a user may not be shown to other participants (e.g., when the user is on mute).

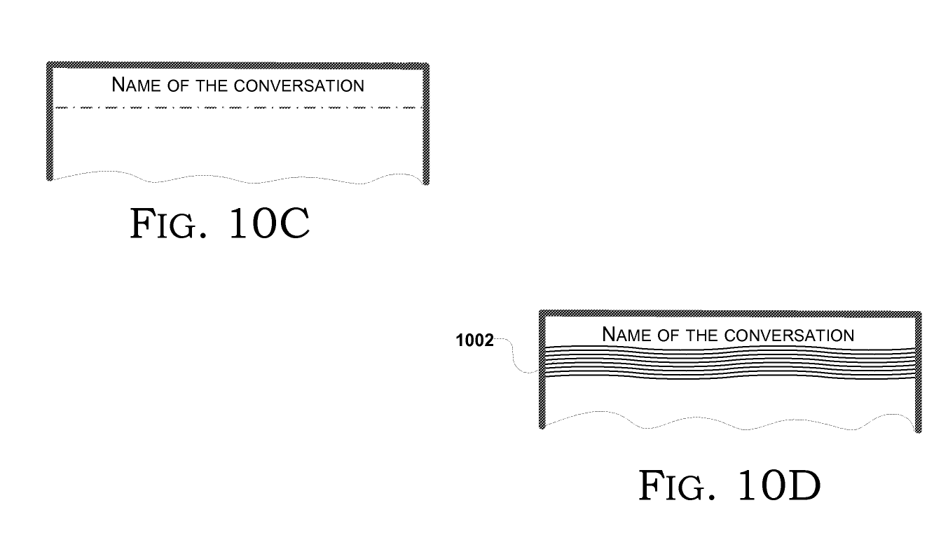

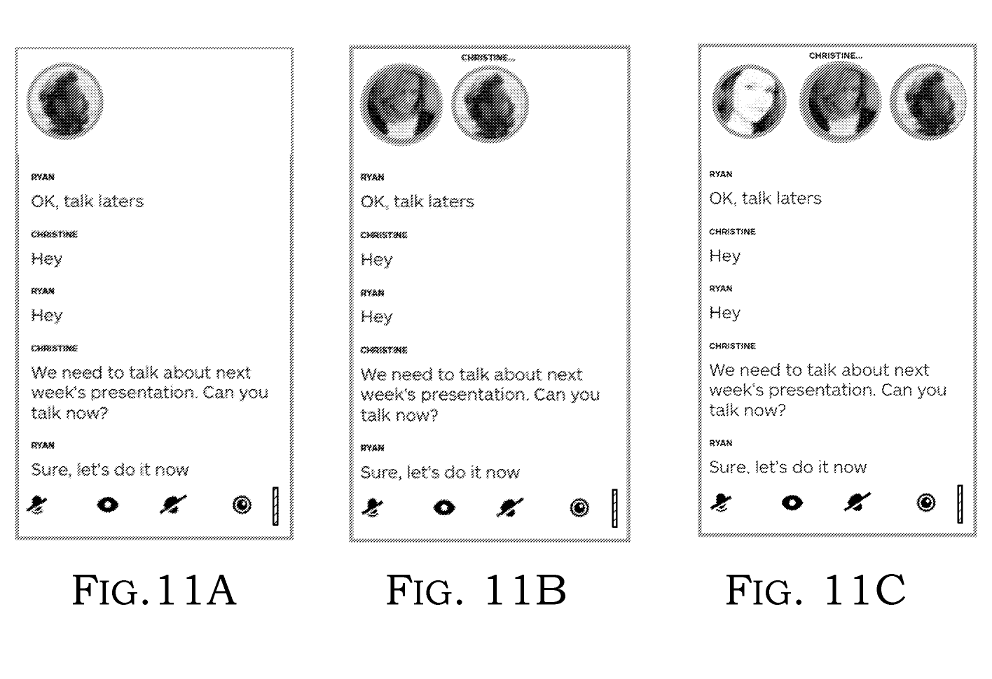

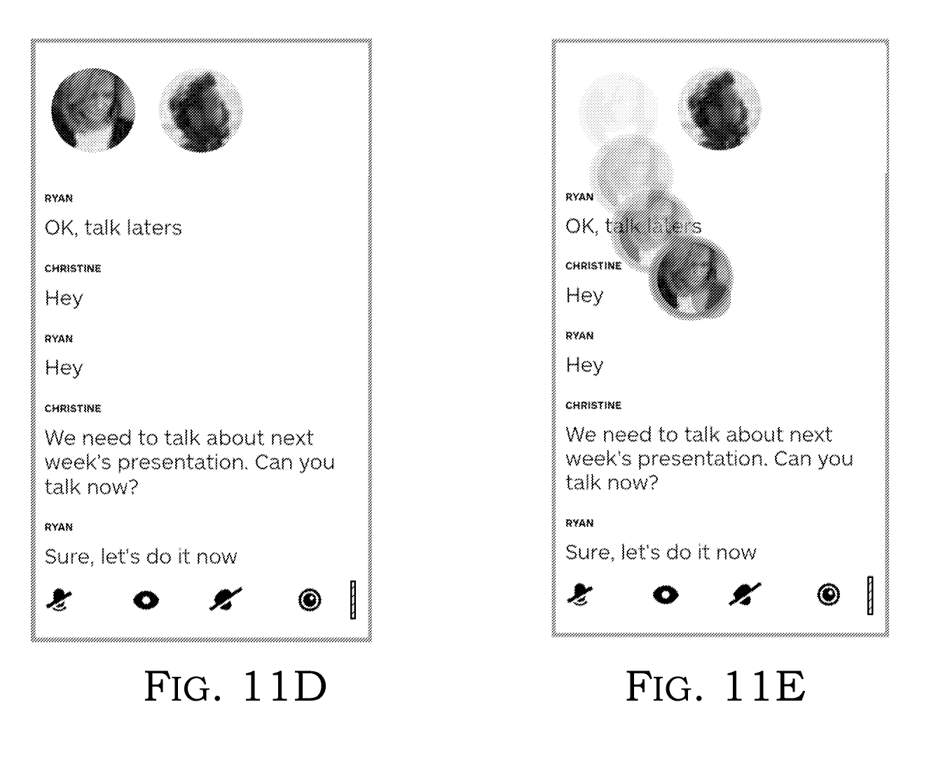

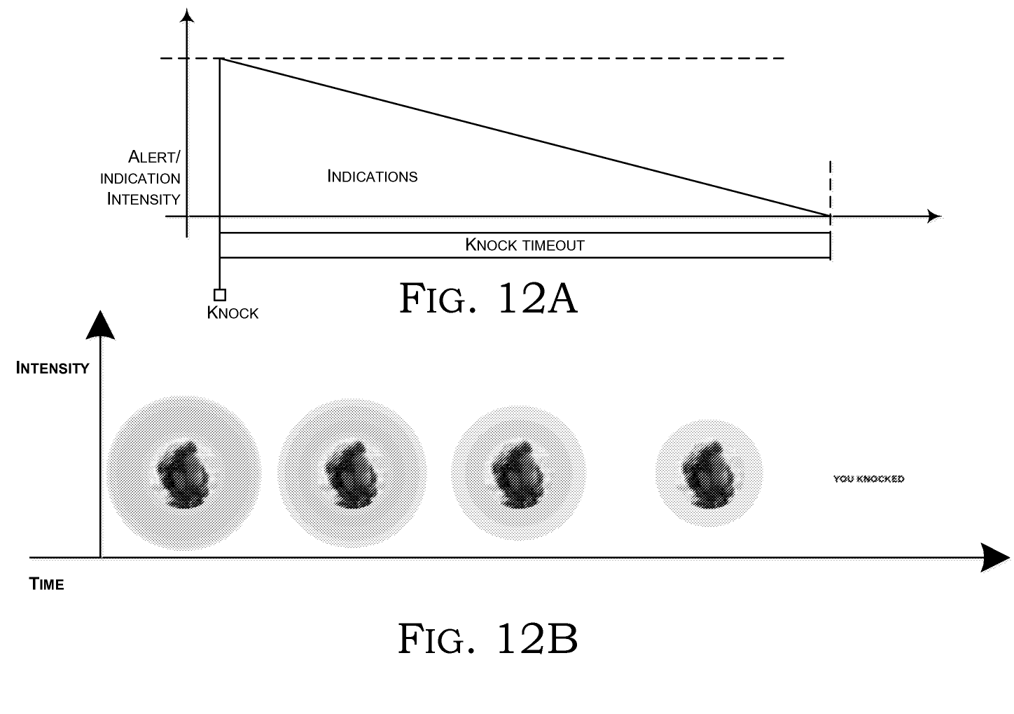

FIGS. 11A-11C show exemplary conversation screens with voice headers comprising one, two, and then three user's avatars, respectively. FIG. 11D shows the same conversation participants as shown in FIG. 11B, however in FIG. 11D their avatars are not animated.

FIG. 11E shows an example of the UI using the avatar to remove a user from a conversation. In this example the avatar is dragged from the conversation header to remove the user from the conversation. Note that the avatar is animated.

The UI and Knocking

The UI (i.e., the UI application(s) 128) preferably deals with three aspects of knocking. First, the UI preferably supports a user knocking one or more other users in order to try to get their attention. In this regard, the UI may provide one or more mechanisms to support selection of which user(s) to knock and to support knocking those users. Second, the UI should support the providing or rendering knock indication(s) on knock recipient(s), and third, the UI should preferably provide knock recipients with options for responding to knocks (including ignoring knocks).

As noted, a knock preferably has a timeout, that is a period of time when it is considered to be valid and relevant. The time out period for a knock is preferably relatively short, on the order of one to two minutes, although other periods may be used. The timeout period (and remaining time) are preferably indicated to the user (at least to the knocker) in some manner.

Knocking

As noted, UI on client devices preferably supports a user knocking one or more other users in order to try to get their attention. The consequences of such a knock depend, at least in part, on the status (e.g., the presence and activity status of the intended recipient(s)), as discussed below. In some embodiments a user may knock within a conversation by two or three taps on a name or names in the conversation list. In order to prevent inadvertent knocks, preferably three or more taps are needed to initiate (or re-initiate) a knock. In some implementations, the UI may require that the user confirm a knock. In a list or group view the user may knock on one or more other users by tapping (two, three, or more taps) on the name of a group or conversation.

Knock Indications

The following table summarizes aspects of exemplary knock indications in embodiments hereof Those of ordinary skill in the art will realize and appreciate, upon reading this description, that these indications are merely exemplary, and that different and/or other indications and conditions may be used.

| | Case B: Client application running in foreground | | |
|---|---|---|---|
| Case A: | Case B.1 | | |
| Client application | Conversation of | | |
| not running or | the incoming | | |
| running in | knock in | Case B.2 | Case B.3 |
| background | foreground | List View | Any other view |
| Push notification | Embedded system | List indication. | Within-app |
| | message | Tap notification | notification. |
| | | opens | Tap notification |
| | | conversation | opens |
| | | where embedded | conversation |
| | | system message is | where embedded |
| | | displayed | system message |
| | | | is displayed |

It should be appreciated that in all cases the visual indicators and notifications preferably include a distinctive sound.

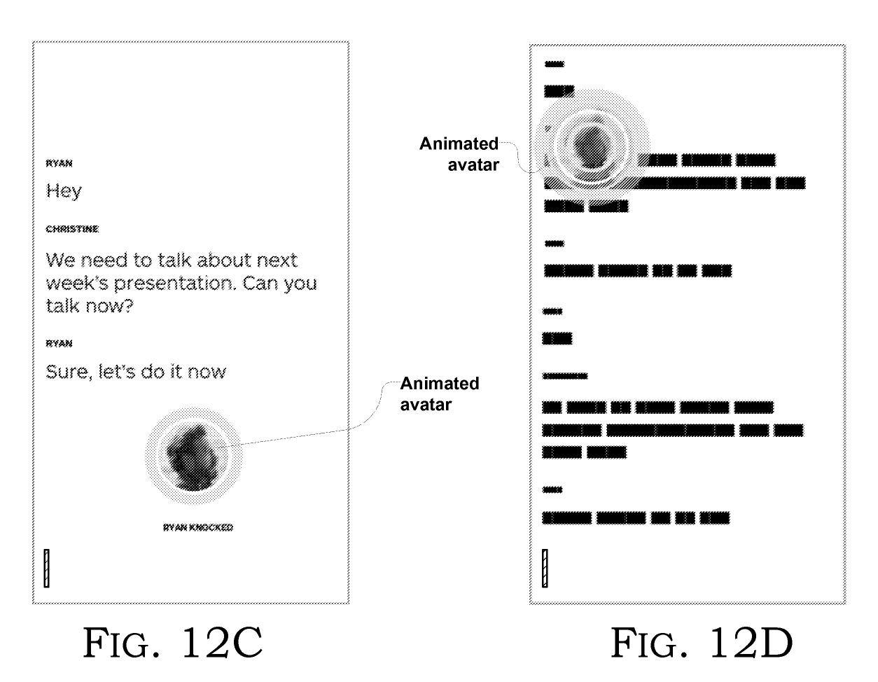

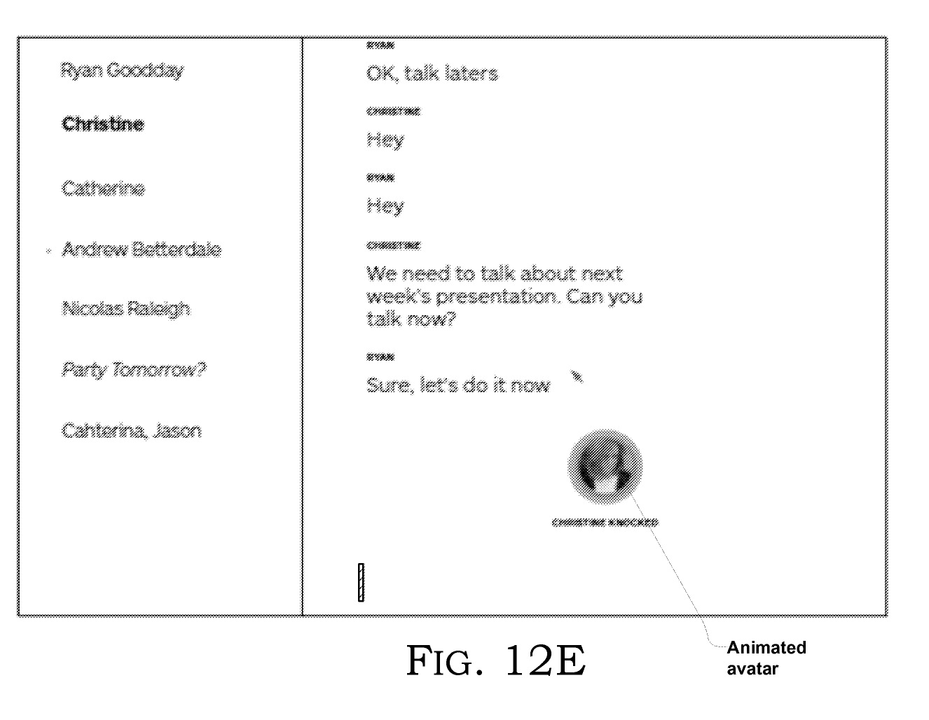

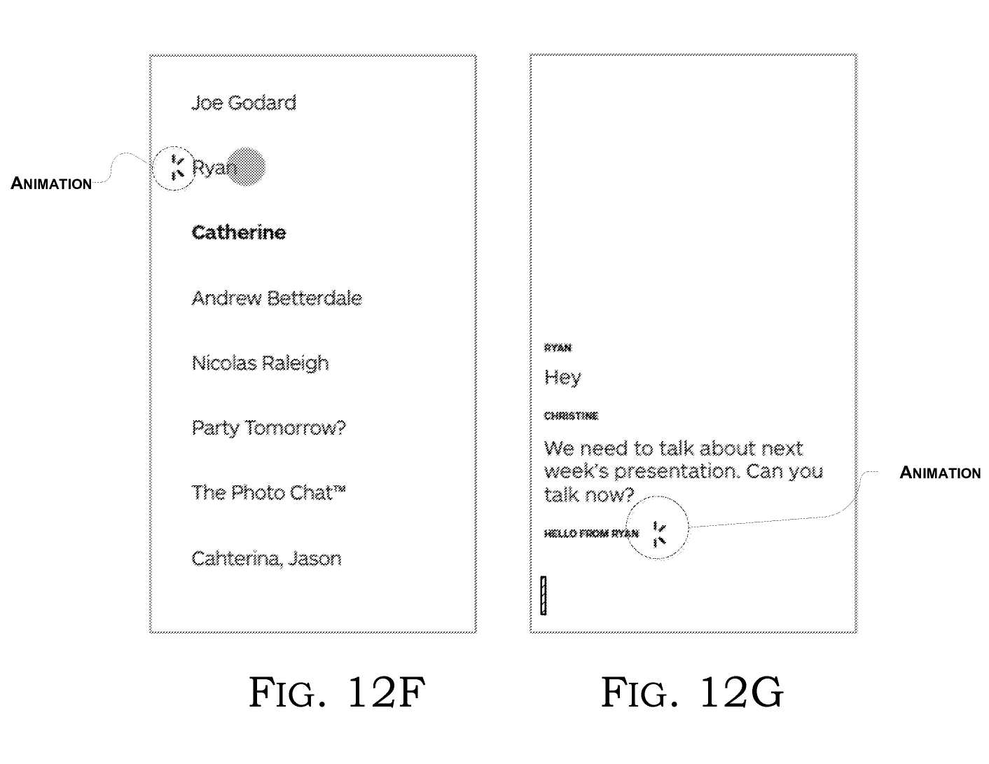

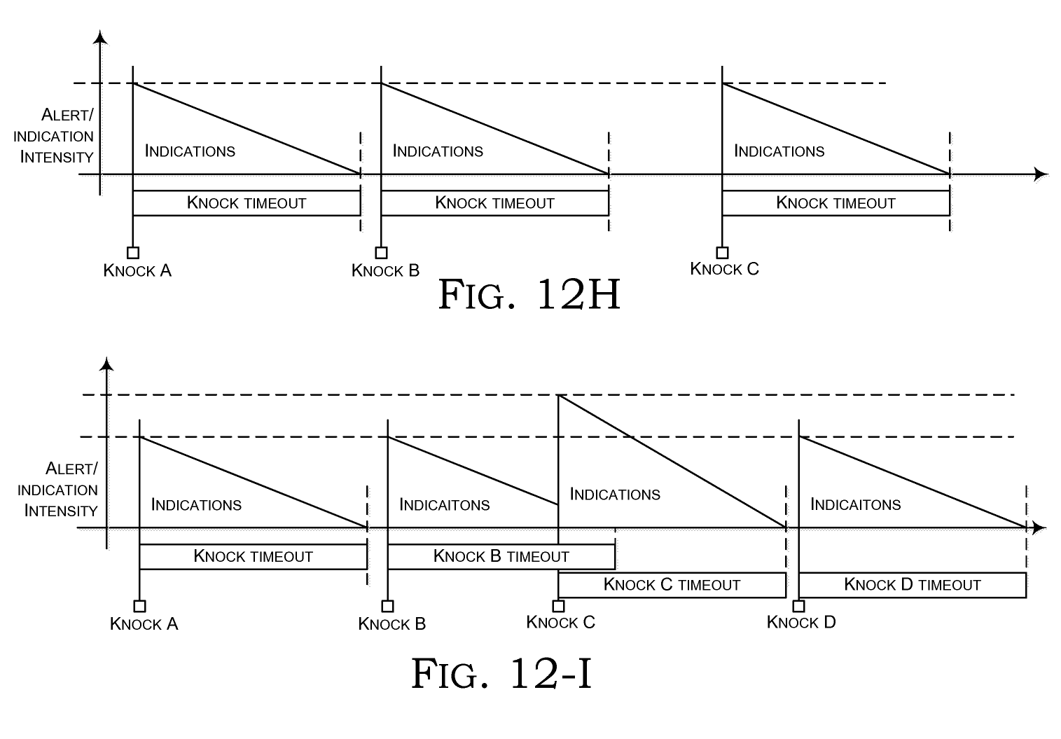

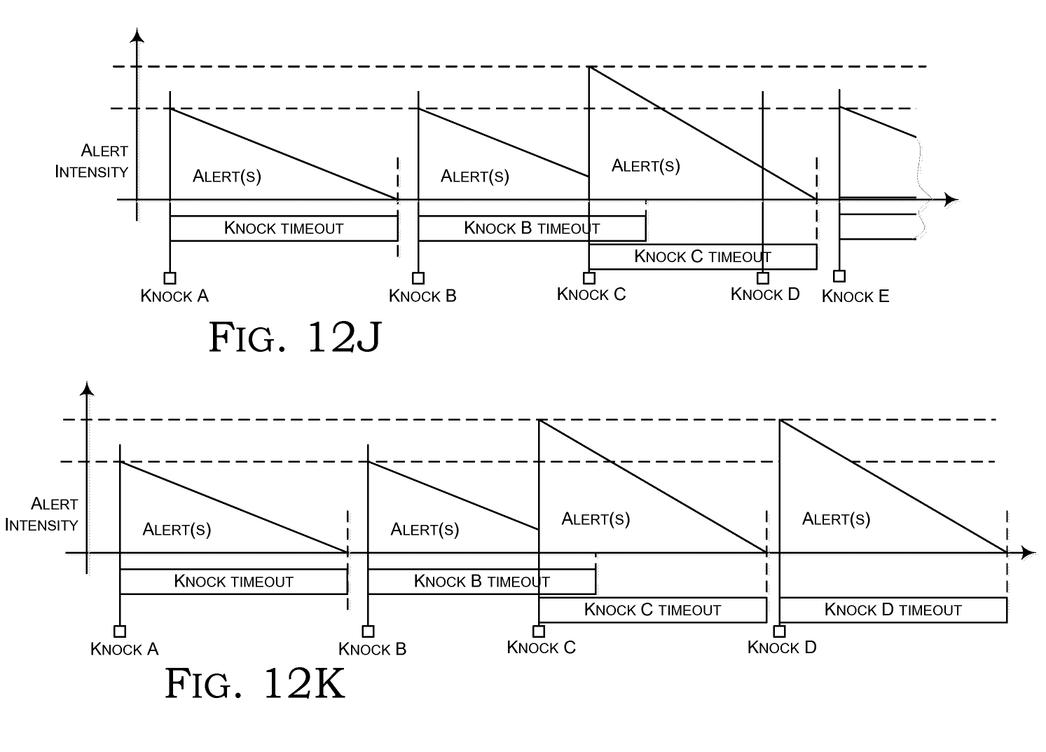

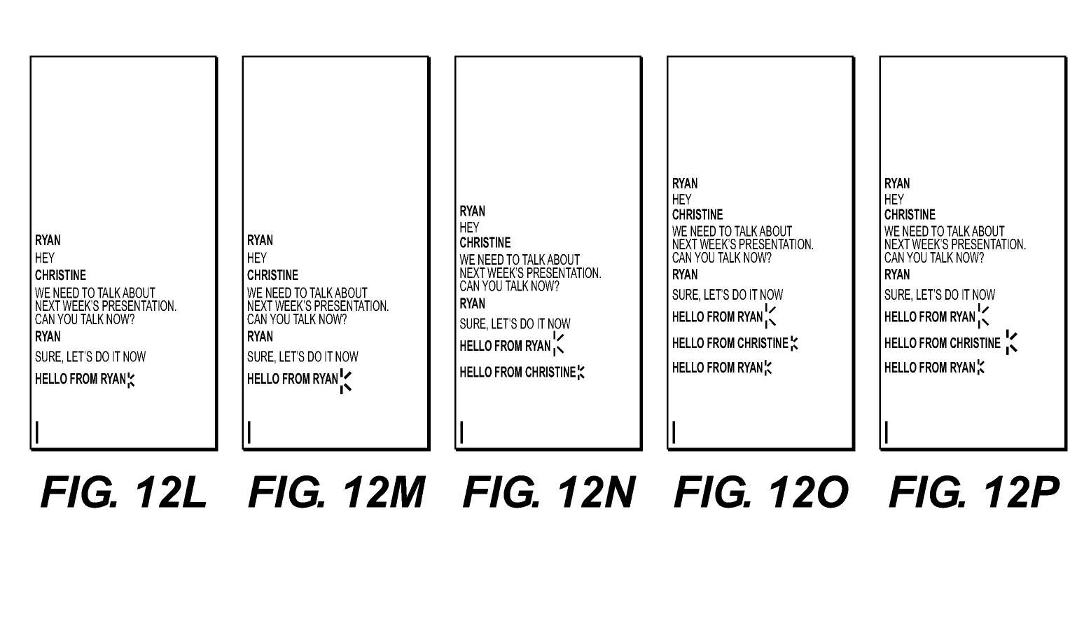

In general, as shown in FIG. 12A, the indication(s) associated with a knock decrease in intensity (e.g., loudness, speed, size, etc.) over time until the timeout period ends, at which point they end. Having ended, a knock generally leaves some indication that it occurred, e.g., as a text message (such as a system message) in the appropriate conversation.

FIG. 12B shows an exemplary animated knock indication that decreases in intensity over time. The example indication in FIG. 12B is an animated avatar of the knocker (the user who initiated the knock). Initially the indication includes 3 or 4 or 5 pulsating rings, moving outward from the outer diameter of the user's photograph (e.g., as described above for animation of an avatar). After some time the outermost diameter is reduced until eventually all that remains is the text “You knocked” on the knocker's screen. The same animation (if appropriate) on a recipient's screen would say “X knocked,” where “X” is the name of the knocker in the system.

In an example implementation the timeout period is one minute, and the five stages shown in FIG. 12B occur at 0 seconds to 15 seconds, from 15 seconds to 30 seconds, from 30 seconds to 45 seconds, and from 45 seconds to 60 seconds. After 60 seconds the indicator states that the user knocked, but no animation or avatar are provided. Those of ordinary skill in the art will realize and appreciate, upon reading this description, that these times are merely exemplary and are not intended to limit the scope of the system in any way.

FIGS. 12C-12D show example indications of a knock. FIG. 12C shows an indication on an active conversation window (case B.1 from the table above), and FIG. 12D shows an indication on another window (case B.3 in the table above). FIG. 12E shows a knock indication on a UI of desktop computer window. FIGS. 12F-12G show further example knock indications. FIG. 12F shows animation in the list (next to the name “Ryan”), and FIG. 12G shows animation in the embedded message (next to the text “Hello from Ryan”). The animation is indicated in the drawings by the circle with a dashed-line circumference. The circle is used here to show the region of animation in the drawings, and is not part of animation.

Hot Knocks

Hot knocks allow a knocker to express urgency and thereby possibly increase the chances of the recipient noticing the knock. Hot knocks may group consecutive knocks into one more intense (e.g., bigger, louder, longer, brighter, etc.) and in general more noticeable notification. A hot knock indicator may increase its intensity in any way, e.g., in terms of one or more of size, speed and/or audio feedback. Like other knocks, hot knocks may indicated in the conversation, the list and preferably as a push notifications.

As shown in FIG. 12H, when a knock occurs after the timeout period of a previous knock then the second knock has normal alert/indication intensity associated therewith. However, as shown in FIG. 12-I, when a second knock occurs within the timeout period of a first knock (knocks C and B in the drawing), the knocks may form a so-called “hot knock” with alert(s)/indication(s) of greater intensity than that of a normal knock.

In a presently preferred implementation, in order for two consecutive knocks to be grouped into a hot knock, the following requirements should be met:

1. After the first knock, no other action from any participant (including the person who knocked) has happened in the conversation. Valid actions are new messages or a participant joining the voice channel of the conversation.

2. The second knock happens within the expiration time of the previous knock.

Knocks following a hot knock (and during its timeout period) are preferably ignored until the hot knock expires. After that, a new regular knock may be created. For example, as shown in FIG. 12J, knock A is a regular knock. Knock B starts out as a regular knock but becomes a hot knock when knock C takes place before knock B has timed out. Knock D occurs during a hot knock (C+D) and is therefore ignored. Knock E, occurring after the expiration of the hot knock (C+D) will be a regular knock. However, some implementations may support higher degrees of hot knocks by increasing the alert(s)/indication(s) intensity still further if multiple knocks occur during the duration of a knock.

In some implementations, a knock occurring within a short period after the expiration of a hot knock (e.g., within 5-10 seconds) may also be a hot knock. Thus, as shown for example in FIG. 12K, knock D, occurring after the termination of hot knock B+C will also be a hot knock if the time between the end of hot knock B+C and the beginning of knock D is sufficiently short. In these drawings the term “alert” is used synonymously with indication.

Knock in Groups

Knocks from different participants in a group are preferably treated as separate knocks and preferably do not implicate each other or hot knocks. Knocks preferably become hot knocks only if coming from the same sender. If a receiver responds to a knock (e.g., taps on a knock indicator), preferably only the sender and the receiver who responded will join voice automatically. The rest of participants have to actively join (e.g., respond to the knock) themselves. Knocks from different senders are preferably sorted by recency in the conversation. Hot knocks update their position.

Consider the following example scenario (with reference to FIGS. 12L to 12P) in a group conversation with three participants, A, B, and C. Participant A knocks and then A hot-knocks. Participant B knocks after the expiration of A's hot knock. Participant C knocks during B's knock, but it is a separate knock. Participant B then hot knocks.

In FIG. 12N, the knock from A has expired (preferably there is animation from B in the background image). In FIG. 12-O, the knock from A has expired. Animation from C replaces that from B. In FIG. 12P, the knock from B becomes a hot knock but it does not change position. Background animation still remains for C.

List Views

Knocks and hot knocks are preferably indicated in the list of a list view. (Lists may include dots adjacent user's names indicating other aspects of the system, and knock indicators are preferably in the same place as the dots.) A knock (regular or hot) affects the position of the conversation in the list as any other new message. Muted conversations do not indicate knocks. Archived conversations which get a knock preferably become un-archived, however, conversations which are both archived and muted remain archived.

Knocks (regular or hot) expire after timeout, as is indicated in the list (e.g., by intensity in the animation). After being expired, the animation stops and an indication equivalent to one regular message is used in the dot indication.

Knocks preferably override present dots during their valid time. After timeout, dots are updated with previous value plus missed knock (1 message) plus any value coming from other messages that may have arrived during knock time. As used herein, a missed knock is a knock that has not been followed by a message from any of the recipients on any channel (including joining the voice channel).

Voice-on Indications in Lists

Multiple conversations may have voice activity ongoing at the same time. However, a user may preferably be in only one voice conversation at a time. Conversations with voice activity are preferably indicated in the list, with voice activity indications preferably kept separate from new messages and knock indicators.

As noted, voice activity in a conversation may affect the conversation's position in the list by communicating the following events:
There is no one in the voice channel of the conversation, and a first participant joins.
The user joins an ongoing voice channel
The user leaves an ongoing voice channel
If the user is currently in a voice channel, the conversation is kept as the first item in the list.

These events may affect archived and muted conversations as any other regular message:
Archived con conversations get un-archived
Muted conversations are ignored
Muted and archived conversations ignore them and do not get un-archived

In some cases, the microphone of the conversation the user is in can be muted. If so, this is preferably indicated in the list.

Voice Scenarios

Embodiments of the system may support various scenarios relating to voice and voice conversations including some or all of the following:
1. While Texting, Participants Agree To Switch To Voice
2. Join Ongoing Voice Channel
3. Multitasking—Texting while on Voice
4. Multitasking—Send image while on Voice
5. Multitasking—Switch from conversation with voice to other and
back
6. Multitasking—Switch to other Voice channel
7. Multitasking—Join Voice while listening music
8. Multitasking—Play music while on voice
9. Switch from a one-one voice conversation to a multi-user voice
conversation
10. Continue Voice from one device to other
11. Mute microphone
12. Enable Loudspeakers
13. Have voice on while using other application

Exemplary Voice Conversation Scenarios and Processing and an Exemplary UI

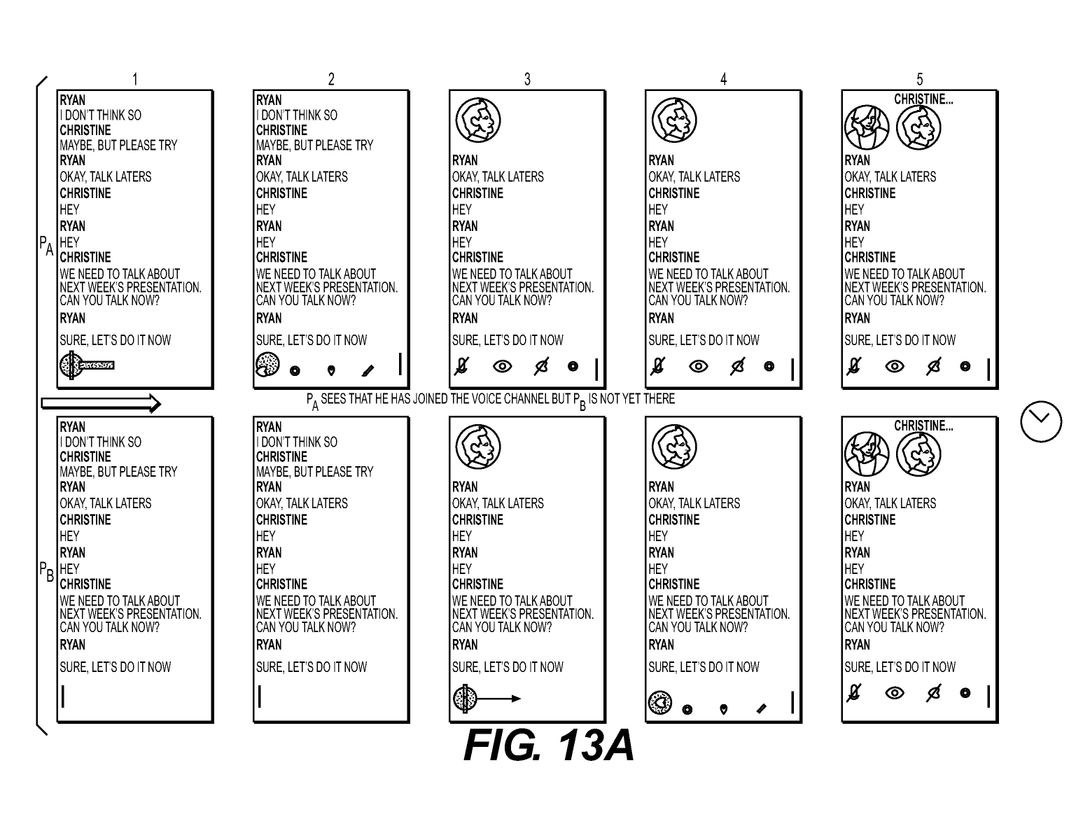

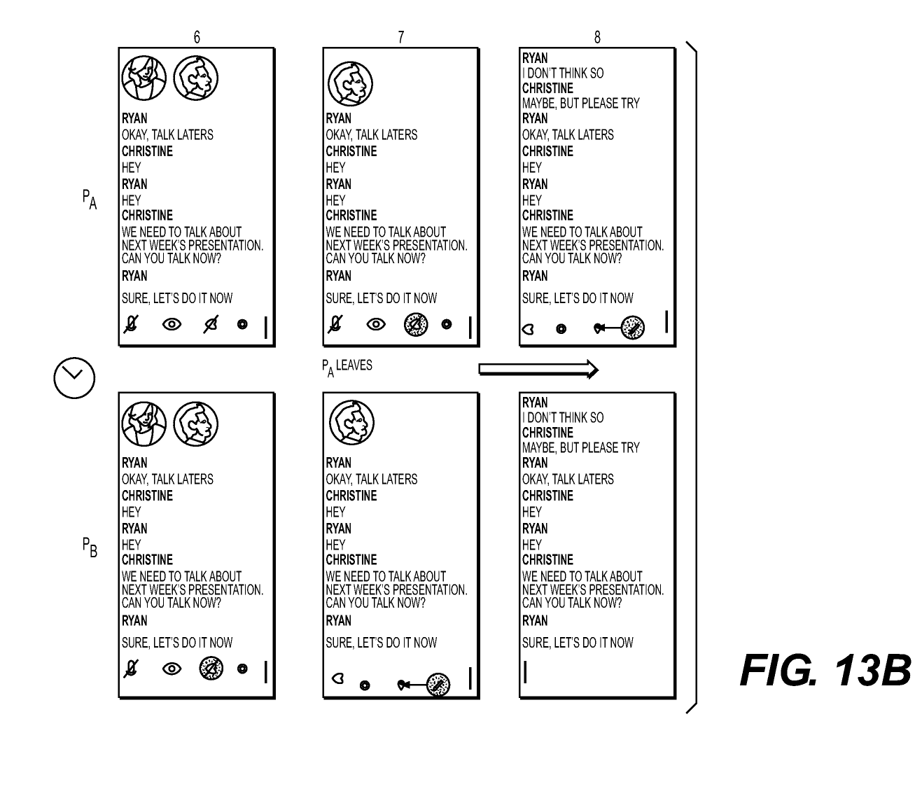

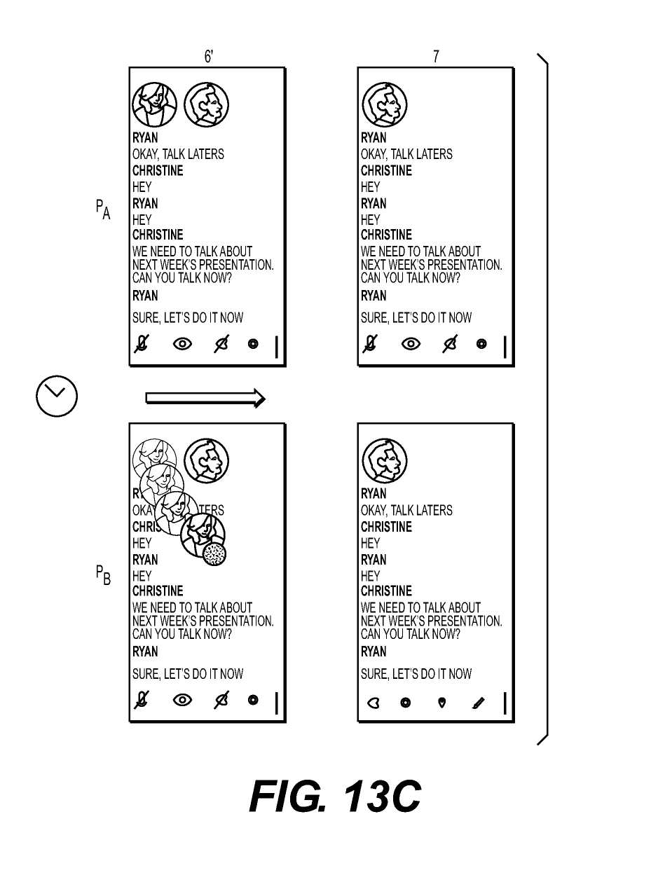

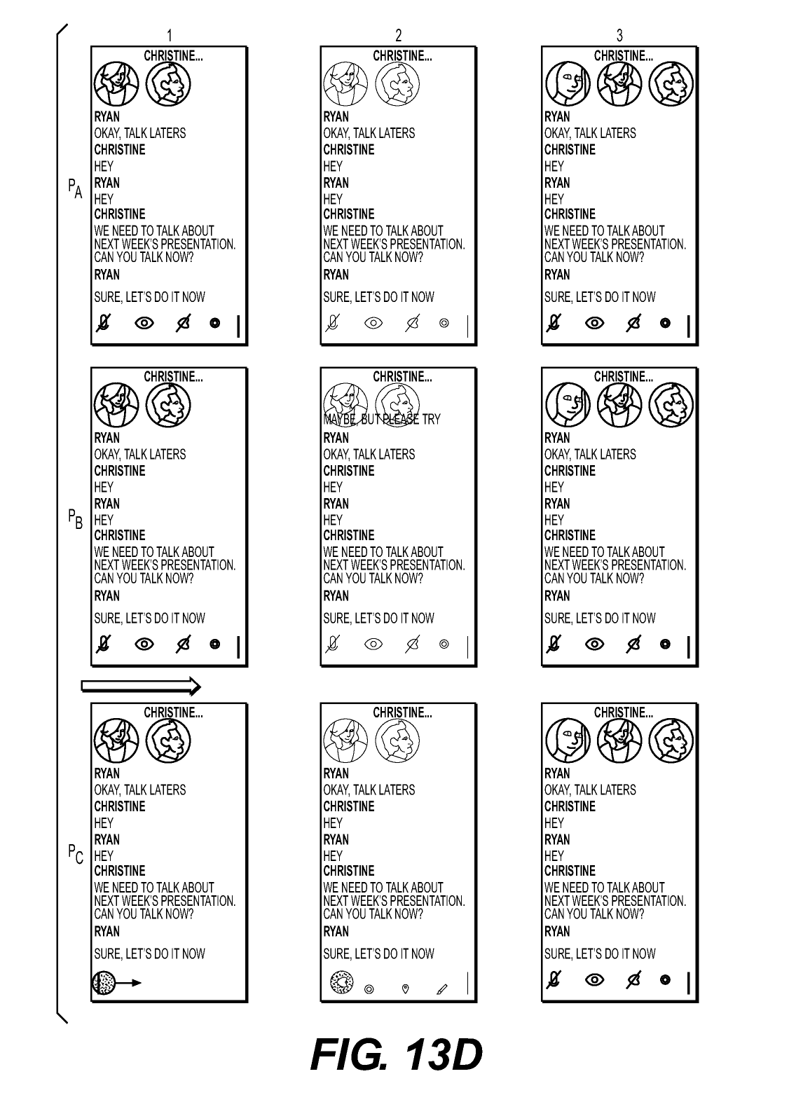

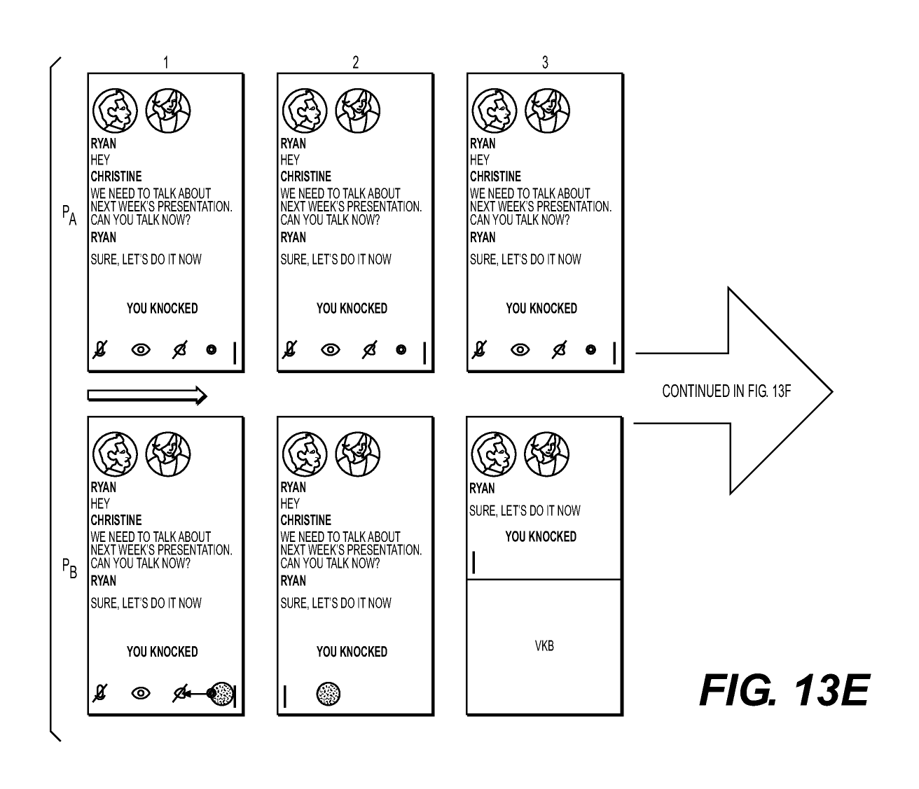

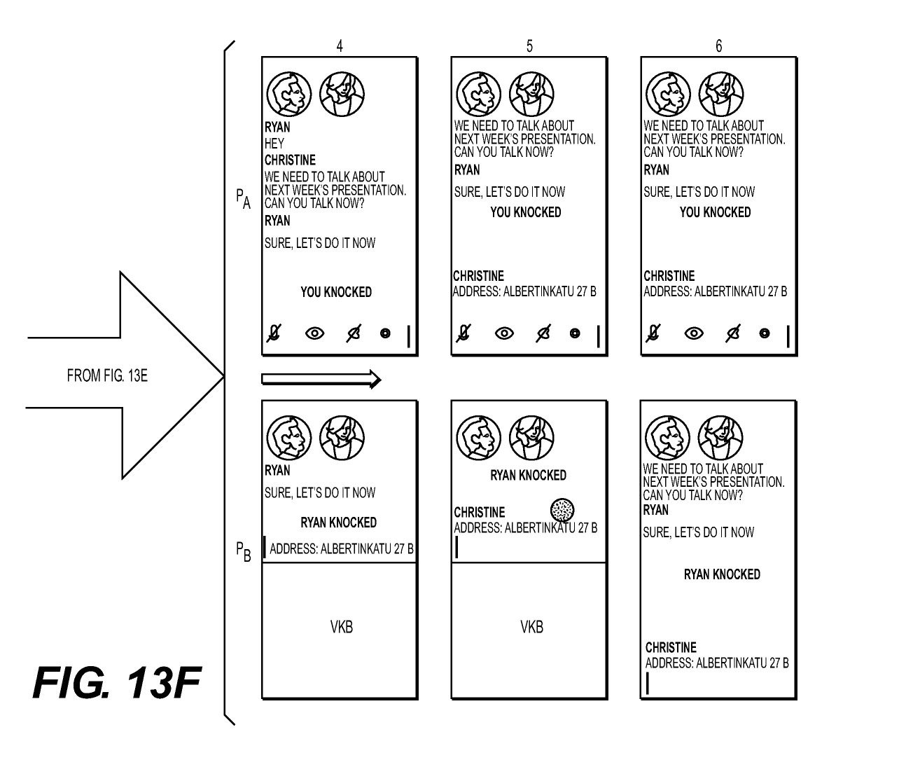

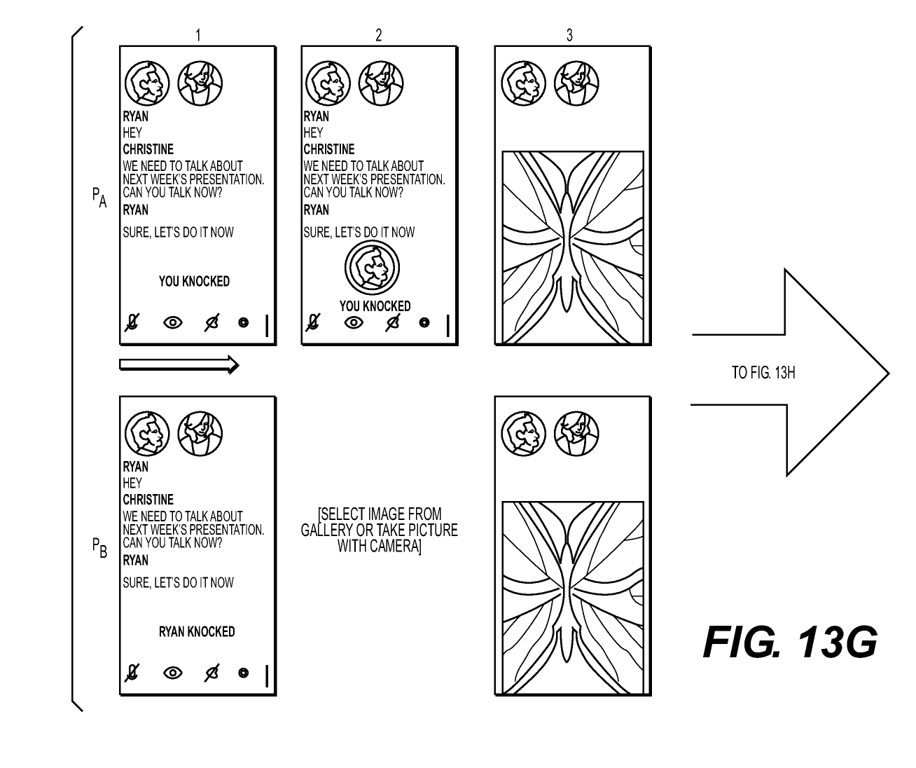

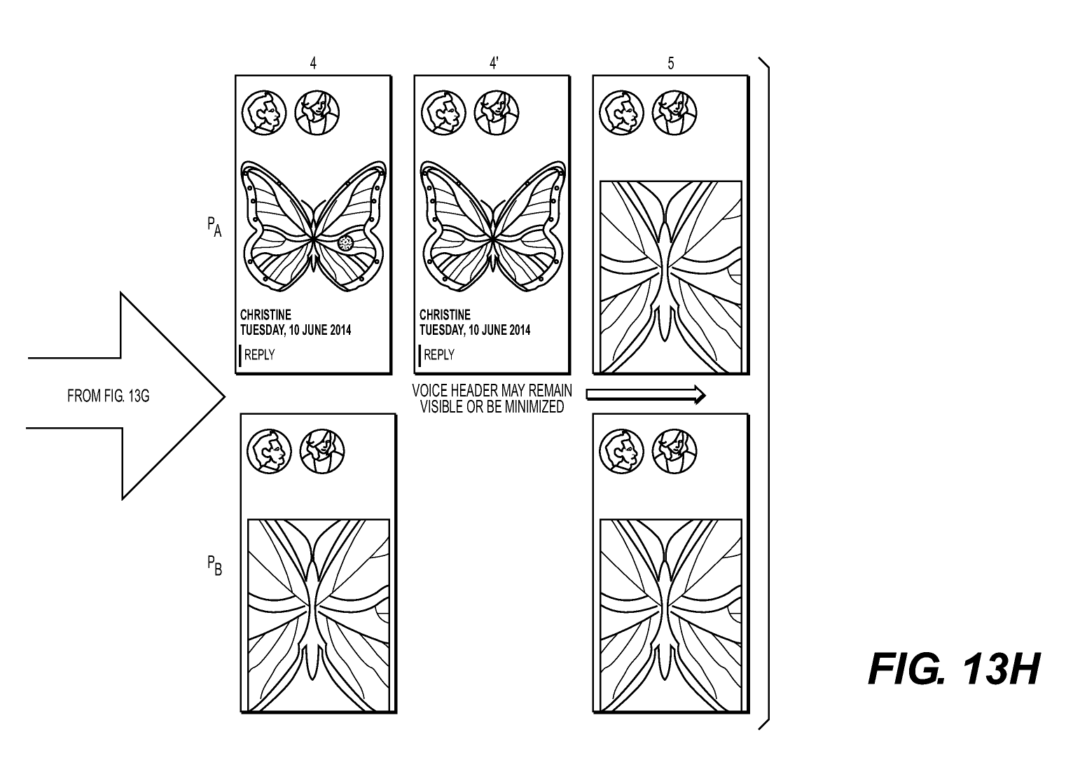

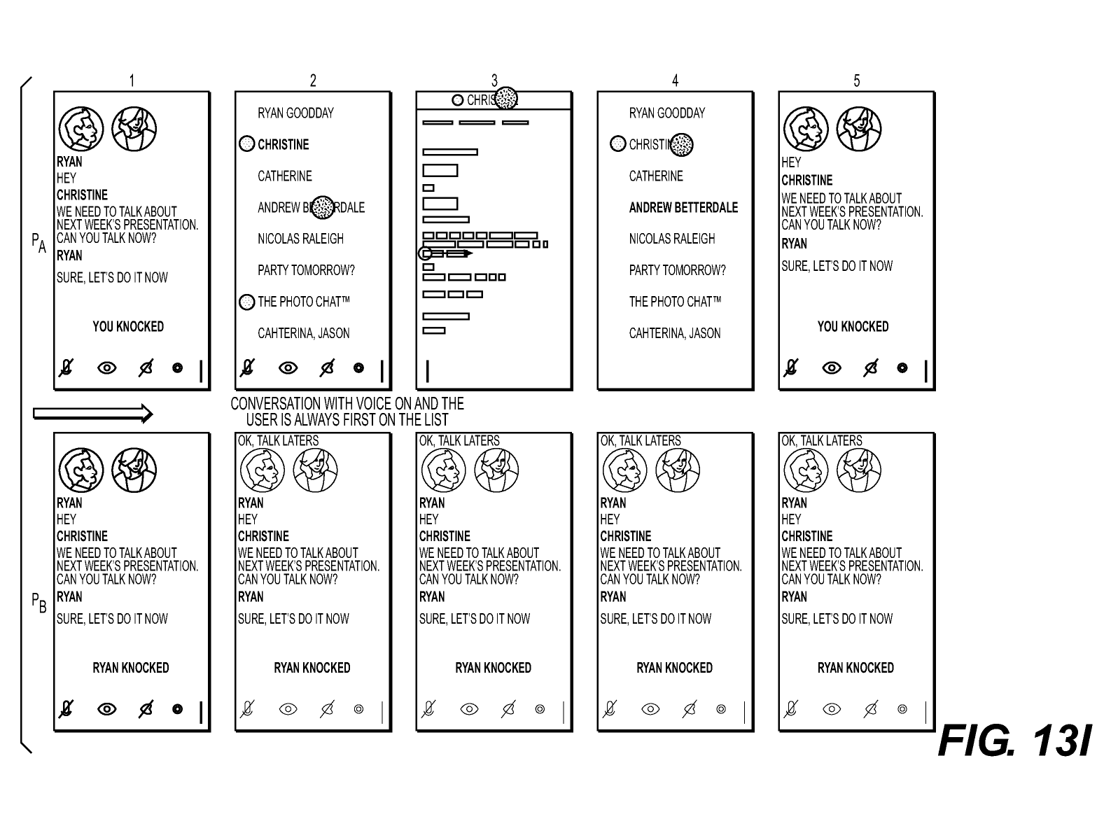

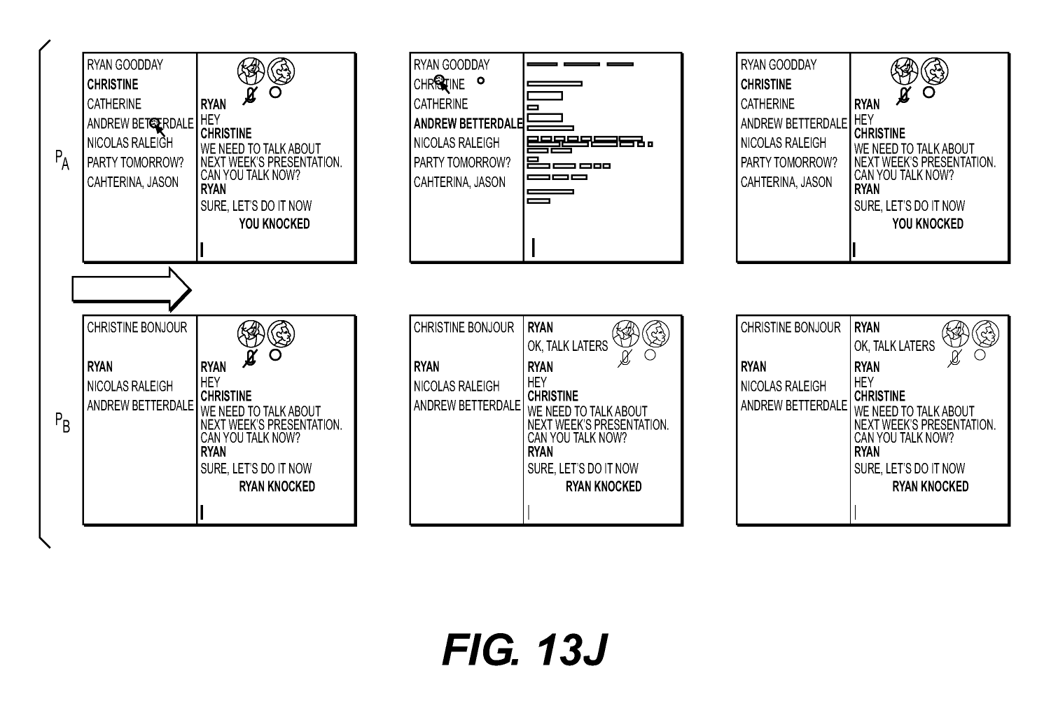

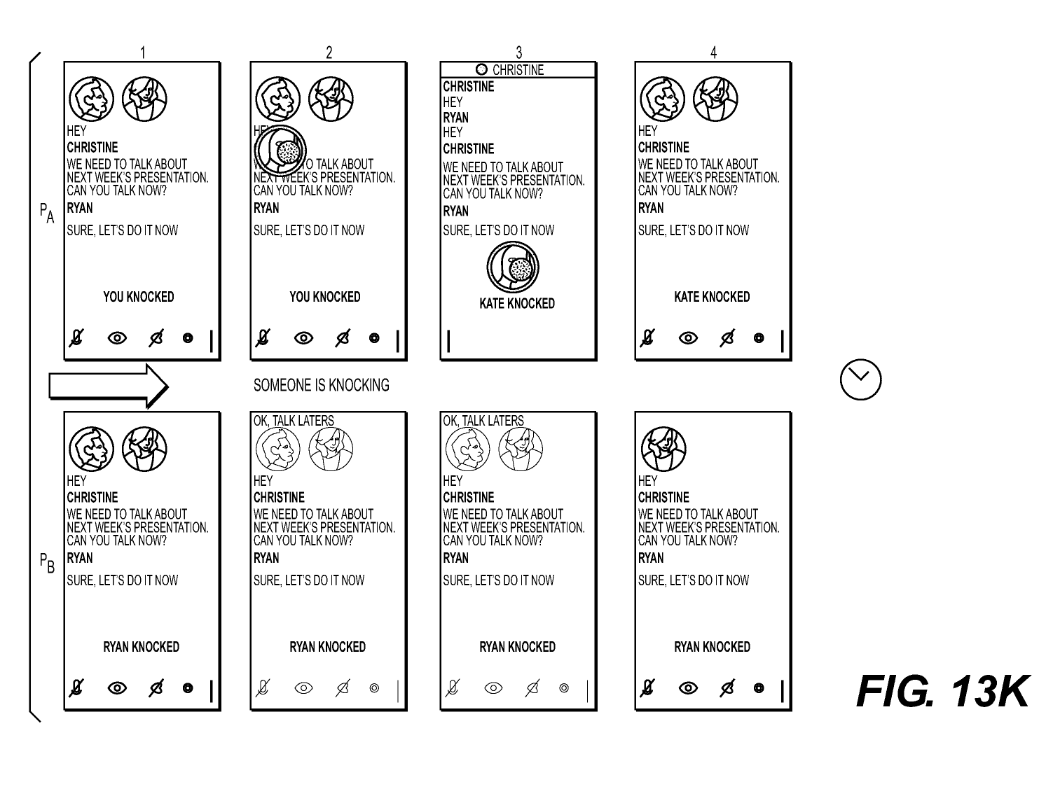

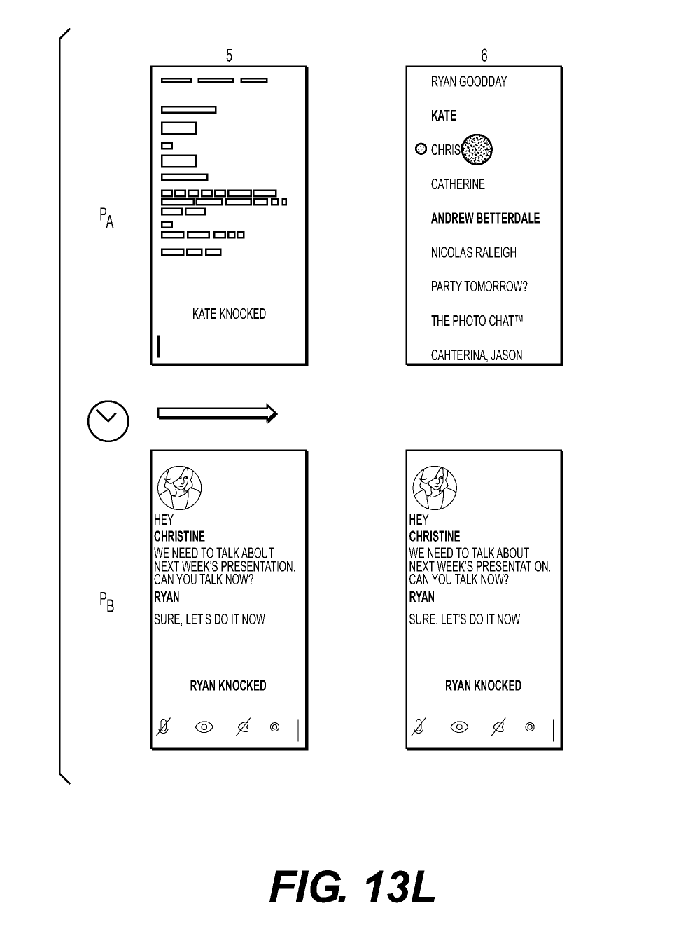

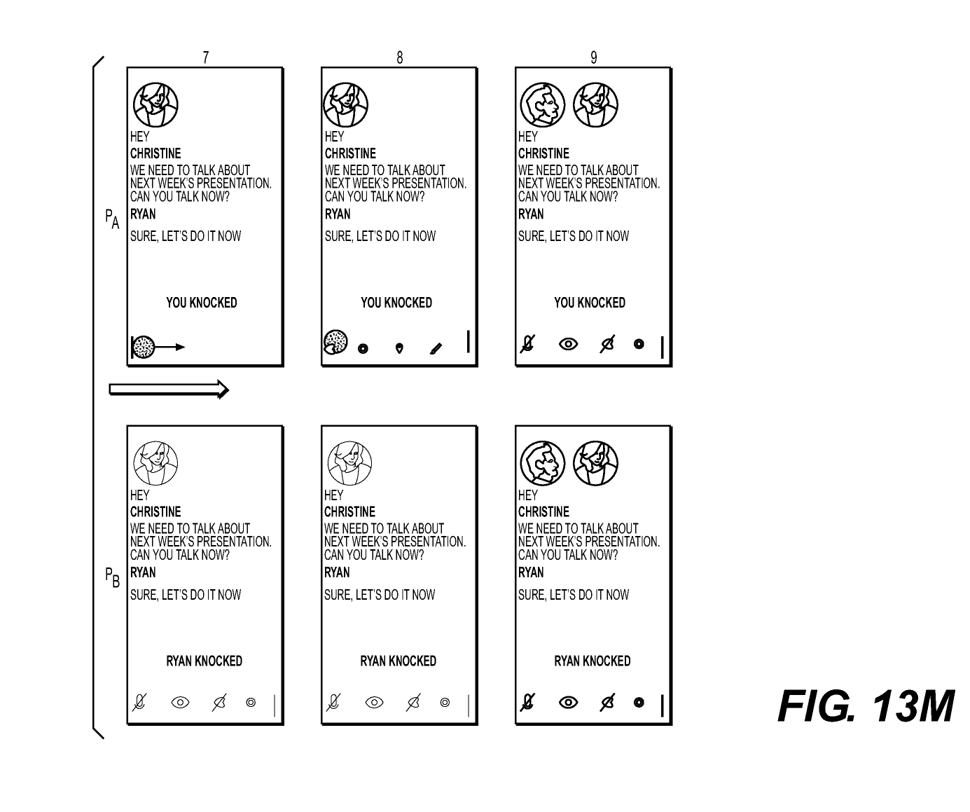

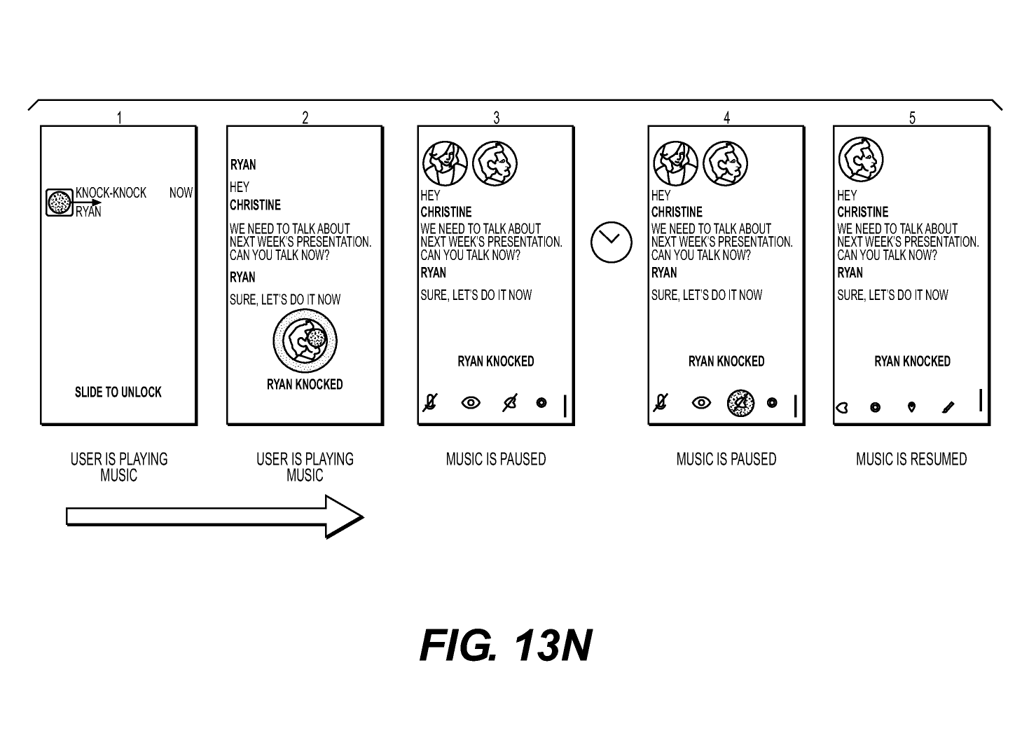

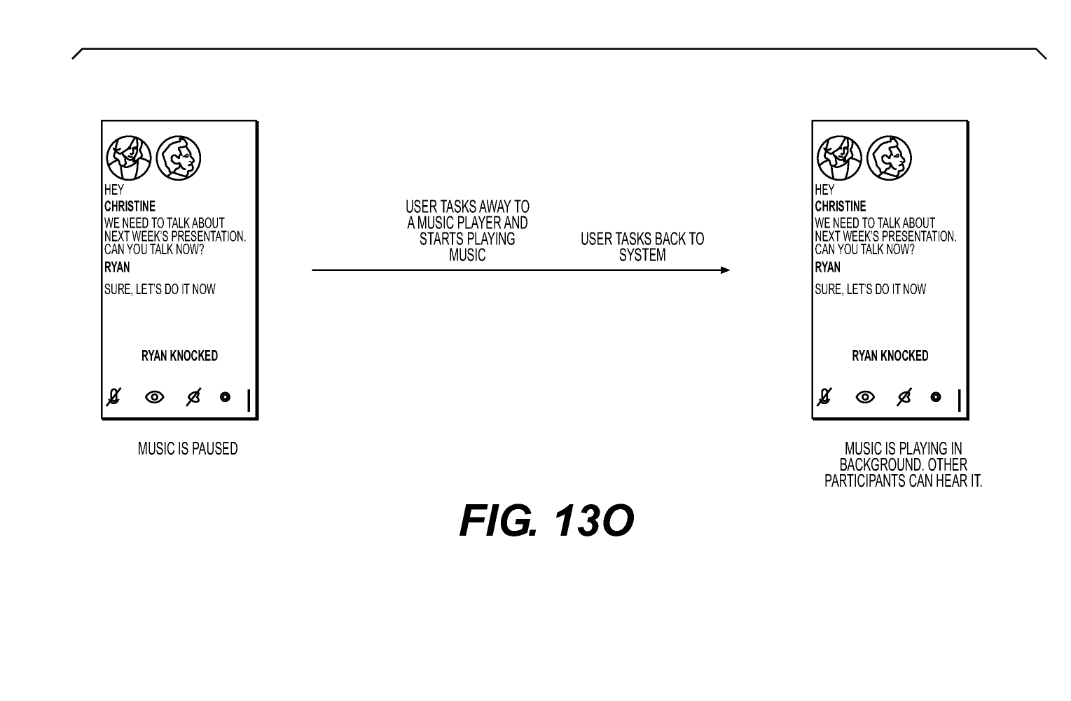

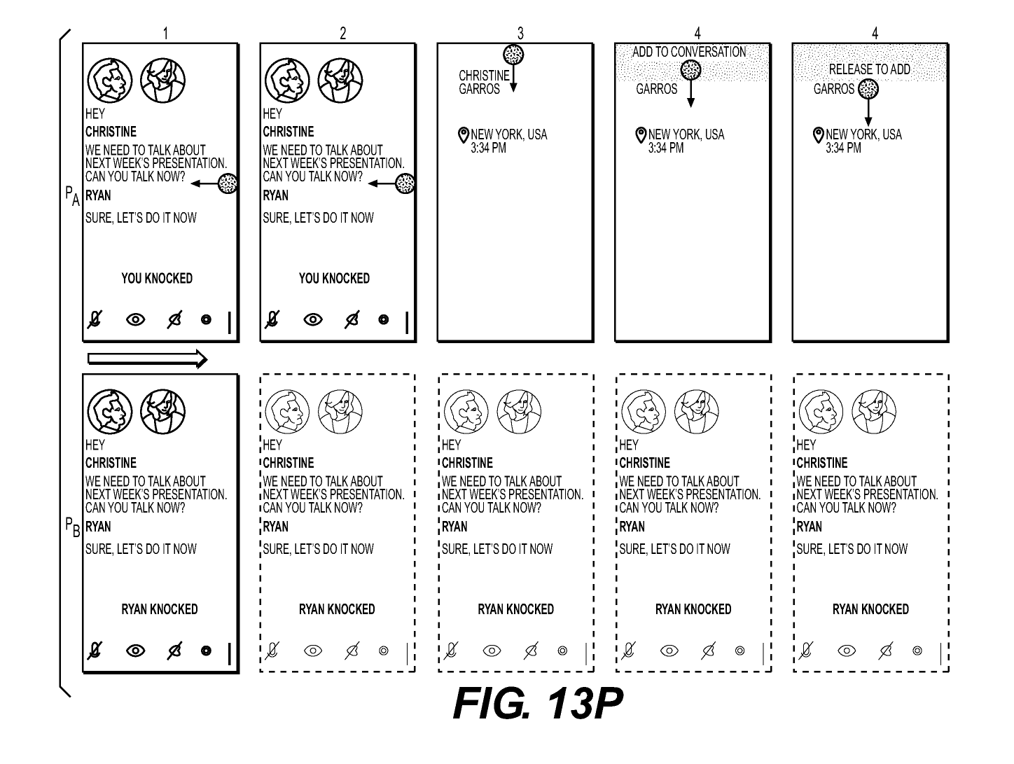

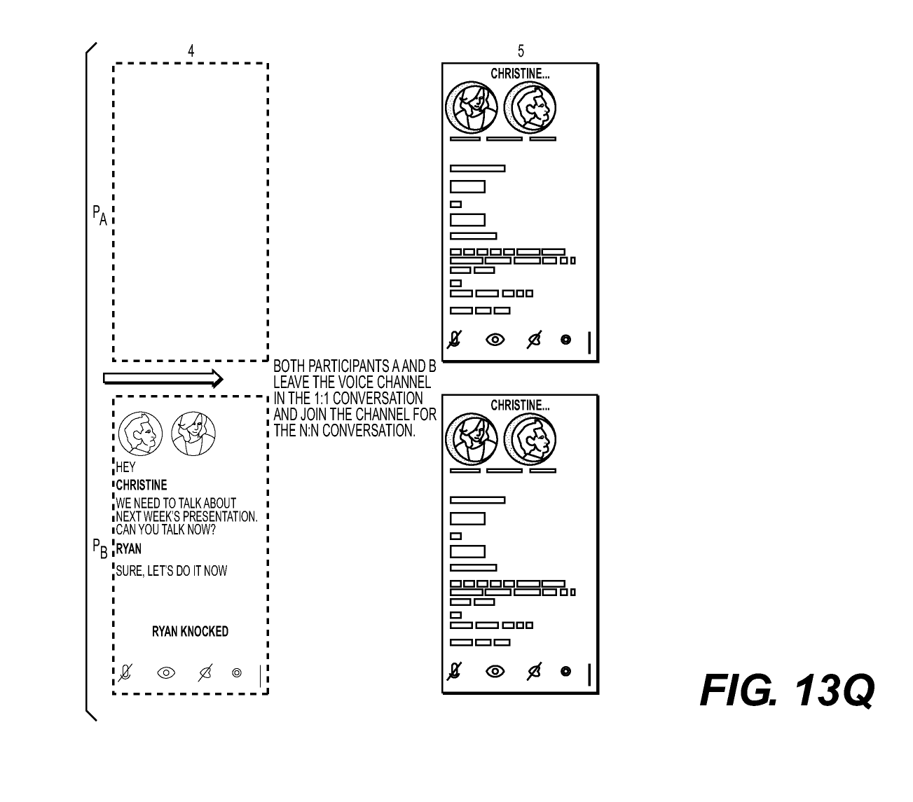

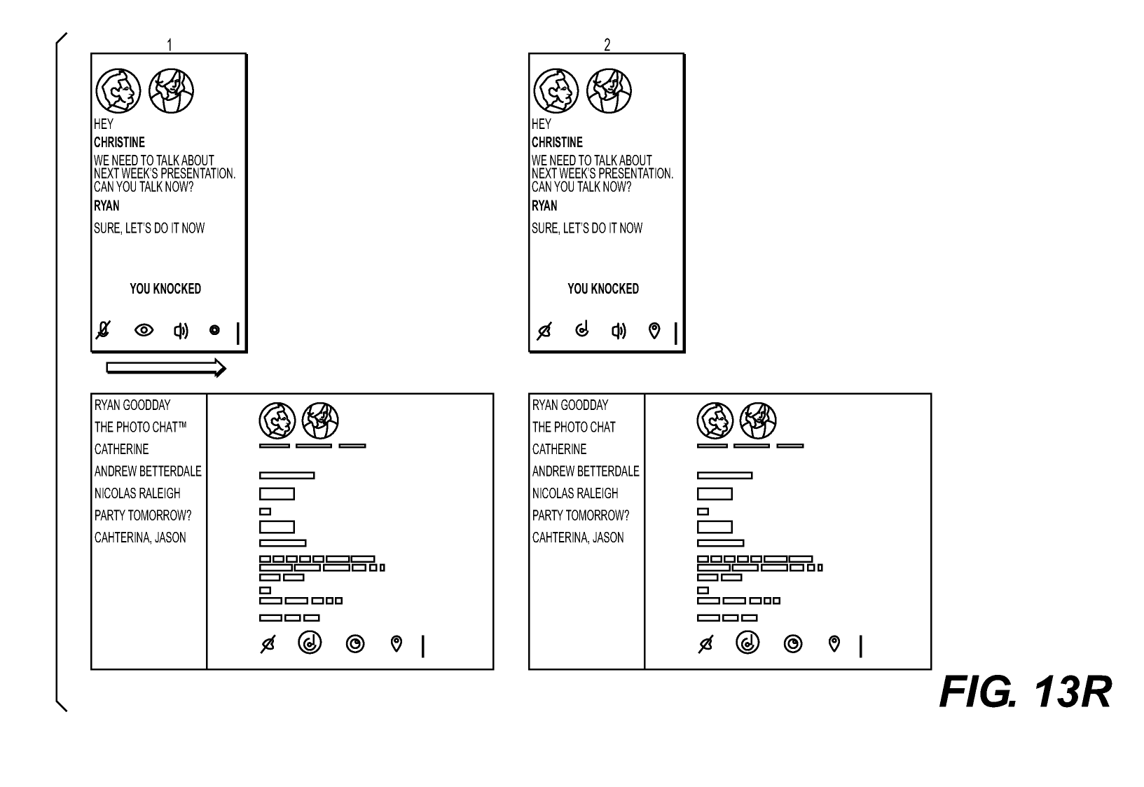

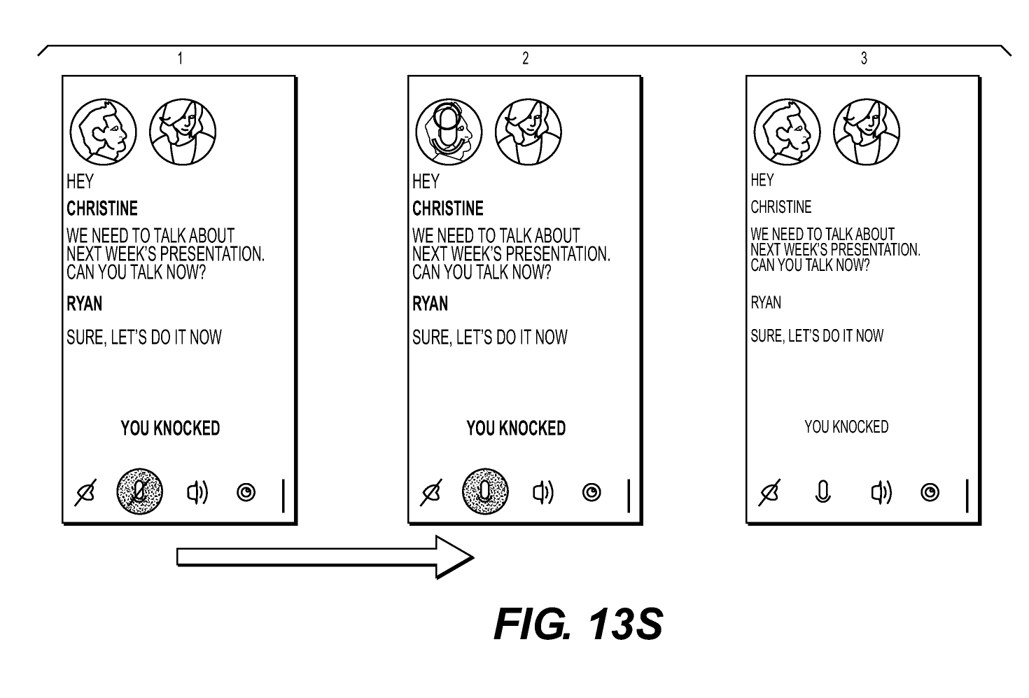

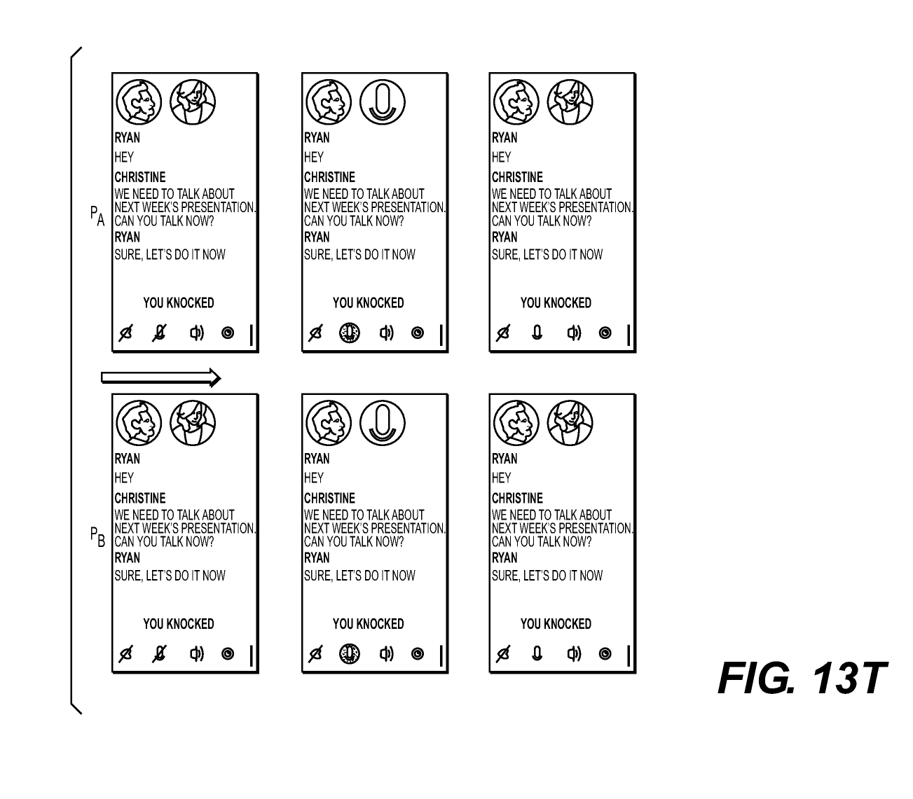

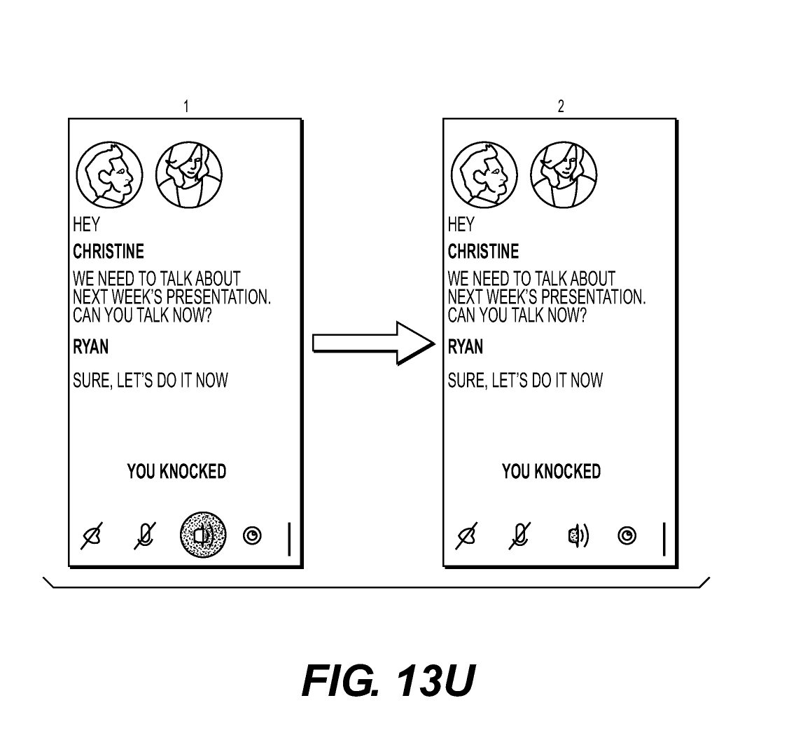

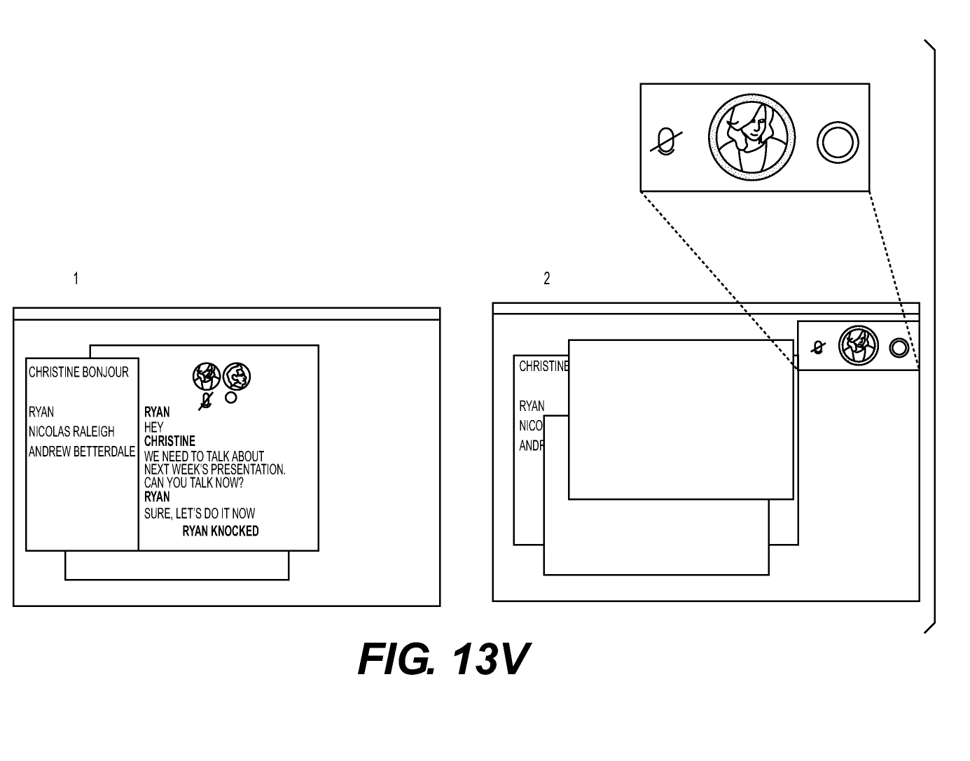

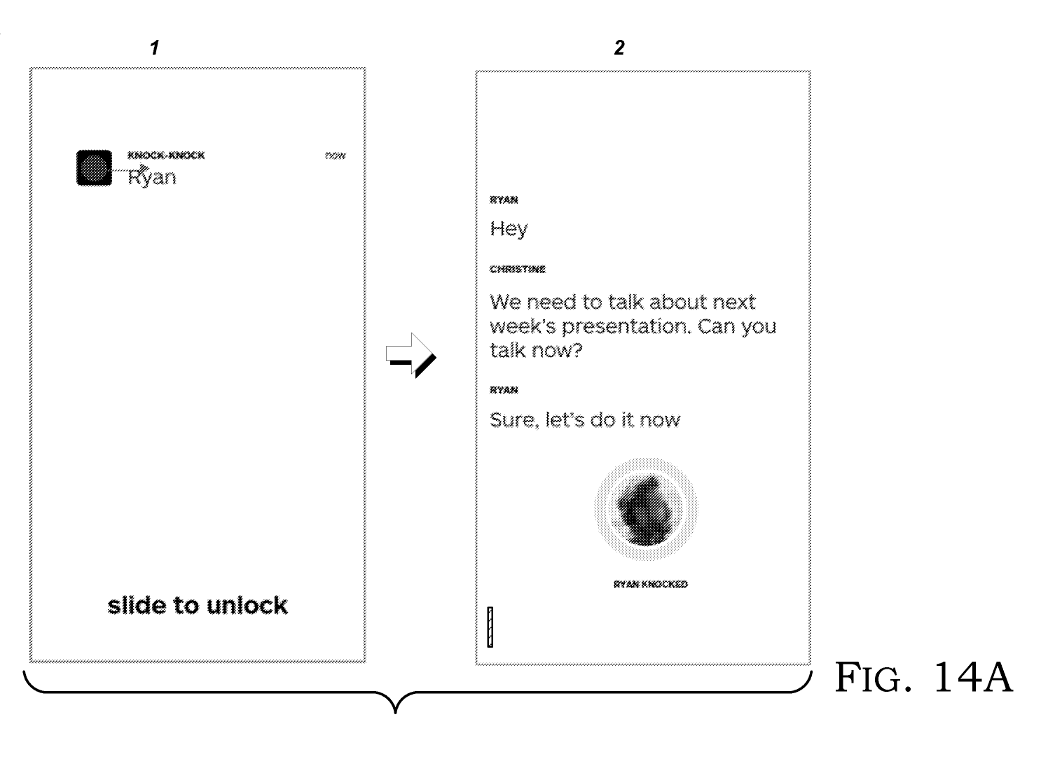

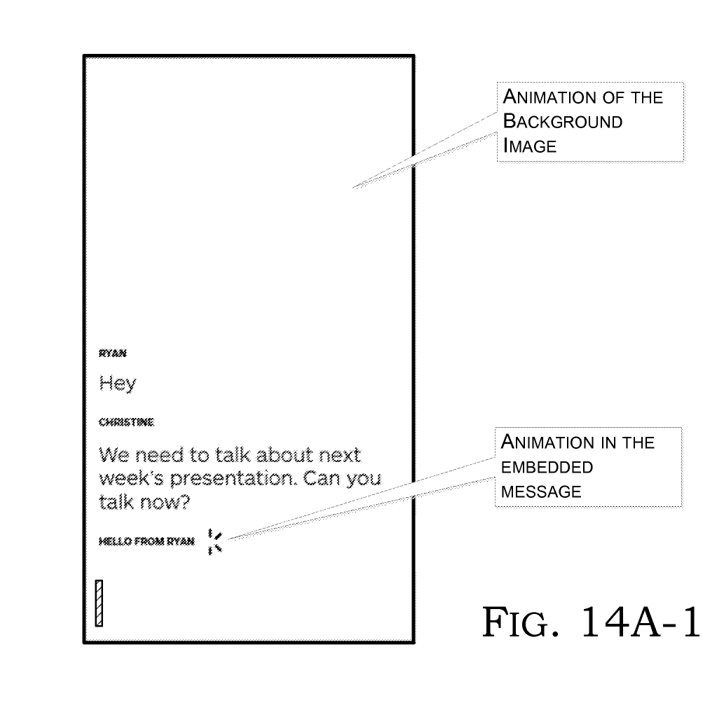

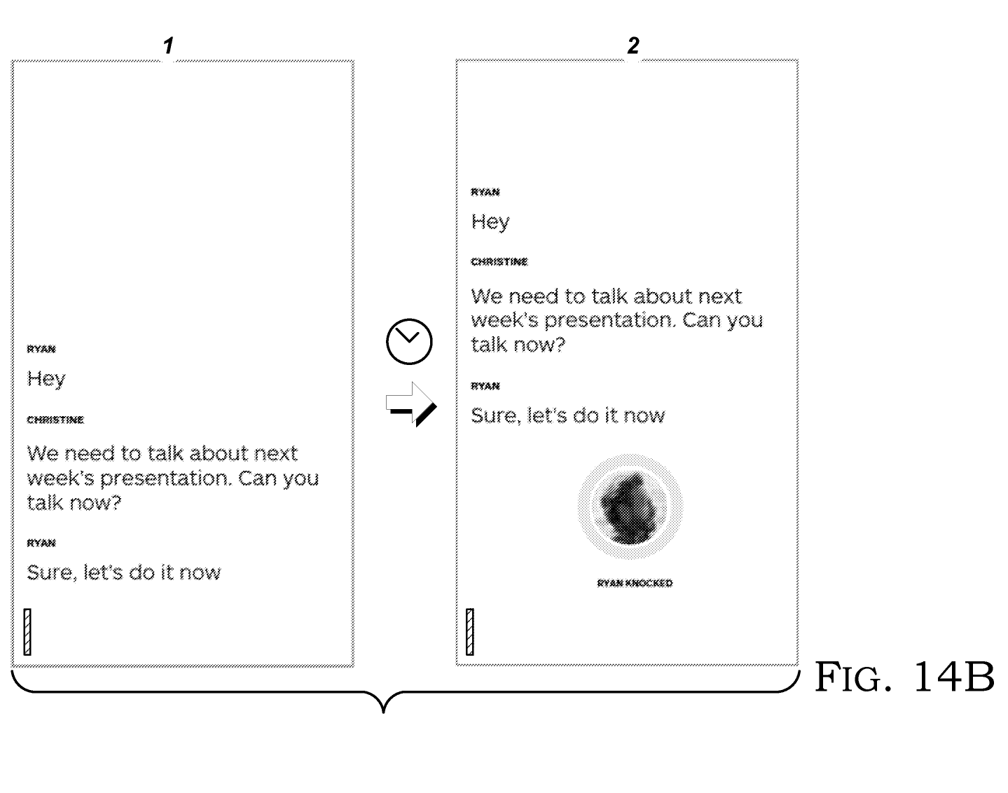

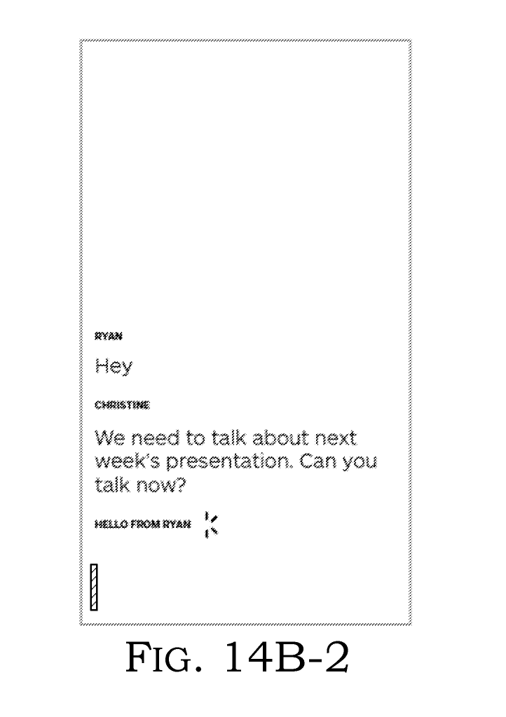

Various exemplary voice conversation scenarios are discussed here and described in FIGS. 13A-13V. In most of these examples the figures show UIs on handheld devices (e.g., as shown in FIGS. 2C-2D). In some examples the figures show UIs on desktop-type computer devices (e.g., as shown in FIG. 2B). In either case, unless stated otherwise, it should be appreciated that the same functionality may be provided by the system and UI on either type of devices or on other devices.

While Texting, Participants Agree to Switch to Voice

Embodiments of the system may support scenarios where, while texting, the participants may to switch to voice.

FIGS. 13A-13B depict aspects of an exemplary scenario in which, while texting, the participants agree to switch to voice. After talking, they leave the voice channel. In view 6 in the scenario of FIG. 13B, participant B (P_{B}) “Christine” leaves the voice channel using the menu at the bottom of the display. FIG. 13C shows an alternative approach in which participant B (P_{B}) “Christine” leaves the voice channel in view 6′ by dragging her avatar out of the voice header.

Join Ongoing Voice Channel

Embodiments of the system may support scenarios in which a participant may join an ongoing voice channel.

FIG. 13D depicts aspects of an exemplary scenario in which a participant joins an ongoing voice channel. In views 1 and 2 two participants (P_{A} and P_{B}) are in a voice conversation (i.e., in a conversation and using the voice channel), as indicated by their avatars in the voice header.

In views 1 and 2, participant P_{C} uses her menu (exposed by sliding the cursor to the right) to access the voice menu. Participant P_{C} selects the voice option and joins the voice conversation in view 3 (as indicated by the addition of her avatar to the left side of the voice header).

Multitasking—Texting while on Voice

Embodiments of the system may support scenarios in which a participant may text while on a voice channel.

FIGS. 13E-13F depict aspects of an exemplary scenario in which a participant texts while using the voice channel. In views 1 and 2 two participants (P_{A} and P_{B}) are an a voice conversation (i.e., in a conversation and using the voice channel), as indicated by their avatars in the voice header). In view 3 participant P_{B} is using her virtual keyboard (VKB). Note that the information she types in using her keyboard appears as text in the conversation of P_{A} (in view 5). In view 6 participant P_{B} is no longer using her keyboard. Note that the participants remained in the voice channel throughout the scenario.

Multitasking—Send Image while on Voice

Embodiments of the system may support scenarios in which a participant may send an image to others while on a voice channel.

FIGS. 13G-13H depict aspects of an exemplary scenario in which a participant sends an image while in a voice conversation, i.e., while in a conversation and using the voice channel. In views 1 and 2 two participants (P_{A} and P_{B}) are in a conversation and using the voice channel (as indicated by their avatars in the voice header). Between views 1 and 2 participant P_{B} selects an image to be sent (using the normal flow of selecting an image, e.g., using a camera on her device or selecting one from a gallery). In view 3 participant P_{B} sends the selected image (in this case a butterfly) that appears on her display and on the display of the other participant (P_{A}) (in views 3-5). Note that the participants remained in the voice channel throughout the scenario, although the voice header may be remain visible (view 4) or be minimized (view 4′).

The exemplary scenario in FIG. 13G also shows an example of knocking. In view 1 participant P_{A} knocks on participant P_{B}. Participant P_{A}'s screen shows an indication of the knock (views 1 and 2), as does participant P_{B}'s screen (view 1).

Multitasking—Switch from Conversation with Voice to Other and Back

Embodiments of the system may support scenarios in which a participant may switch back and forth between voice conversations with different participants.

FIG. 13I depicts aspects of an exemplary scenario in which a user multitasks, switching from a conversation with voice to another and then back.

In view 1 the two participants (P_{A} and P_{B}) are in a voice conversation (i.e., in a conversation using the voice channel), as indicated by their avatars in the voice header.

Participant P_{A} slides his screen to the right, thereby exposing the list view (participant P_{A}'s view 2). Participant P_{A}'s list shows his voice conversation with participant P_{B} as first on his list. In view 2 participant P_{A} selects another user and engages in conversation with that user. Note that during that conversation participant P_{A}'s screen displays a minimized header (e.g., as shown in FIG. 9C) indicating that participant P_{A} is still in a voice conversation with participant P_{B}.

In view 3, participant P_{A} again slides his conversation view aside to again expose his list view (view 4) from which he can select participant P_{B} to continue their voice conversation (as shown in view 5).

Note that participant P_{B}'s view remains the same throughout this scenario.

FIG. 13J shows the same scenario as shown in FIG. 13I, this time on the UI of the screen of a desktop computer.

Multitasking—Switch to Other Voice Channel

Embodiments of the system may support scenarios in which a participant may switch to another voice channel.

FIGS. 13K-13M depicts aspects of an exemplary scenario in which a user multitasks, switching from one voice channel to another.

In view 1 the two participants (P_{A} and P_{B}) are in a voice conversation (i.e., in a conversation using the voice channel), as indicated by their avatars in the voice header. In views 2 and 3 someone is knocking on participant P_{A}, as indicated by the knock indicator—the other party's animated avatar—on PA's screen.

Participant P_{A} selects the knock indicator (e.g., by tapping it on the screen) and is initially transferred to a texts conversation with Participant P_{C} (“Kate”) as shown in view 3. View 3 has a minimized voice header showing that Participant P_{A} is still in a voice conversation with Participant P_{B}. When Participant P_{A} selects to enter a voice conversation with Participant P_{C} (“Kate”) (in view 4), he leaves the voice conversation with Participant P_{B}.

When Participant P_{A} wants to rejoin the voice conversation with Participant P_{B} he may do so via the conversation list (view 6 in FIG. 13L). Participant P_{A} may also rejoin the voice conversation with Participant P_{B} via the menu (obtained by sliding the cursor in views 7 and 8 in FIG. 13M).

Note that Participant P_{B}'s view during this scenario shows that she is on the voice channel (her avatar remains in the voice header) in all views, even after Participant P_{A} left.

Multitasking—Join Voice while Listening Music

Embodiments of the system may support scenarios in which a participant may join a voice channel while listening to music on a device.

FIG. 13N depicts aspects of an exemplary scenario in which a user joins a voice channel while is listening to music. This example only shows the UI views of one participant, PB (Catherine). In view 1 music is playing on her device. In view 2 she receives a knock indication from Ryan. She selects the knock indicator and, in view 3 and 4, is shown in a voice conversation with Ryan. During that voice conversation her music is paused or muted. When she leaves the voice conversation (view 5), her music resumes playing on her device.

Multitasking—Play Music while on Voice

Embodiments of the system may support scenarios in which a participant may play music while on a voice channel.

FIG. 13-O depicts aspects of an exemplary scenario in which a user joins a voice channel while is listening to music. Note that the other participants in the voice conversation can hear the user's music.

Switch from a One-One Voice Conversation to a Multi-User Voice Conversation

Embodiments of the system may support scenarios in which a participant may switch from a one-one voice conversation to a multi-user voice conversation. FIGS. 13P-13Q depict aspects of such an exemplary scenario.

Continue Voice from One Device to Other

Embodiments of the system may support scenarios in which a participant may switch a voice conversation from one device to another. FIG. 13R depicts aspects of such an exemplary scenario, in which a user switches from a mobile device (the UI depicted in the upper portion of the drawing) to a tablet device (the UI depicted in the lower portion of the drawing).

As shown in FIG. 13R, two participants are engaged in a voice conversation. The active voice device is the one using the microphone and speakers. There is preferably only one active voice device at a time. Only the active voice device provides mute and loudspeaker controls. The user can leave Voice from any device. If the user rejoins the voice channel, the device where she does it becomes the active voice one. The user can pull the voice channel from the active one to another, becoming the new active one.

Mute Microphone

Embodiments of the system may support scenarios in which a participant may mute their microphone. FIG. 13S depicts aspects of such an exemplary scenario, in which a user mutes his microphone, and this status is indicated in his avatar (view 2).

Embodiments of the system may support scenarios in which a participant may mute the microphones of other participants. FIG. 13T depicts aspects of such an exemplary scenario, in which one user the microphone of the other user, and this status is indicated in the avatar (view 2).

Enable Loudspeakers

Embodiments of the system may support scenarios in which a user may enable loudspeakers. FIG. 13U depicts aspects of such an exemplary scenario.

Have Voice on while Using Other Application

Embodiments of the system may support scenarios in which a user may have a voice conversation on while using another application. FIG. 13V depicts aspects of such an exemplary scenario. As shown in FIG. 13V, the user is in a voice conversation in a window on their device (e.g., a desktop computer or the like). When the user switches to another application (e.g., another window) the window with the voice conversation becomes fully or partially hidden. The system preferably provides a floating mini-widow (shown blown up in the drawing) to provide information about the status of the voice conversation. The mini window preferably provides controls such as, at least, a mute control, and an indication of the name or identity of the conversation (e.g., the conversation header in some format). When a conversation heading is provided in the mini window, that heading preferably indicates who is talking. In some embodiments the system allows a user to leave the conversation via the mini window.

Knock Scenarios

Embodiments of the system may support various scenarios relating to knocks and knocking including some or all of the following:
1. The application is not running or running in the background (CASE A from the table above)
2. Conversation of the incoming knock in the foreground (CASE B.1 from the table above)
3. List view (CASE B.2 from the table above)
4. Other views (CASE B.3 from the table above)
5. Knock from the list before joining.
6. Knock from the conversation before joining
7. Join the voice channel first and then knock
8. Decline a knock with a predefined text answer
9. Decline a knock with a predefined text answer
10. Decline a knock with a custom text answer
11. Ignore/Miss a knock
12. The user creates hot knocks after the knocks expire
13. The user creates hot knocks before knocks expire
14. The user creates hot knocks before knocks expire by long tap

The Application is not Running or Running in the Background (CASE A)

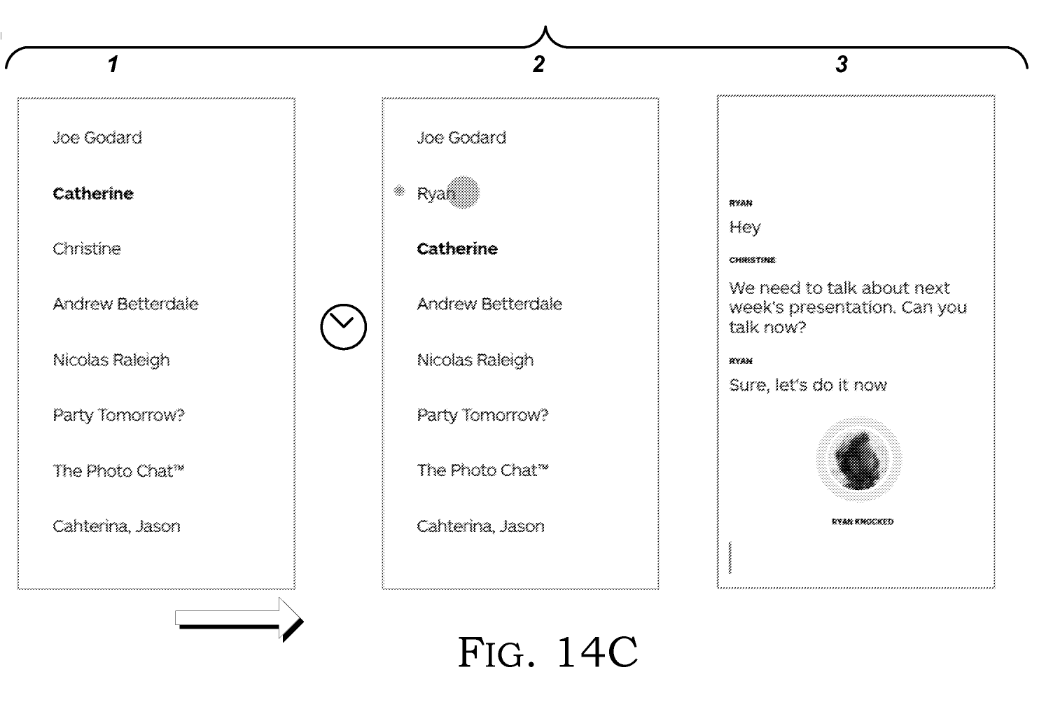

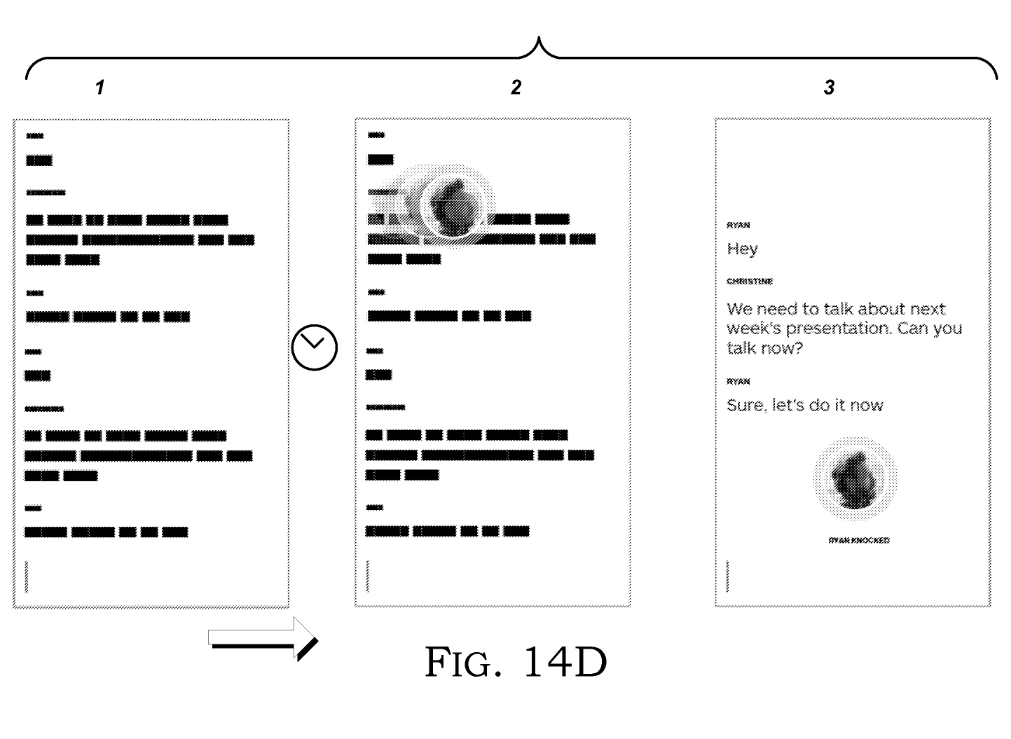

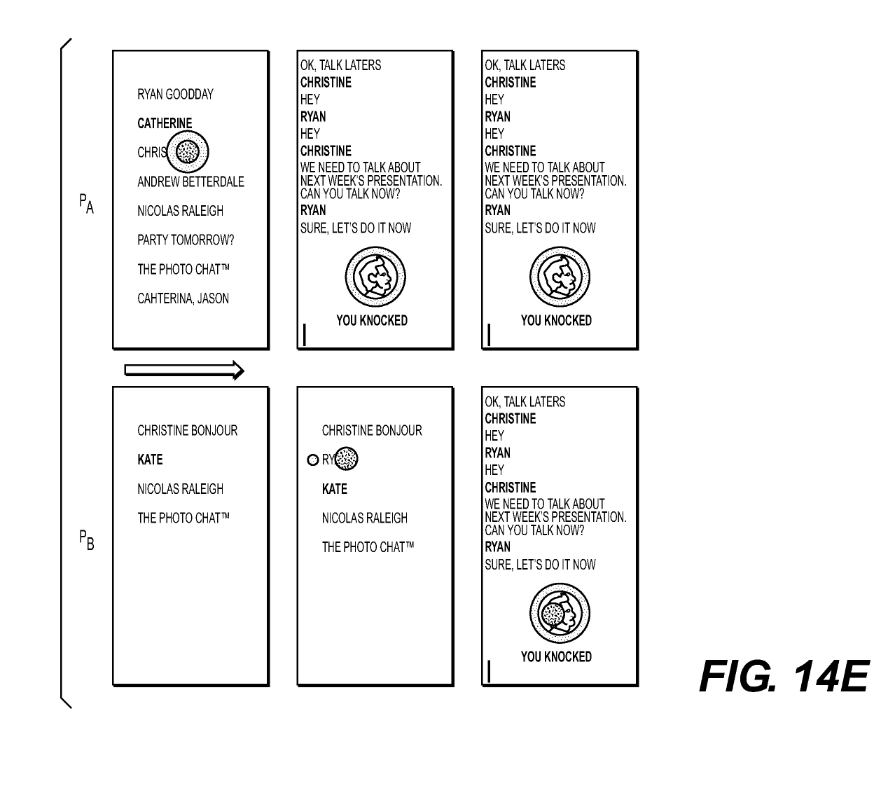

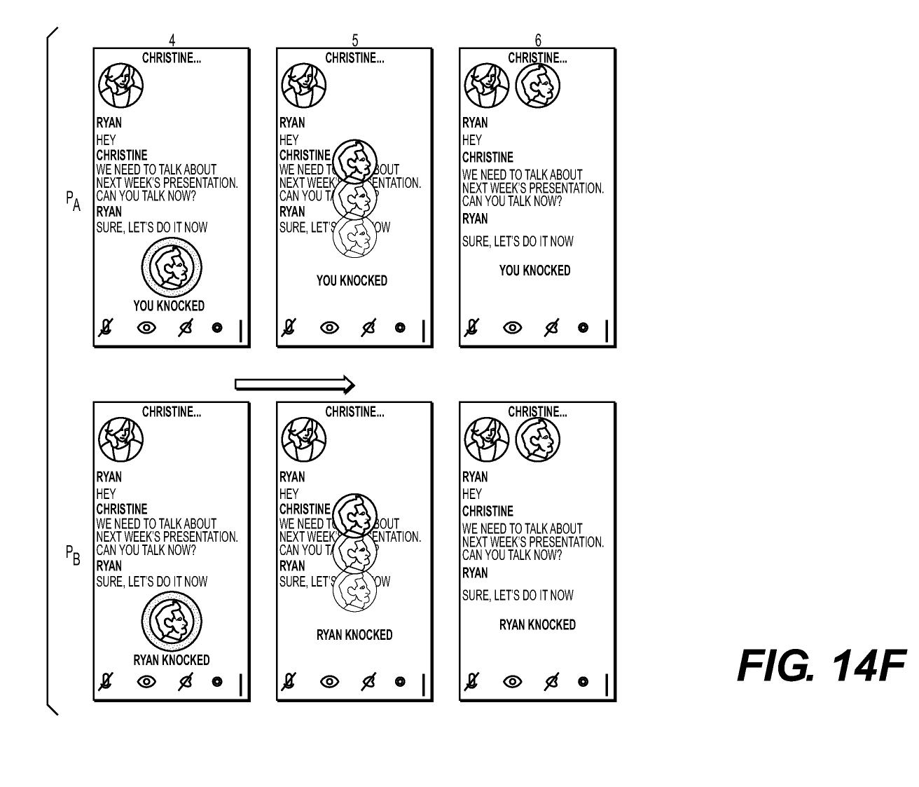

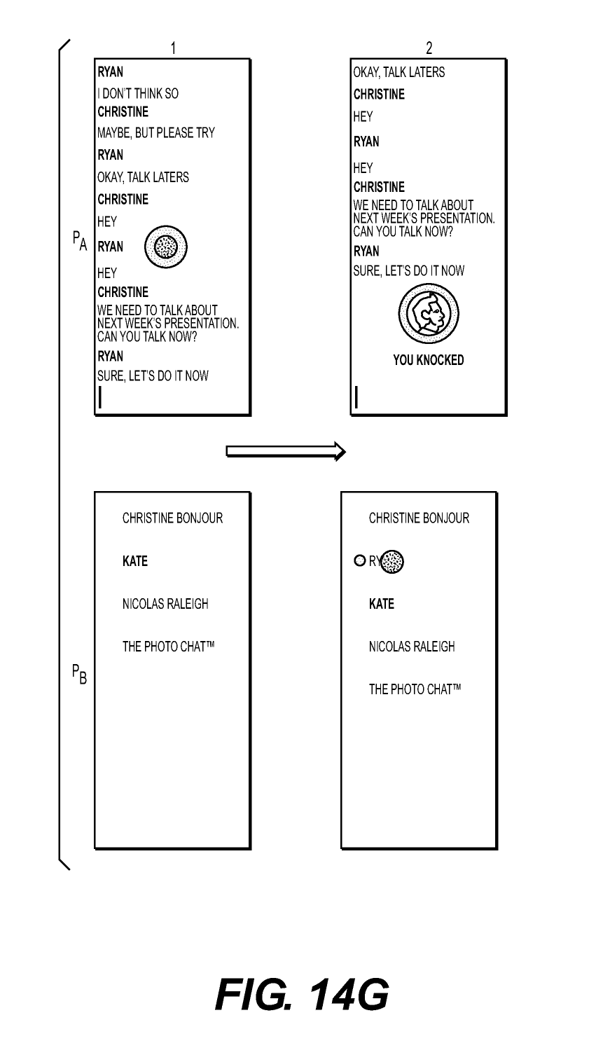

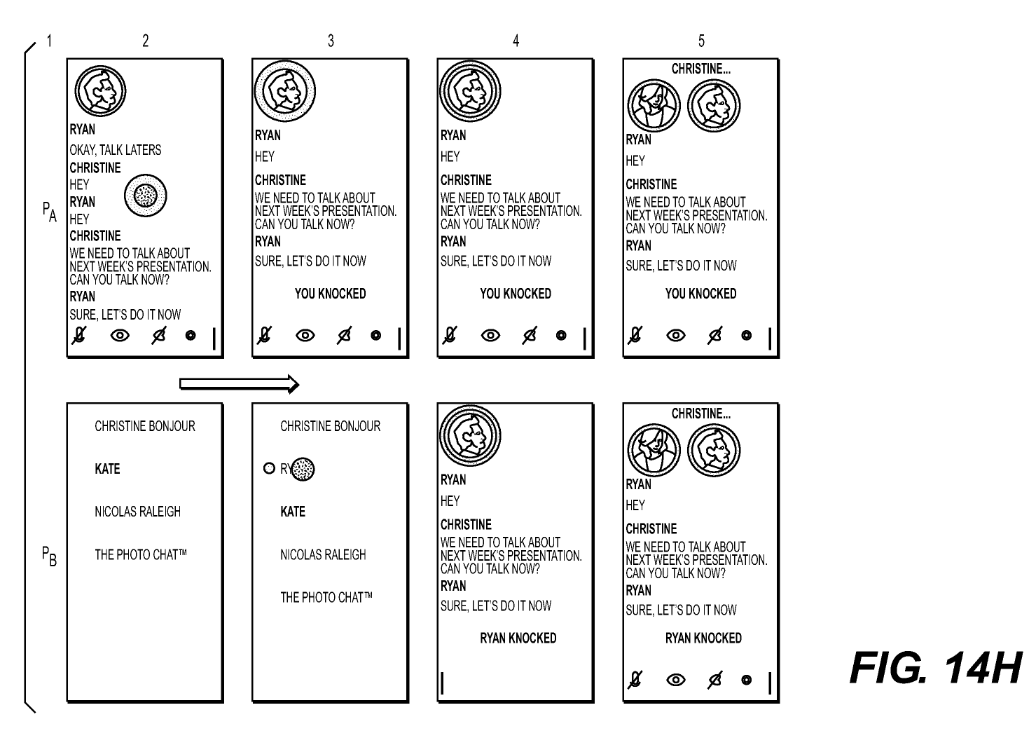

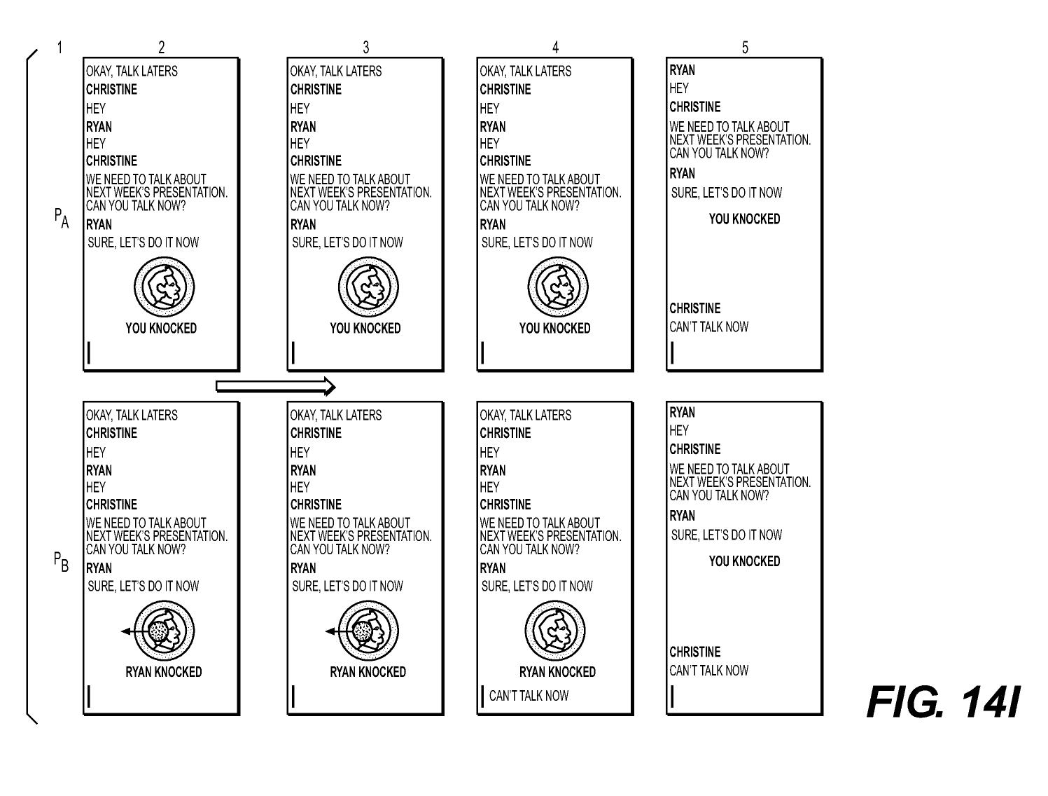

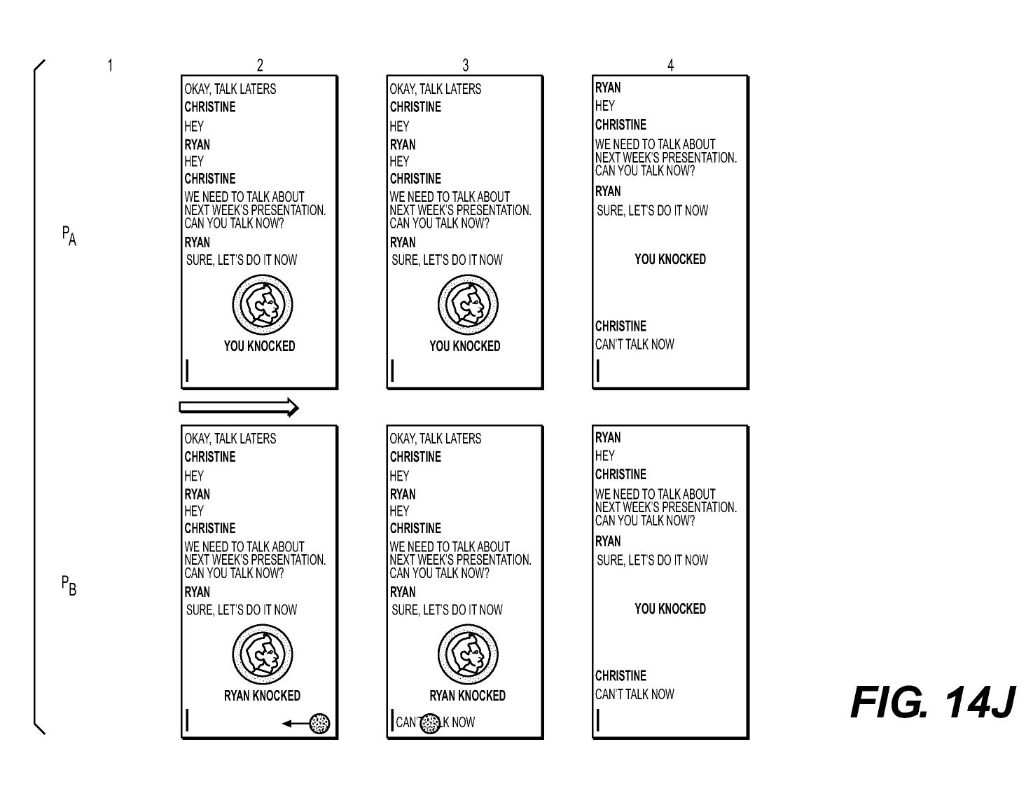

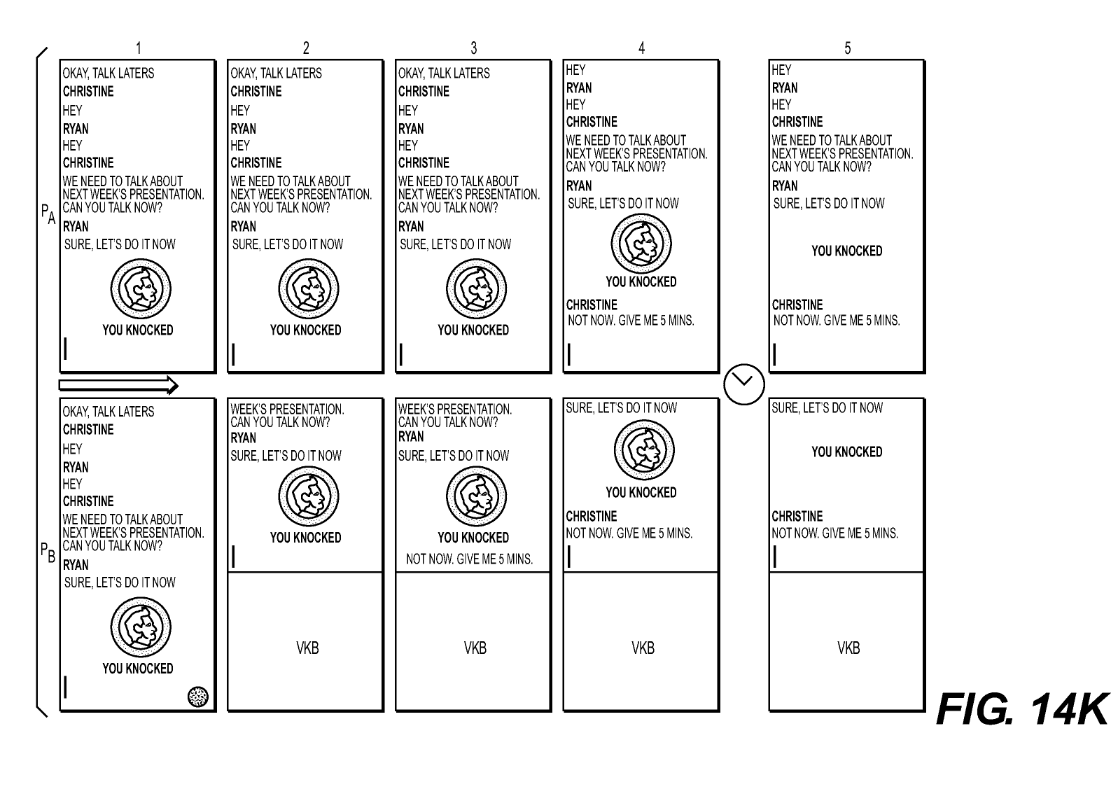

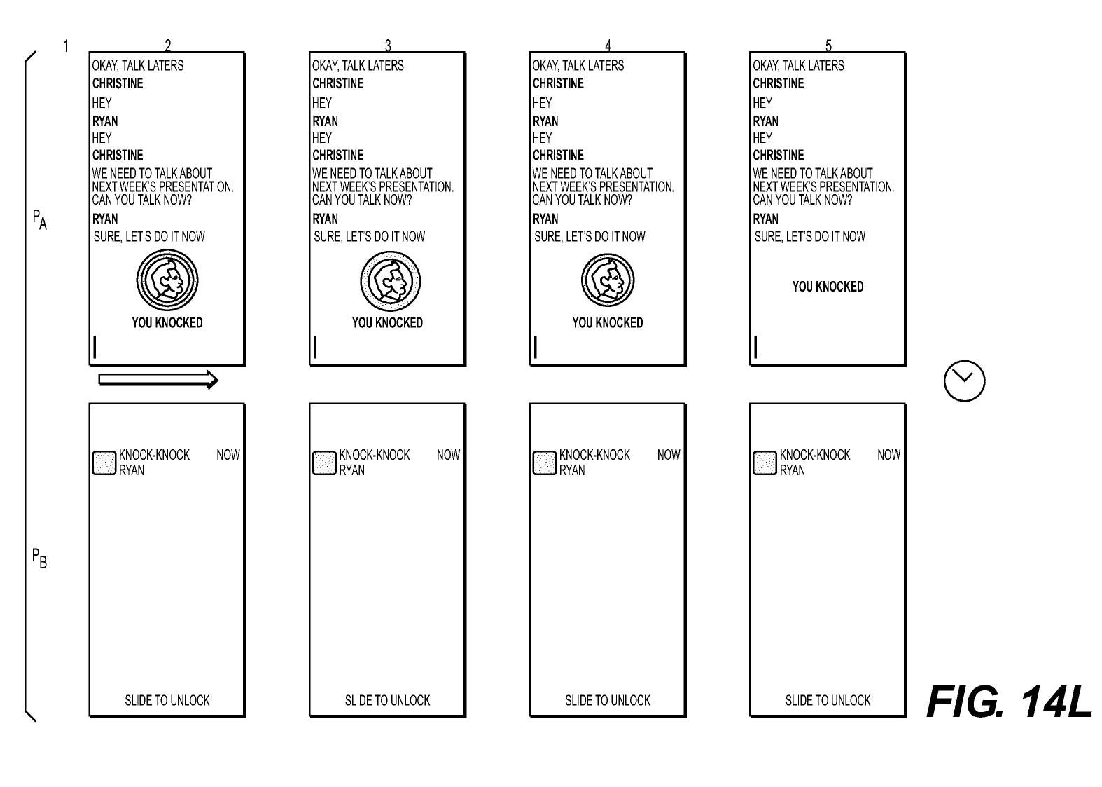

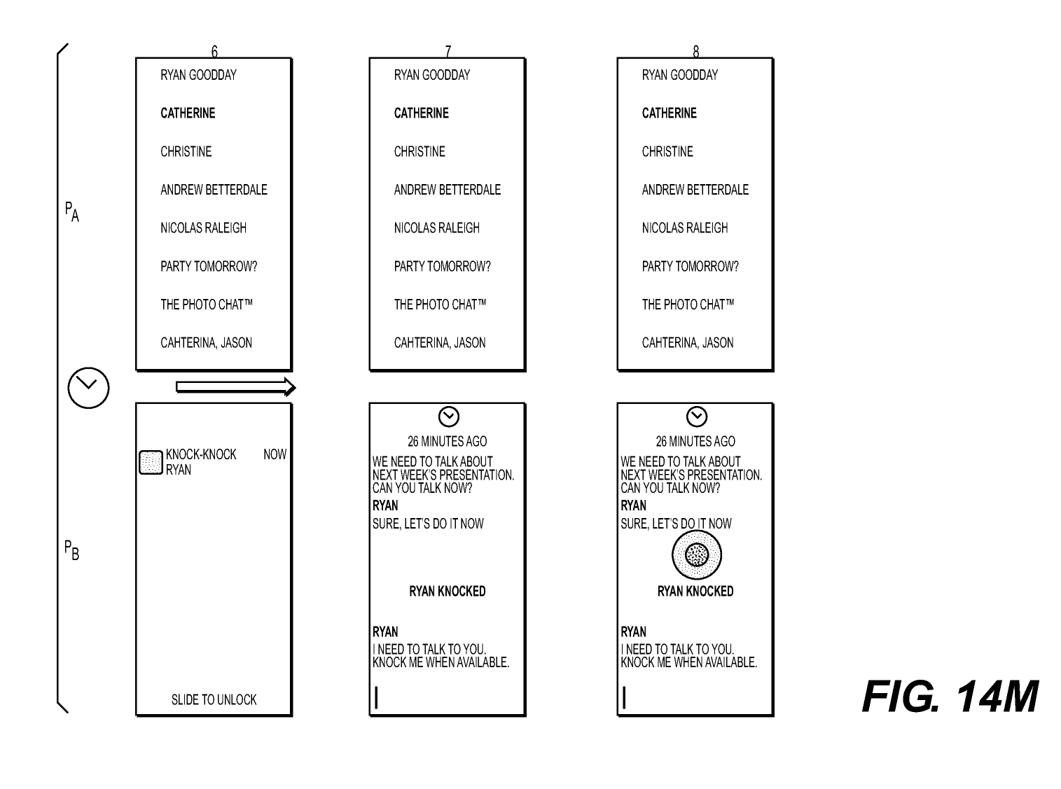

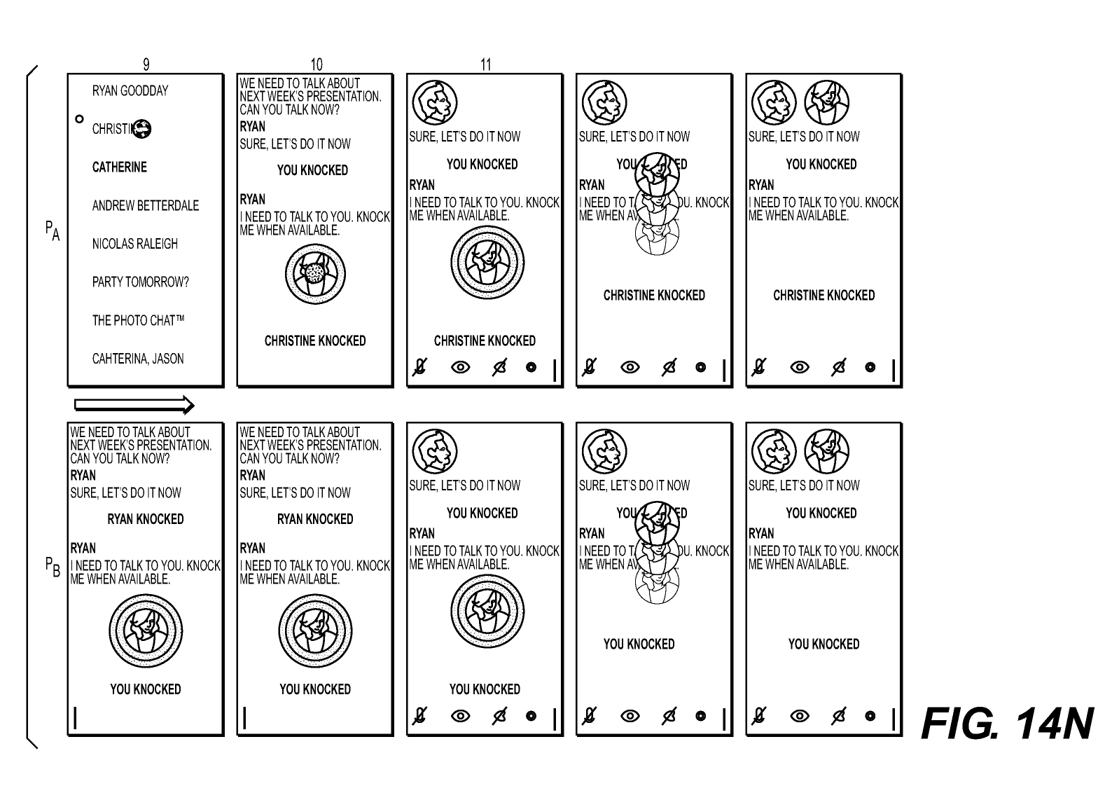

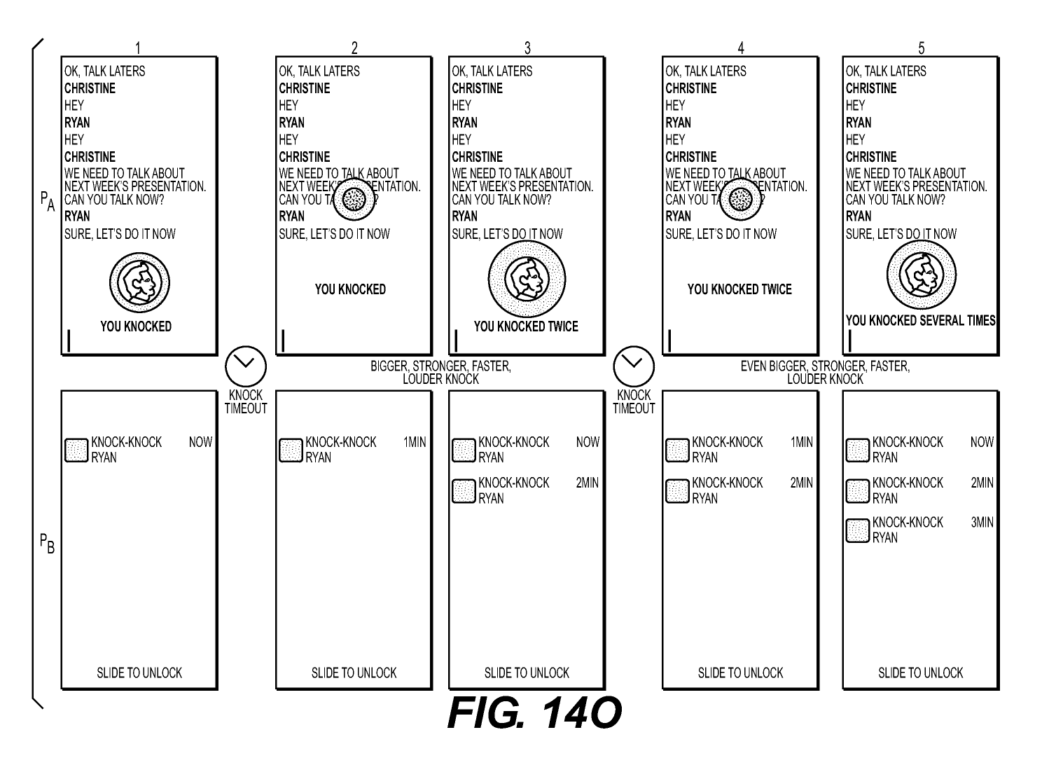

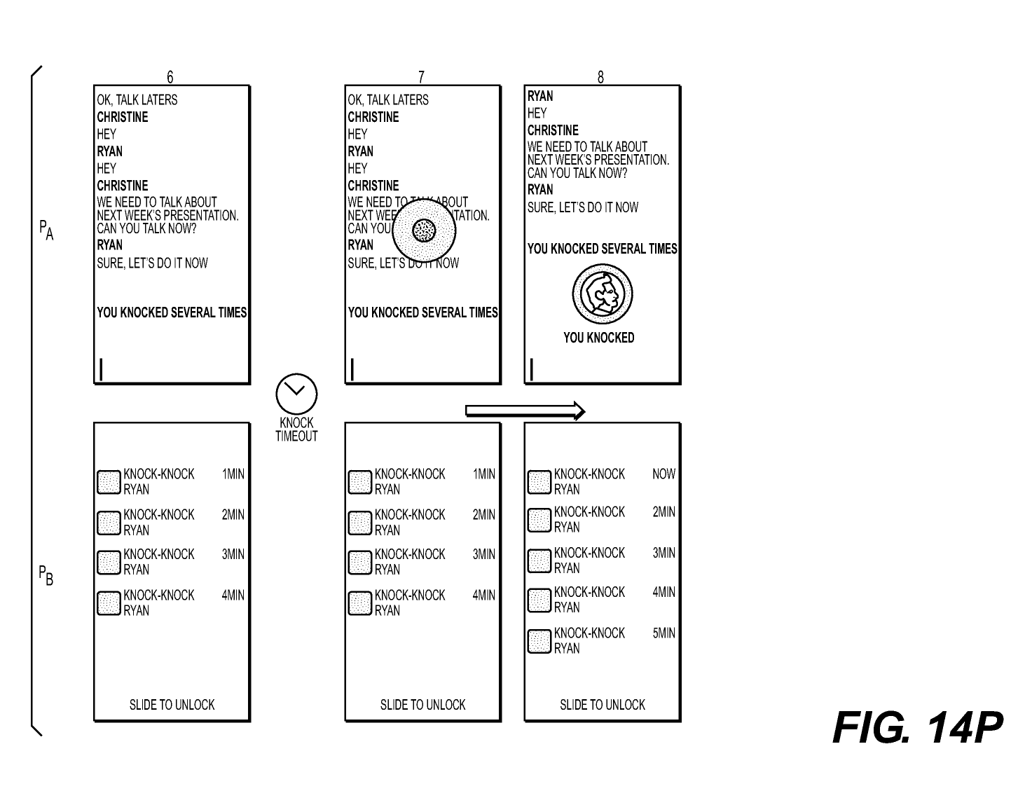

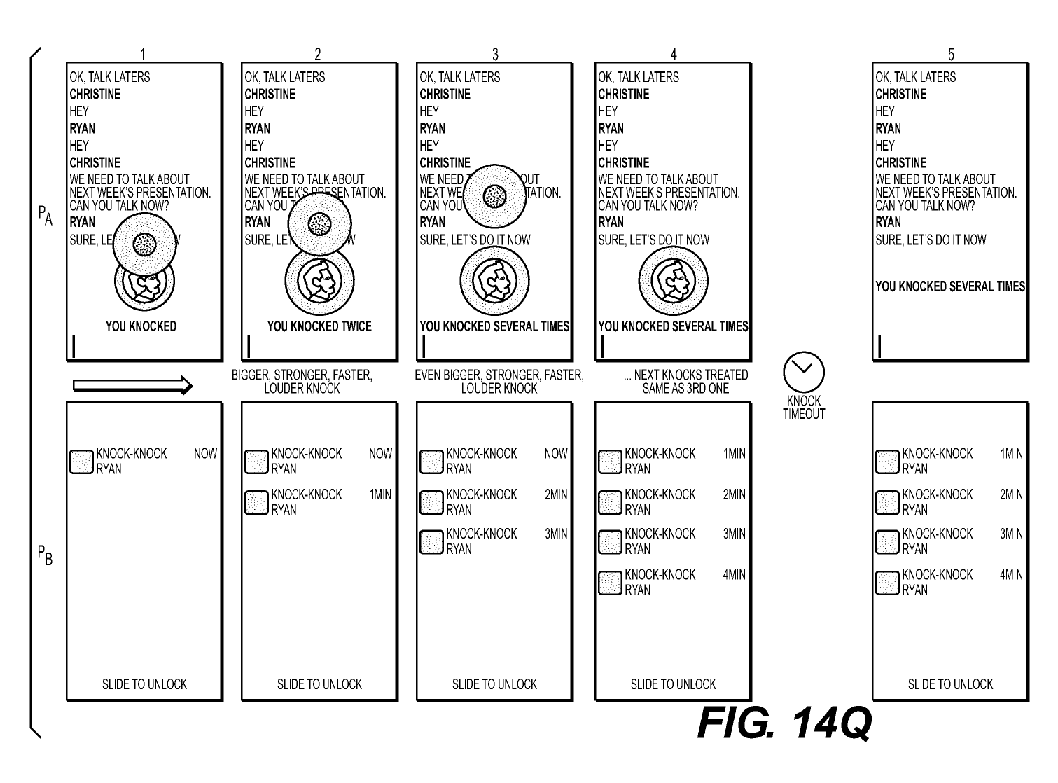

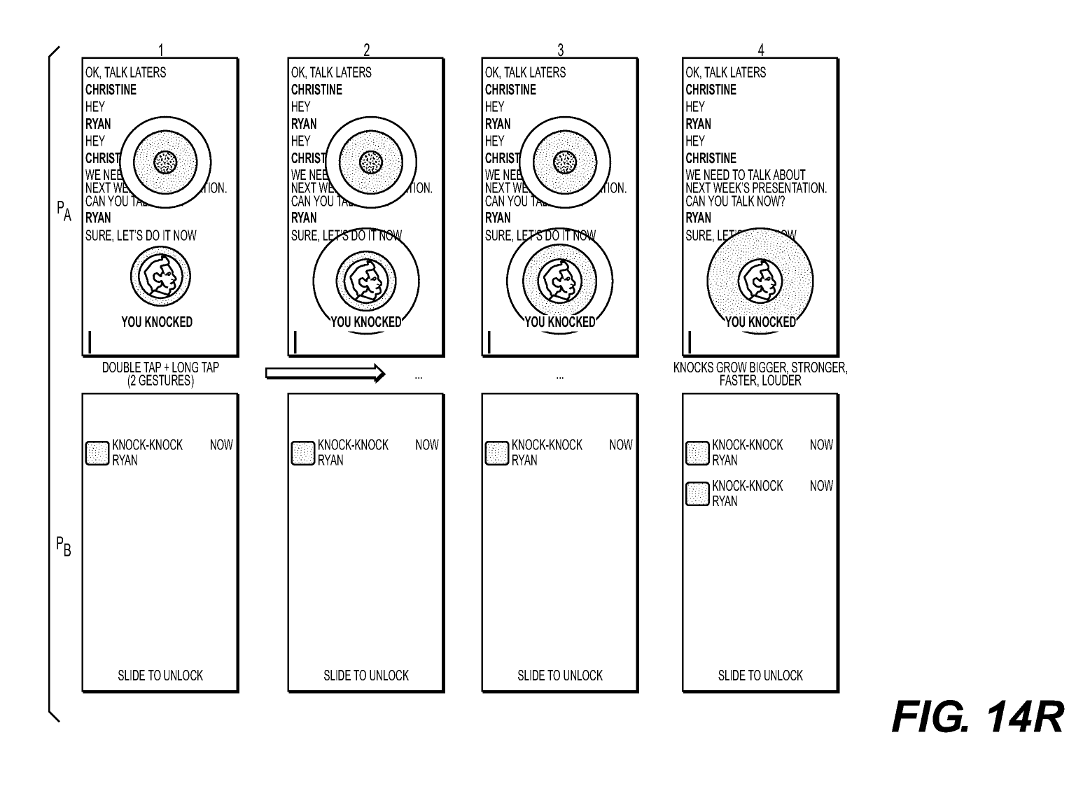

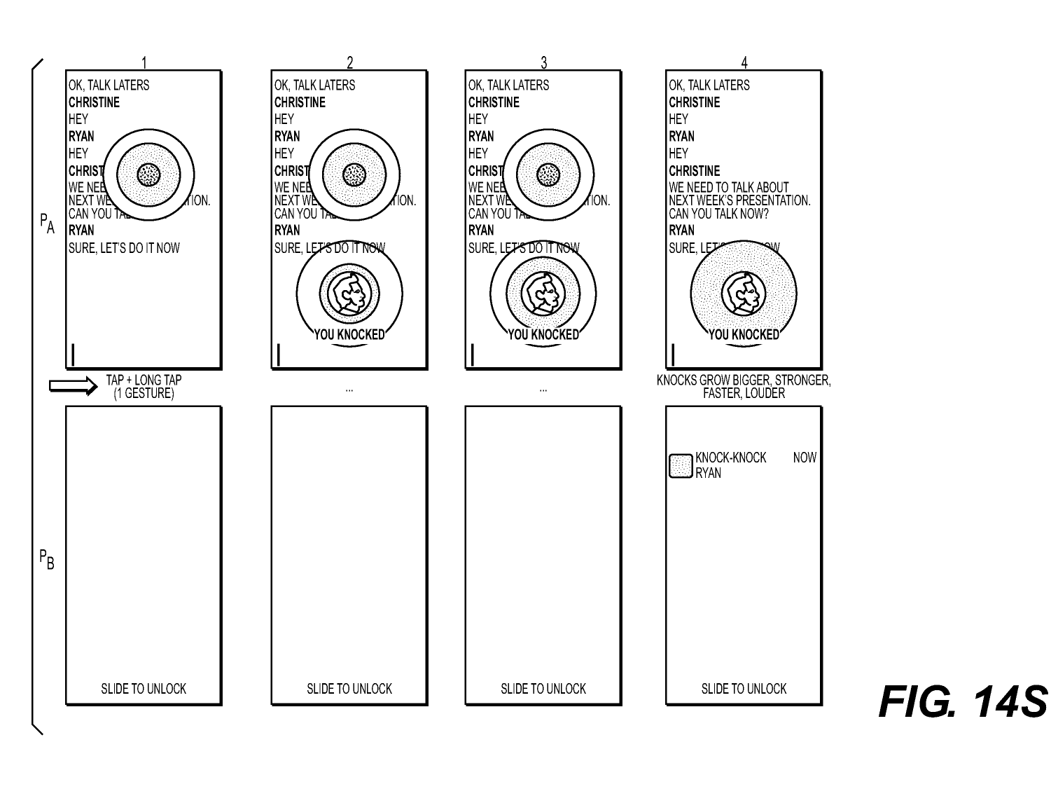

Embodiments of the system may support scenarios in which a user is knocked while the application is not running or is running in the background. FIGS. 14A and 14A-1 depict aspects of such an exemplary scenario. Although the knock is shown as an avatar in FIG. 14A, other forms of alert and/or indication may be used (as shown in FIG. 14A-1).

Conversation of the Incoming Knock in the Foreground (CASE B.1)

Embodiments of the system may support scenarios in which a conversation of the incoming knock is in the foreground. FIGS. 14B and 14B-2 depict aspects of such an exemplary scenario.

List View (CASE B.2)

Embodiments of the system may support scenarios of knocking using the list view. FIG. 14C depicts aspects of such an exemplary scenario. Animation in the list preferably uses the same animation curve as in the conversation. When the knock expires, the animation stops and the indicator is maintained.

Other Views (CASE B.3)

Embodiments of the system may support scenarios of knocking using other views. FIG. 14D depicts aspects of such an exemplary scenario.

Knock from the List Before Joining

Embodiments of the system may support scenarios of knocking using the list view before joining FIGS. 14E-14F depict aspects of such an exemplary scenario.

Knock from the Conversation Before Joining

Embodiments of the system may support scenarios of knocking from the conversation before joining FIG. 14G depicts aspects of such an exemplary scenario.

Join the Voice Channel First and then Knock

Embodiments of the system may support scenarios of joining the voice channel first and then knocking. FIG. 14H depicts aspects of such an exemplary scenario.

Decline a Knock with a Predefined Text Answer

Embodiments of the system may support scenarios of declining a knock with a predefined text answer. FIGS. 14-I and 14-J depict aspects of exemplary such scenarios.

Decline a Knock with a Custom Text Answer

Embodiments of the system may support scenarios of declining a knock with a custom text answer. FIG. 14K depicts aspects of such an exemplary scenario.

Ignore/Miss a Knock

Embodiments of the system may support scenarios of ignoring or missing a knock. FIGS. 14L-14N depict aspects of such an exemplary scenario.

The User Creates Hot Knocks after the Knocks Expire

Embodiments of the system may support scenarios of a user creating hot knocks after knocks expire. FIGS. 140-14P depict aspects of such an exemplary scenario.

The User Creates Hot Knocks Before Knocks Expire

Embodiments of the system may support scenarios of a user creating hot knocks before knocks expire. FIGS. 14Q-14S depict aspects of such an exemplary scenario.

The User Creates Hot Knocks Before Knocks Expire by Long Tap

Embodiments of the system may support scenarios of a user creating hot knocks before knocks expire. FIGS. 14T-14U depict aspects of such an exemplary scenario.

It should be appreciated that not every implementation of the system will provide all of these features, and not every feature need be provided to all users of a particular system. In addition, a system 100 may provide additional and/or different features.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

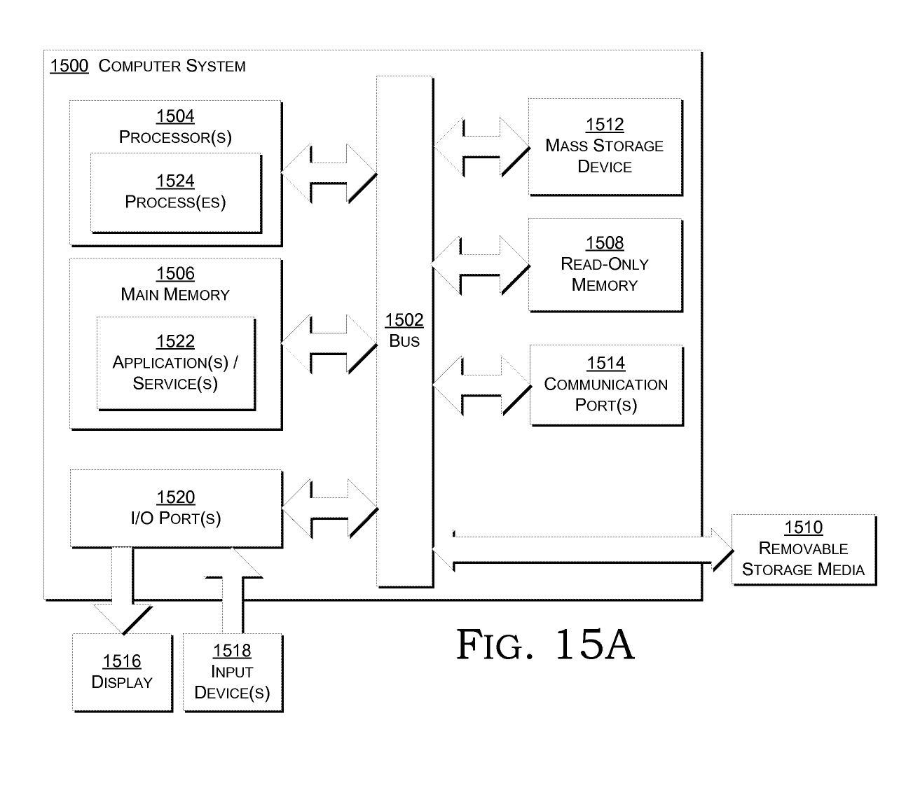

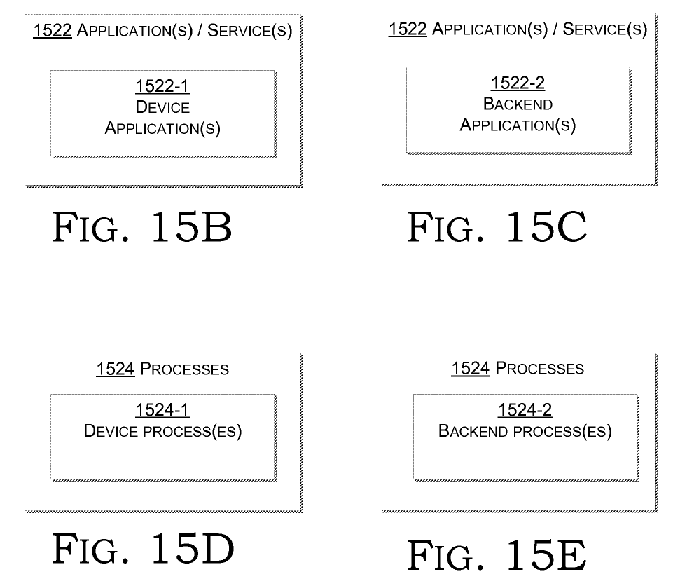

FIG. 15A is a schematic diagram of a computer system 1500 upon which embodiments of the present disclosure may be implemented and carried out.

According to the present example, the computer system 1500 includes a bus 1502 (i.e., interconnect), one or more processors 1504, one or more communications ports 1514, a main memory 1506, removable storage media 1510, read-only memory 1508, and a mass storage 1512. Communication port(s) 1514 may be connected to one or more networks by way of which the computer system 1500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1504 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1514 can be any of an RS-232 port for use with a modem based dial-up connection, a 10/100 Ethernet port, a Gigabit port using copper or fiber, or a USB port, and the like. Communications port(s) 1514 may be chosen depending on a network such as a Local Area Network (LAN), a Wide Area Network (WAN), a CDN, or any network to which the computer system 1500 connects. The computer system 1500 may be in communication with peripheral devices (e.g., display screen 1516, input device(s) 1518) via Input/Output (I/O) port 1520. Some or all of the peripheral devices may be integrated into the computer system 1500, and the input device(s) 1518 may be integrated into the display screen 1516 (e.g., in the case of a touch screen).

Main memory 1506 can be Random Access Memory (RAM), or any other dynamic storage device(s) commonly known in the art. Read-only memory 1508 can be any static storage device(s) such as Programmable Read-Only Memory (PROM) chips for storing static information such as instructions for processor(s) 1504. Mass storage 1512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1502 communicatively couples processor(s) 1504 with the other memory, storage and communications blocks. Bus 1502 can be a PCI/PCI-X, SCSI, a Universal Serial Bus (USB) based system bus (or other) depending on the storage devices used, and the like. Removable storage media 1510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1506 is encoded with application(s) 1522 that support(s) the functionality as discussed herein (an application 1522 may be an application that provides some or all of the functionality of one or more of the mechanisms described herein). Application(s) 1522 (and/or other resources as described herein) can be embodied as software code such as data and/or logic instructions (e.g., code stored in the memory or on another computer readable medium such as a disk) that supports processing functionality according to different embodiments described herein.

For example, as shown in FIGS. 15B and 15C, respectively, application(s) 1522 may include device application(s) 1522-1 in FIG. 15B (corresponding to 114 in FIG. 2A), and backend application(s) 1522-2 in FIG. 15B (corresponding to 112 in FIGS. 1 and 3, and corresponding to backend service(s) 802, FIG. 8A).

As shown, e.g., in FIG. 2A, device application(s) 114 (1522-1 in FIG. 15B) may include system/administrative applications 126, user interface (UI) applications 128, storage applications 130, messaging and signaling applications 132, and other miscellaneous applications 134.

As noted above, backend system services 802 (1522-2 in FIG. 15C) may include configuration services 812, user services 814, utilities and miscellaneous services 815, and conversation/asset manager services 816. The conversation/asset manager services 816 may include conversation services 818 and asset services 820. The utilities and miscellaneous services 815 may include search services 817.

During operation of one embodiment, processor(s) 1504 accesses main memory 1506 via the use of bus 1502 in order to launch, run, execute, interpret or otherwise perform the logic instructions of the application(s) 1522. Execution of application(s) 1522 produces processing functionality of the service(s) or mechanism(s) related to the application(s). In other words, the process(es) 1524 represents one or more portions of the application(s) 1522 performing within or upon the processor(s) 1504 in the computer system 1500.

For example, as shown in FIG. 15D, process(es) 1524 may include device process(es) 1524-1, corresponding to one or more of the device application(s) 1522-1. Similarly, as shown in FIG. 15E, process(es) 1524 may include backend process(es) 1524-2, corresponding to one or more of the backend application(s) 1522-2.

It should be noted that, in addition to the process(es) 1524 that carries (carry) out operations as discussed herein, other embodiments herein include the application 1522 itself (i.e., the un-executed or non-performing logic instructions and/or data). The application 1522 may be stored on a computer readable medium (e.g., a repository) such as a disk or in an optical medium. According to other embodiments, the application 1522 can also be stored in a memory type system such as in firmware, read only memory (ROM), or, as in this example, as executable code within the main memory 1506 (e.g., within Random Access Memory or RAM). For example, application 1522 may also be stored in removable storage media 1510, read-only memory 1508, and/or mass storage device 1512.

Those skilled in the art will understand that the computer system 1500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Real Time

Those of ordinary skill in the art will realize and understand, upon reading this description, that, as used herein, the term “real time” means near real time or sufficiently real time. It should be appreciated that there are inherent delays in network-based communication (e.g., based on network traffic and distances), and these delays may cause delays in data reaching various components Inherent delays in the system do not change the real-time nature of the data. In some cases, the term “real-time data” may refer to data obtained in sufficient time to make the data useful for its intended purpose.

Although the term “real time” may be used here, it should be appreciated that the system is not limited by this term or by how much time is actually taken. In some cases, real time computation may refer to an online computation, i.e., a computation that produces its answer(s) as data arrive, and generally keeps Uₚ with continuously arriving data. The term “online” computation is compared to an “offline” or “batch” computation.

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

Appendix A (U.S. Provisional Patent Application No. 61/860,222, titled “Unified and Consistent Multimodal Communication Framework,” filed Jul. 30, 2013, the entire contents of which are fully incorporated herein by reference for all purposes.)

What is claimed:

1. A computer-implemented method, operable in a communication framework in which each of a plurality of users has one or more devices associated therewith, and in which the users use at least some of their devices to communicate via a backend system,
the method comprising,
(A) maintaining, in the backend system, a conversation between one or more users of the plurality of users, wherein the conversation comprises a time-ordered sequence of objects, and wherein the conversation maintained by the backend is an authoritative version of the conversation within the communication framework, wherein the conversation includes a logical voice channel;
(B) providing a user interface (UI) on each device, said UI supporting establishing a voice conversation using the voice channel.

2. The method of claim 1 wherein said conversation comprises a logical messaging channel, and wherein UI supports establishing said voice conversation using the voice channel while using said logical messaging channel.

3. The method of claim 2 wherein the UI provides access to a voice menu, said voice menu including at least one voice region that, when selected, causes the device to join the voice channel of the conversation.

4. The method of claim 3 wherein, when the device is actively using the voice channel of the conversation, the voice menu provides at least a second region that, when selected, causes the device to leave the voice channel of the conversation.

5. The method of claim 3 wherein, when the device is actively using the voice channel of the conversation, the voice menu provides at least a third region that, when selected, causes the device selectively to mute or un-mute the voice channel of the conversation.

6. The method of claim 1 wherein each conversation has at least one participant, and wherein, when at least one participant of a conversation is using the voice channel of that conversation, the UI provides a voice header for that conversation, wherein at least some of the participants of the voice channel of the conversation are identified in the voice header of the conversation.

7. The method of claim 6 wherein a particular participant in a voice channel of a conversation is identified in the voice header of the conversation is using an iconic representation of said particular participant.

8. The method of claim 7 wherein the iconic representation of said particular participant is an animated representation of said particular participant.

9. The method of claim 7 wherein the iconic representation is derived from user information about said particular participant maintained in the backend.

10. The method of claim 9 wherein the iconic representation is based on a picture of the particular participant maintained in the backend.

11. The method of claim 6 wherein the voice header is modified based on which users in the conversation are current participants in the voice channel.

12. The method of claim 6 wherein the UI supports a user leaving the voice channel of a conversation by dragging their iconic representation out of the voice header.

13. The method of claim 6 wherein the voice header is ordered based on which user most recently joined the voice channel.

14. The method of claim 1 wherein the UI supports a user using another channel of the conversation while using the voice channel of the conversation.

15. The method of claim 14 wherein the other channel is a text channel of the conversation.

16. The method of claim 14 wherein the UI supports the user sending an image while on the voice channel.

17. The method of claim 14 wherein the UI supports the user listening to music while on the voice channel.

18. The method of claim 14 wherein the UI supports the user playing music to other users on the voice channel.

19. The method of claim 1 wherein, when the user is using the voice channel of a conversation on a first device, the UI supports switching to using the voice channel on a second device.

20. The method of claim 1 wherein the UI supports the user muting other users in the voice channel of the conversation.

21. The method of claim 1 wherein, when a user is on a voice channel with at least one other user, the user automatically leaves the voice channel when all other users leave the voice channel.

22. The method of claim 1 wherein, when the user is first to join the voice channel of a conversation, the user is initially muted in the conversation.

23. The method of claim 1 wherein the UI is provided as part of an application on the device, and wherein, when the user terminates or closes the application on the device, the user leaves the voice channel of the conversation on the device.

24. The method of claim 1 wherein the UI supports a particular user in a conversation attempting to get the attention of at least one other user in the conversation.

25. The method of claim 1 wherein the UI supports a particular user in a conversation attempting to get the attention of all other users in the conversation.

26. The method of claim 24 wherein the UI supports the particular user in a conversation attempting to get the attention of said at least one other user in the conversation by the particular user tapping a number of times on the name or iconic representation of said at least one other user in the conversation.

27. The method of claim 26 wherein said number of times is greater than two.

28. The method of claim 1 wherein the UI supports a particular user in a conversation attempting to get the attention of a user in the conversation, wherein, in response to an attempt by said particular user to get the attention of said user, the UI provides an alert indicator to the user.

29. The method of claim 28 wherein the alert indicator comprises an animated indicator.

30. The method of claim 28 wherein the alert indicator comprises an audio indicator.

31. The method of claim 28 wherein said alert times out after a time out period.

32. The method of claim 31 wherein, when the particular user attempts to get the attention of another user during the time out period, then the UI supports extending the time out period.

33. The method of claim 31 wherein, when the particular user attempts to get the attention of another user during the time out period, then the UI supports increasing an intensity of the alert indicator.

34. The method of claim 26 wherein the UI supports a user responding to another user's attempt to get their attention.

35. The method of claim 34 wherein the UI supports a user responding to another user's attempt to get their attention by selecting the alert indicator.

36. The method of claim 1 wherein the maintaining in (B) comprises maintaining a substantially consistent version of the conversation.

37. The method of claim 1 wherein conversation maintained by the backend is considered to be the true version of the conversation within the communication framework.

38. The method of claim 1 wherein the one or more devices are selected from: smartphones, tablet devices, computer devices, set-top boxes, and televisions.

39. The method of claim 1 wherein each object in the conversation represents at least one of: text, an image, video content, audio content, voice information, a file, a link to an asset, and meta information about the conversation.

40. The method of claim 1 wherein the backend system acts as a persistent store through which users share data.

41. A device, operable in a communication framework in which each a plurality of users has one or more devices associated therewith, the device being associated with a particular user of the plurality of users, and in which the users use at least some of their devices to communicate via a backend system,
the device being constructed and adapted to:
(a) engage, via the backend, in a conversation with one or more users of the plurality of users, the conversation includes voice, wherein the backend system maintains a substantially consistent and authoritative state of the conversation; and
(b) provide a user interface (UI), wherein the device renders the particular view of the conversation via the UI.

42. The device of claim 41 wherein the device is constructed and adapted to support the method of claim 1.

43. The device of claim 41 further comprising a display, wherein the UI is provided using the display.

44. The device of claim 40 wherein the device is a device selected from: a smartphone, a tablet device, a computer device, a set-top box, and a television.

45. The device of claim 40 wherein each object in the conversation represents at least one of: text, an image, video content, audio content, voice, a file, a link to an asset, and meta information about the conversation.

46. The device of claim 40 wherein the conversation maintained by the backend is considered to be the true version of the conversation within the communication framework.

47. A communication framework in which each a plurality of users has one or more devices associated therewith, the framework comprising:
a backend system, wherein the at least some of the users use at least some of their devices to have conversations via the backend system,
wherein the backend system is constructed and adapted to:
(a) support a particular conversation between one or more users of the plurality of users, said conversation including voice; and
(b) maintain a substantially consistent and authoritative state of the particular conversation.

48. The communication framework of claim 47 wherein the backend system is further constructed and adapted to:
(c) provide at least some of the substantially consistent and authoritative state of the particular compensation to a user involved in the particular conversation.

49. The communication framework of claim 48 wherein the user involved in the particular conversation joined the conversation after the conversation had been ongoing.

50. The communication framework of claim 49 wherein the backend system is constructed and adapted to support a particular conversation by:
(a)(1) supporting establishment of the particular conversation; and
(a)(2) providing at least a subset of the conversation to a device associated with the conversation.

51. The communication framework of claim 49 wherein the particular conversation comprises a time-ordered sequence of objects, and wherein the backend system provides the subset of the conversation to a device associated with the conversation by providing the subset of the sequence of objects to the device.

52. The communication framework of claim 47 wherein the backend is constructed and adapted to support the method of claim 1.

53. The communication framework of claim 47 wherein each of the one or more devices is a device selected from: a smartphone, a tablet device, a computer device, a set-top box, and a television.

54. The communication framework of claim 47 wherein each object in the conversation represents at least one of: text, an image, voice, video content, audio content, a file, a link to an asset, and meta information about the conversation.

55. The communication framework of claim 47 wherein the particular conversation maintained by the backend is considered to be a true version of the particular conversation within the communication framework.

56. A computer-implemented method, operable in a communication system in which each of a plurality of users has one or more devices associated therewith, and in which the users use at least some of their devices to communicate via a backend system, the method comprising:
(A) maintaining in the backend system a substantially consistent version of a conversation between multiple users of the plurality of users, wherein conversation maintained by the backend provides an authoritative version of the conversation within the communication framework; and
(B) establishing a voice conversation using the voice channel.

57. A computer-implemented method, operable in a communication system in which each of a plurality of users has one or more devices associated therewith, and in which the users use at least some of their devices to communicate via a backend system, the method comprising the method of claim 1.

58. A device comprising hardware, including a processor and a memory, the device being programmed to perform the method of claim 1.

59. The device of claim 58 wherein the device is a device selected from: a smartphone, a tablet device, a computer device, a set-top box, and a television.

60. A tangible computer-readable non-transitory storage medium comprising instructions for execution on a device, wherein the instructions, when executed, perform acts of a method of claim 1.

61. The storage medium of claim 60 wherein the device is a device selected from: a smartphone, a tablet device, a computer device, a set-top box, and a television.
